(19) United States
(12) Patent Application Publication
(10) Pub. No.: US 2025/0023105 A1
(43) Pub. Date: Jan. 16, 2025

(54) BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Tetsuji ISHITANI, Atsugi, Kanagawa (JP); Noriko MIYAIRI, Hadano, Kanagawa (JP); Daichi HIGO, Atsugi, Kanagawa (JP); Kaori OGITA, Isehara, Kanagawa (JP); Takashi HIRAHARA, Isehara, Kanagawa (JP)

(21) Appl. No.: 18/712,499

(22) PCT Filed: Nov. 17, 2022
(86) PCT No.: PCT/IB2022/061055

§ 371 Date: May 22, 2024

(30) Foreign Application Priority Data
Nov. 29, 2021 (JP) 2021-192944
Dec. 29, 2021 (JP) 2021-215390

(51) Int. Cl. H01M 10/0569; H01M 10/0525; H01M 10/0567; H01M 10/0568; H01M 50/105

(52) U.S. Cl. CPC H01M 10/0569; H01M 10/0525; H01M 10/0567; H01M 10/0568; H01M 50/105; H01M 2220/20; H01M 2300/0028; H01M 2300/0051

(57) ABSTRACT

A nonaqueous solvent that can be used in a wide temperature range, has a low viscosity, has high lithium ion conductivity at low temperatures, or has high heat resistance is provided. The nonaqueous solvent containing an ionic liquid and an organic electrolyte for low-temperature use has a low viscosity even at low temperatures and has high carrier ion conductivity. As the organic electrolyte for low-temperature use, an electrolyte in which methyl ethyl carbonate accounts for greater than or equal to 30 volume % and less than or equal to 65 volume % can be used. A battery using the nonaqueous solvent as an electrolyte can be used in a wide temperature range and thus is preferable.

### TECHNICAL FIELD

The present invention relates to a battery, specifically a secondary battery, and an electronic device, a vehicle, or the like including a battery.

### BACKGROUND ART

Among batteries, secondary batteries can be used repeatedly by being charged and discharged, and are also called storage batteries. Secondary batteries using lithium ions as carrier ions, which are called lithium-ion secondary batteries, can have high capacity and a small size and are under intensive research and development.

One of the problems for secondary batteries is their susceptibility to an environmental temperature. For example, an environmental temperature decrease leads to a lower viscosity of an electrolyte of a secondary battery, which reduces carrier ion conducting performance. Degraded performance of an electrolyte causes degradation of performance, such as an increase in internal resistance, of a secondary battery.

Examples of vehicles with motors driven by secondary batteries include electric vehicles; it has been difficult to spread electric vehicles to cold climate areas and tropical regions because of influences of environmental temperatures such as cold temperatures and hot temperatures on electrolytes.

Examples of vehicles including secondary batteries include, in addition to electric vehicles, hybrid vehicles having two power sources of an engine and a motor. Hybrid vehicles that can be charged through receptacles are plug-in hybrid vehicles. Examples of electronic devices including secondary batteries include portable information terminals such as mobile phones, smartphones, and laptop personal computers, portable music players, digital cameras, and medical instruments.

It is desired that the secondary batteries included in electric vehicles, hybrid vehicles, plug-in hybrid vehicles, or electronic devices can demonstrate stable performance irrespective of the environmental temperature at which the secondary batteries are used. In addition, the secondary batteries are required to be much safer.

A non-flammable ionic liquid is known as a highly safe electrolyte. Patent Document 1 discloses setting the viscosity of an electrolyte containing an ionic liquid within a certain range in light of a problem related to the safety of lithium-ion secondary batteries.

### REFERENCE

### Patent Document

[Patent Document 1] Japanese Published Patent Application No. 2018-116840

### SUMMARY OF THE INVENTION

### Problems to be Solved by the Invention

In Patent Document 1, however, the problem related to the temperature range in which secondary batteries can be used has not been recognized.

In view of the above, an object of the present invention is to provide a nonaqueous solvent that can be used in a wide temperature range and a formation method thereof. Another object is to provide a secondary battery containing the nonaqueous solvent and a fabrication method thereof. Another object is to provide a vehicle including the secondary battery and a fabrication method thereof.

Another object of the present invention is to provide a nonaqueous solvent containing an ionic liquid and having a low viscosity at least at low temperatures and a formation method thereof. Another object is to provide a secondary battery containing the nonaqueous solvent and a fabrication method thereof. Another object is to provide a vehicle including the secondary battery and a fabrication method thereof.

Another object of the present invention is to provide a nonaqueous solvent having high lithium ion conductivity at least at low temperatures and a formation method thereof. Another object is to provide a secondary battery including the nonaqueous solvent and a fabrication method thereof. Another object is to provide a vehicle including the secondary battery and a fabrication method thereof.

Another object of the present invention is to provide a nonaqueous solvent with high heat resistance and a formation method thereof. Another object is to provide a secondary battery containing the nonaqueous solvent and a fabrication method thereof. Another object is to provide a vehicle including the secondary battery and a fabrication method thereof.

One embodiment of the present invention does not necessarily achieve all of these objects. Other objects can be derived from the description of this specification, the drawings, and the claims. The description of these objects does not disturb the existence of other objects related to safety and the like.

### Means for Solving the Problems

The present inventors have conducted intensive research to solve the above problems and have found out that adding an organic solvent with a low viscosity to an ionic liquid enables a nonaqueous solvent to have a low viscosity even at low temperatures. It is found out that mixing a conventional organic solvent and an organic solvent with a low viscosity also enables a nonaqueous solvent to have a low viscosity even at low temperatures. A low viscosity can increase the conductivity of a nonaqueous solvent, improving carrier ion conductivity such as lithium ion conductivity. When the nonaqueous solvent is used as an electrolyte of a secondary battery, it is possible to provide a secondary battery having high carrier ion conductivity such as high lithium ion conductivity at least at low temperatures.

When an ionic liquid is contained in a nonaqueous solvent at greater than or equal to 20 volume % and less than or equal to 80 volume %, preferably 50 volume %, the viscosity of the nonaqueous solvent at low temperatures falls within a preferable range. In this specification and the like, the volume of an electrolyte refers to volume measured at 25° C. Furthermore, a volume ratio may be a mixing ratio in a formation process or a ratio obtained from various analysis results.

Although using only an organic solvent with a low viscosity results in poor high-temperature resistance and high-voltage resistance, mixing a conventional organic solvent and an organic solvent with a low viscosity can offer high-temperature resistance and high-voltage resistance. Considering the carrier ion conductivity at low temperatures, the high heat resistance, and the high-voltage resistance, it is possible to provide a nonaqueous solvent that can be used in a wide temperature range. Furthermore, it is possible to provide a secondary battery including the nonaqueous solvent and a vehicle including the secondary battery.

One embodiment of the present invention is a battery including an electrolyte, in which the electrolyte contains an ionic liquid and an organic electrolyte, the organic electrolyte contains a cyclic carbonate, methyl ethyl carbonate, and dimethyl carbonate, and the methyl ethyl carbonate accounts for greater than or equal to 30 volume % and less than or equal to 65 volume % in the organic electrolyte.

In the above, the ionic liquid preferably accounts for greater than or equal to 20 volume % and less than or equal to 80 volume % in the electrolyte.

In the above, the ionic liquid preferably has Structural Formula (111) below and Structural Formula (H11) below.

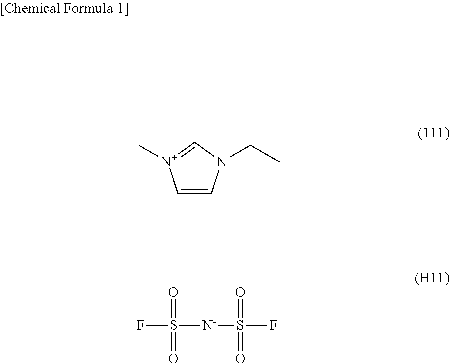

In the above, it is preferable that the cyclic carbonate contain ethylene carbonate, and that the ethylene carbonate account for greater than or equal to 25 volume % and less than or equal to 35 volume % in the organic electrolyte.

Another embodiment of the present invention is a battery including an organic electrolyte, in which the organic electrolyte contains a cyclic carbonate and three or more kinds of linear carbonates. When nuclear magnetic resonance analysis is performed on a first organic electrolyte in the battery before a cycle test and a second organic electrolyte in the battery after the cycle test, a difference between a proportion of the linear carbonates in the first organic electrolyte and a proportion of the linear carbonates in the second organic electrolyte is less than or equal to 20 points. As the cycle test, charging and discharging are alternately repeated 50 times in a 45° C. environment, where the charging is constant current charging at a current value of 100 mA/g to a voltage of 4.6 V and subsequent constant voltage charging to a current value of 10 mA/g and the discharging is constant current discharging at a current value of 100 mA/g to a voltage of 2.5 V.

In the above, the electrolyte preferably contains lithium hexafluorophosphate.

The above battery is preferably a flexible battery.

### Effect of the Invention

The nonaqueous solvent of one embodiment of the present invention has a low viscosity even at low temperatures. The nonaqueous solvent of one embodiment of the present invention also has high heat resistance. Because of having the above low viscosity at low temperatures and the above high heat resistance, the nonaqueous solvent of one embodiment of the present invention can be used in a wide temperature range.

The nonaqueous solvent can be used as an electrolyte of a secondary battery, in which case the secondary battery of one embodiment of the present invention can be used in a wide temperature range. Moreover, the secondary battery can be included in a vehicle, in which case the vehicle of one embodiment of the present invention can be used in a wide temperature range.

A nonaqueous solvent with high heat resistance is highly safe. The nonaqueous solvent can be used as an electrolyte of a secondary battery, in which case the secondary battery of one embodiment of the present invention is highly safe. Moreover, the secondary battery can be included in a vehicle, in which case the vehicle of one embodiment of the present invention is highly safe.

Structures and effects other than the above-described ones will be apparent from the description of the following embodiments.

### BRIEF DESCRIPTION OF THE DRAWINGS

FIG. 1A and FIG. 1B are cross-sectional views illustrating a structure example of a secondary battery.

FIG. 2 is a diagram showing crystal structures of a positive electrode active material.

FIG. 3 is a diagram showing crystal structures of a conventional positive electrode active material.

FIG. 4 is a diagram showing XRD patterns calculated from crystal structures.

FIG. 5 is a diagram showing XRD patterns calculated from crystal structures.

FIG. 6A and FIG. 6B are diagrams showing XRD patterns calculated from crystal structures.

FIG. 7A to FIG. 7C are perspective views and a cross-sectional view illustrating a structure example of a coin-type secondary battery.

FIG. 8A to FIG. 8C are diagrams illustrating a structure example of a secondary battery.

FIG. 9A and FIG. 9B are diagrams illustrating a structure example of a secondary battery. FIG. 9C is a diagram illustrating an example of a battery pack including a plurality of secondary batteries.

FIG. 10A to FIG. 10C are diagrams illustrating examples of a battery pack including a plurality of secondary batteries.

FIG. 11A to FIG. 11C are diagrams illustrating examples of a battery pack including a plurality of secondary batteries.

FIG. 12A is a perspective view illustrating a structure example of a secondary battery, and FIG. 12B is a top view illustrating the structure example of the secondary battery.

FIG. 13A and FIG. 13B are cross-sectional views illustrating a structure example of a secondary battery.

FIG. 14A to FIG. 14E are diagrams illustrating a structure example of a secondary battery.

FIG. 15A to FIG. 15C are diagrams illustrating structure examples of a secondary battery.

FIG. 16A to FIG. 16C are diagrams illustrating structure examples of a secondary battery.

FIG. 17A to FIG. 17C are diagrams illustrating an electronic device of one embodiment of the present invention.

FIG. 18A and FIG. 18B are diagrams illustrating an electronic device of one embodiment of the present invention.

FIG. 19A to FIG. 19D are diagrams illustrating electronic devices of one embodiment of the present invention.

FIG. 20A to FIG. 20D are diagrams illustrating electronic devices of one embodiment of the present invention.

FIG. 21A to FIG. 21C are diagrams illustrating an electronic device of one embodiment of the present invention.

FIG. 22A to FIG. 22C are diagrams illustrating an electronic device of one embodiment of the present invention.

FIG. 23A is a diagram illustrating an electric bicycle, and FIG. 23B is a diagram illustrating a secondary battery of the electric bicycle. FIG. 23C is a diagram illustrating an example of a battery pack. FIG. 23D is a diagram illustrating an electric motorcycle.

FIG. 24A is a perspective view of a power storage device, FIG. 24B is a block diagram of the power storage device, and FIG. 24C is a block diagram of a vehicle including a motor.

FIG. 25A to FIG. 25E are diagrams illustrating examples of transport vehicles.

FIG. 26A to FIG. 26D are diagrams illustrating examples of space equipment.

FIG. 27 is a graph showing the viscosities of electrolytes.

FIG. 28A to FIG. 28C are photographs showing the wettability of electrolytes.

FIG. 29A to FIG. 29C are photographs showing the wettability of electrolytes.

FIG. 30A and FIG. 30B are graphs showing charge and discharge cycle performance of secondary batteries.

FIG. 31A and FIG. 31B are graphs showing charge and discharge cycle performance of secondary batteries.

FIG. 32A and FIG. 32B are graphs showing charge and discharge cycle performance of secondary batteries.

FIG. 33A and FIG. 33B show ¹H NMR spectra of an electrolyte.

FIG. 34A and FIG. 34B show ¹H NMR spectra of electrolytes.

FIG. 35 is a graph showing compositions of an electrolyte.

FIG. 36A and FIG. 36B are graphs showing compositions of electrolytes.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

In this embodiment, a nonaqueous solvent of the present invention will be described.

In a nonaqueous solvent of one embodiment of the present invention, at least an ionic liquid and an organic electrolyte with a low viscosity are mixed. The proportion of the ionic liquid in the entire nonaqueous solvent is greater than or equal to 20 volume % and less than or equal to 80 volume %, preferably 50 volume %. The nonaqueous solvent containing the ionic liquid in this proportion can have a low viscosity even at low temperatures. Thus, the nonaqueous solvent has high carrier ion conductivity even at low temperatures, in which case the nonaqueous solvent that can be used in a wide temperature range can be provided. When the nonaqueous solvent is used as an electrolyte of a secondary battery, it is possible to provide a secondary battery that can be used in a wide temperature range. When the secondary battery is included in a vehicle, it is possible to provide a vehicle that can be used in a wide temperature range.

In a nonaqueous solvent of one embodiment of the present invention, a conventional organic solvent and an organic solvent with a low viscosity are mixed. In particular, when a linear carbonate contained in the conventional organic solvent and a plurality of linear carbonates with low viscosities are mixed to be used, the nonaqueous solvent can have a low viscosity even at low temperatures. Although using only the organic solvent with a low viscosity results in poor high-temperature resistance and high-voltage resistance, mixing the conventional organic solvent and the organic solvent with a low viscosity can offer high-temperature resistance and high-voltage resistance. Considering the carrier ion conductivity at low temperatures, the high heat resistance, and the high-voltage resistance, it is possible to provide a nonaqueous solvent that can be used in a wide temperature range. Furthermore, it is possible to provide a secondary battery including the nonaqueous solvent and a vehicle including the secondary battery.

### <Ionic Liquid>

An ionic liquid that can be used in one embodiment of the present invention will be described. The ionic liquid, which is sometimes referred to as a room temperature molten salt, contains a cation and an anion. The basic skeleton of the cation has an imidazolium-based skeleton, an ammonium-based skeleton, a pyrrolidinium-based skeleton, a piperidinium-based skeleton, a pyridinium-based skeleton, or a phosphonium-based skeleton. An ionic liquid in which the basic skeleton of a cation is an imidazolium-based skeleton has a lower viscosity than an ionic liquid with an ammonium-based skeleton. A low viscosity tends to increase carrier ion conductivity. In addition, a physical property such as a viscosity can be controlled with an alkyl group of a side chain of the cation or the like.

Examples of the anion include a halide ion, tetrafluoroborate, hexafluorophosphate, bis(trifluoromethylsulfonyl) amide, and bis(fluorosulfonyl) imide.

The anion in the ionic liquid that can be used in one embodiment of the present invention will be described. As the anion, one or more of a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, a perfluoroalkylphosphate anion, a tetrafluoroborate anion, and the like can be used.

A monovalent amide-based anion is represented by a general formula (CₙF₂ₙ₊₁SO₂)₂N⁻ (n is greater than or equal to 0 and less than or equal to 3).

When n is 0, the above general formula represents a bis(fluorosulfonyl) imide anion, which is represented by Structural Formula (H11). A bis(fluorosulfonyl) imide anion is abbreviated as FSI or FSA.

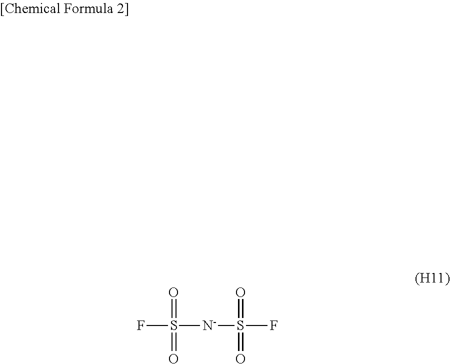

When n is 1, the above general formula represents a bis(trifluoromethanesulfonyl) imide anion, which is represented by Structural Formula (H12). A bis(trifluoromethanesulfonyl) imide anion is abbreviated as TFSI or TFSA.

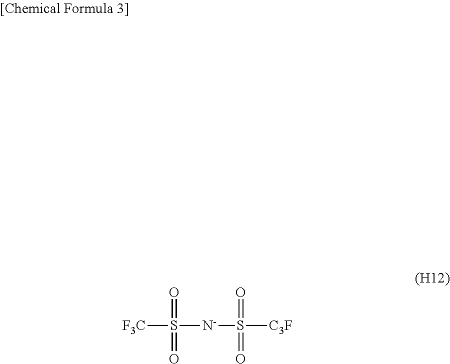

An example of a monovalent cyclic amide-based anion is a 4,4,5,5-tetrafluoro-1,3,2-dithiazolidine tetraoxide anion, which is represented by Structural Formula (H13).

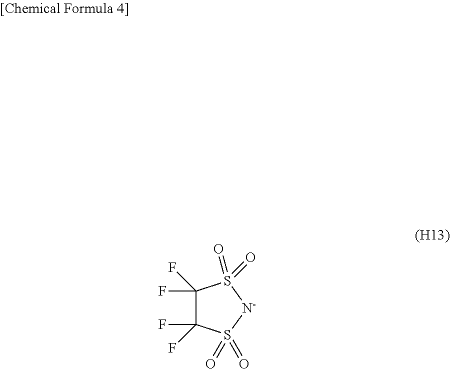 [SMILES: O=S1(=O)[N-]S(=O)(=O)C(F)(F)C1(F)F]

A monovalent methide-based anion is represented by a general formula (CₙF₂ₙ₊₁SO₂)₃C⁻ (n is greater than or equal to 0 and less than or equal to 3).

An example of a monovalent cyclic methide-based anion is a 4,4,5,5-tetrafluoro-2-[(trifluoromethyl)sulfonyl]-1,3-dithiolane tetraoxide anion, which is represented by Structural Formula (H14).

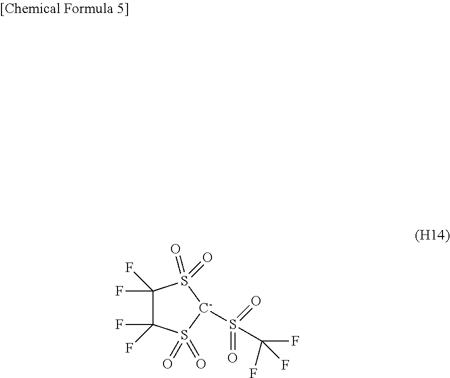 [SMILES: O=S(=O)([C-]1S(=O)(=O)C(F)(F)C(F)(F)S1(=O)=O)C(F)(F)F]

A fluoroalkylsulfonate anion is represented by a general formula (CₘF₂ₘ₊₁SO₃)⁻ (m is greater than or equal to 0 and less than or equal to 4).

When m is 0, the above general formula represents a fluorosulfonate anion; when m is 1, 2, 3, or 4, the above general formula represents a perfluoroalkylsulfonate anion.

A fluoroalkylborate anion is represented by a general formula {BFₙ(CₘHₖF₂ₘ₊₁₋ₖ)₄₋ₙ}⁻ (n is greater than or equal to 0 and less than or equal to 3, m is greater than or equal to 1 and less than or equal to 4, and k is greater than or equal to 0 and less than or equal to 2m).

A fluoroalkylphosphate anion is represented by a general formula {PFₙ(CₘHₖF₂ₘ₊₁₋ₖ)₆₋ₙ}⁻ (n is greater than or equal to 0 and less than or equal to 5, m is greater than or equal to 1 and less than or equal to 4, and k is greater than or equal to 0 and less than or equal to 2m).

One or more of these anions can be used.

The cation in the ionic liquid of the present invention will be described.

The cation in the ionic liquid of the present invention contains an imidazolium-based cation represented by General Formula (G1). In General Formula (G1), A⁻ represents an anion.

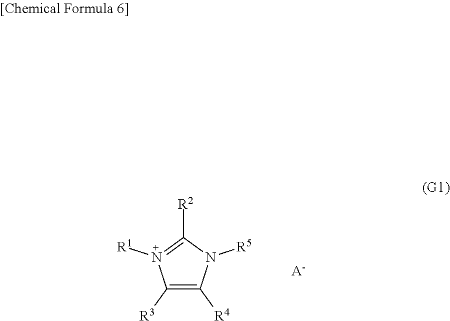

In General Formula (G1) above, R¹ represents an alkyl group having 1 to 4 carbon atoms, R² to R⁴ each independently represent a hydrogen atom or an alkyl group having 1 to 4 carbon atoms, and R⁵ represents an alkyl group having 1 to 6 carbon atoms or an ether group, a thioether group, or a siloxane having a main chain composed of two or more selected from C, O, Si, N, S, and P atoms. In General Formula (G1) above, A⁻ preferably has an FSI anion or a TFSI anion.

The ionic liquid of the present invention contains a pyridinium-based cation represented by General Formula (G2). In General Formula (G2), A⁻ represents an anion.

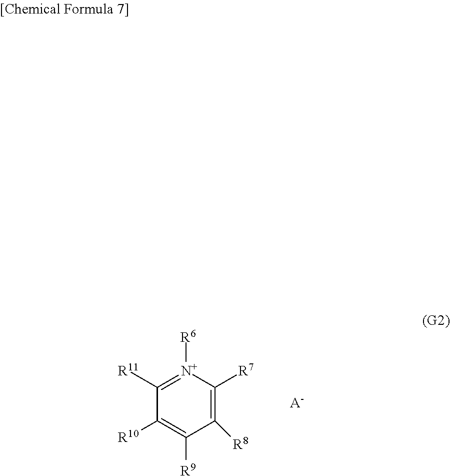

In General Formula (G2) above, R⁶ has an alkyl group having 1 to 6 carbon atoms or a main chain composed of two or more selected from C, O, Si, N, S, and P atoms. R⁷ to R¹¹ each independently represent a hydrogen atom or an alkyl group having 1 to 4 carbon atoms. Furthermore, R⁸ or R⁹ represents a hydroxyl group in some cases. In General Formula (G2) above, A⁻ preferably has an FSI anion or a TFSI anion.

The ionic liquid of the present invention may contain a quaternary ammonium cation. For example, a quaternary ammonium cation represented by General Formula (G3) is contained. In General Formula (G3), A⁻ represents an anion.

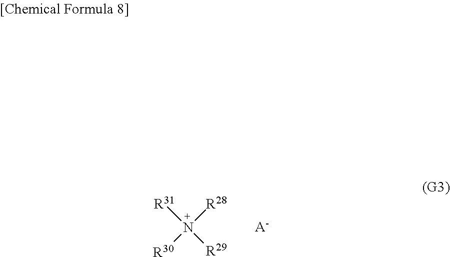

In General Formula (G3) above, R²⁸ to R³¹ each independently represent any of an alkyl group having 1 to 20 carbon atoms, a methoxy group, a methoxymethyl group, a methoxyethyl group, and a hydrogen atom. In General Formula (G3) above, A⁻ represents an anion and preferably has an FSI anion or a TFSI anion.

The ionic liquid of the present invention contains a cation represented by General Formula (G4). In General Formula (G4), A⁻ represents an anion.

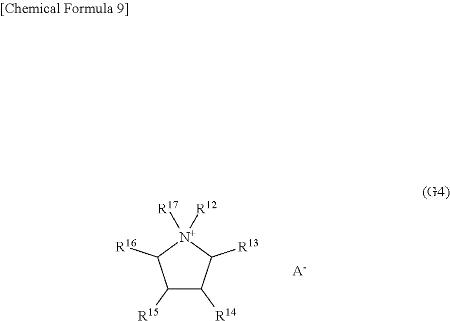

In General Formula (G4) above, R¹² and R¹⁷ each independently represent an alkyl group having 1 to 3 carbon atoms. R¹³ to R¹⁶ each independently represent any of a hydrogen atom and an alkyl group having 1 to 3 carbon atoms. In General Formula (G4) above, A⁻ preferably has an FSI anion or a TFSI anion.

The ionic liquid of the present invention contains a cation represented by General Formula (G5). In General Formula (G5), A⁻ represents an anion.

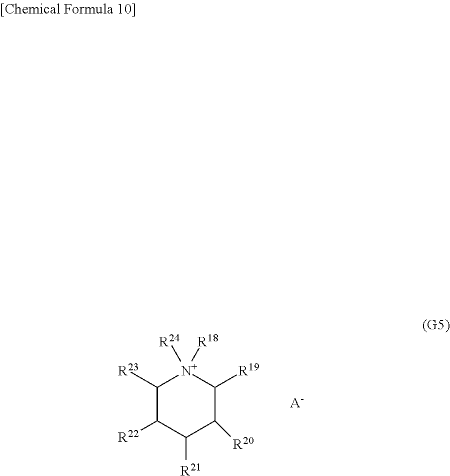

In General Formula (G5) above, R¹⁸ and R²⁴ each independently represent an alkyl group having 1 to 3 carbon atoms. R¹⁹ to R²³ each independently represent a hydrogen atom or an alkyl group having 1 to 3 carbon atoms. In General Formula (G5) above, A⁻ preferably has an FSI anion or a TFSI anion.

The ionic liquid of the present invention contains a cation represented by General Formula (G6). In General Formula (G6), A⁻ represents an anion.

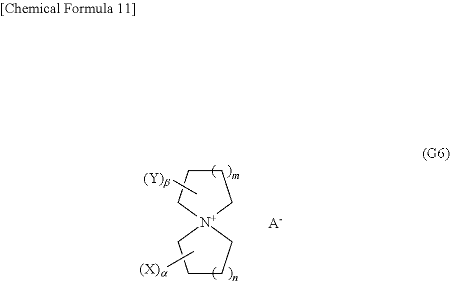

In General Formula (G6) above, n and m are each greater than or equal to 1 and less than or equal to 3, a is greater than or equal to 0 and less than or equal to 6, β is greater than or equal to 0 and less than or equal to 6, and X or Y represents, as a substituent, a linear or side-chain alkyl group having 1 to 4 carbon atoms, a linear or side-chain alkoxy group having 1 to 4 carbon atoms, or a linear or side-chain alkoxyalkyl group having 1 to 4 carbon atoms. In General Formula (G6) above, A⁻ preferably has an FSI anion or a TFSI anion.

The ionic liquid of the present invention contains a tertiary sulfonium cation represented by General Formula (G7). In General Formula (G7), A⁻ represents an anion.

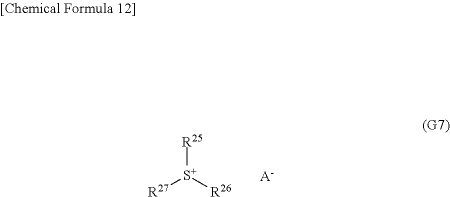

In General Formula (G7) above, R²⁵ to R²⁷ each independently represent a hydrogen atom, an alkyl group having 1 to 4 carbon atoms, or a phenyl group. Furthermore, R²⁵ to R²⁷ each independently have a main chain composed of two or more selected from C, O, Si, N, S, and P atoms. In General Formula (G7), A⁻ preferably has an FSI anion or a TFSI anion.

The ionic liquid of the present invention contains a quaternary phosphonium cation represented by General Formula (G8) below. In General Formula (G8), A⁻ represents an anion.

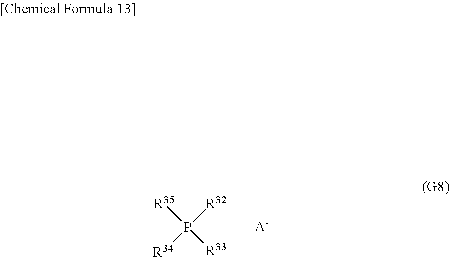

In General Formula (G8) above, R³² to R³⁵ each independently represent a hydrogen atom, an alkyl group having 1 to 4 carbon atoms, or a phenyl group. Furthermore, R³² to R³⁵ each independently have a main chain composed of two or more selected from C, O, Si, N, S, and P atoms. In General Formula (G8), A⁻ preferably has an FSI anion or a TFSI anion.

Specific examples of the cation represented by General Formula (G1) above include Structural Formula (111) to Structural Formula (174). Structural Formula (111) represents a 1-ethyl-3-methyl imidazolium cation, which is abbreviated as EMI. Structural Formula (113) represents a 1-butyl-3-methyl imidazolium cation, which is abbreviated as BMI.

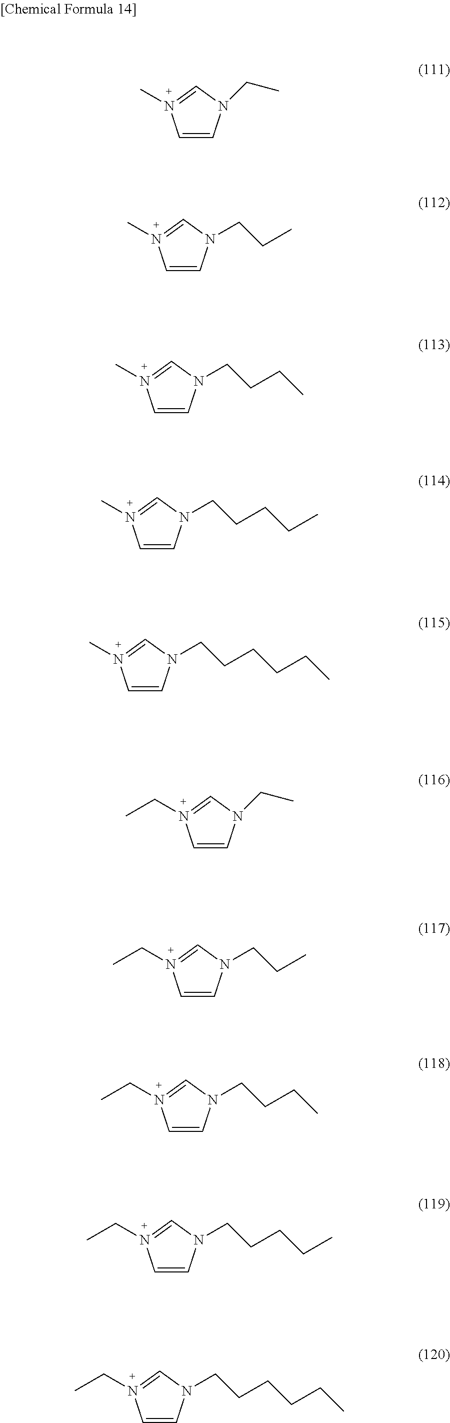

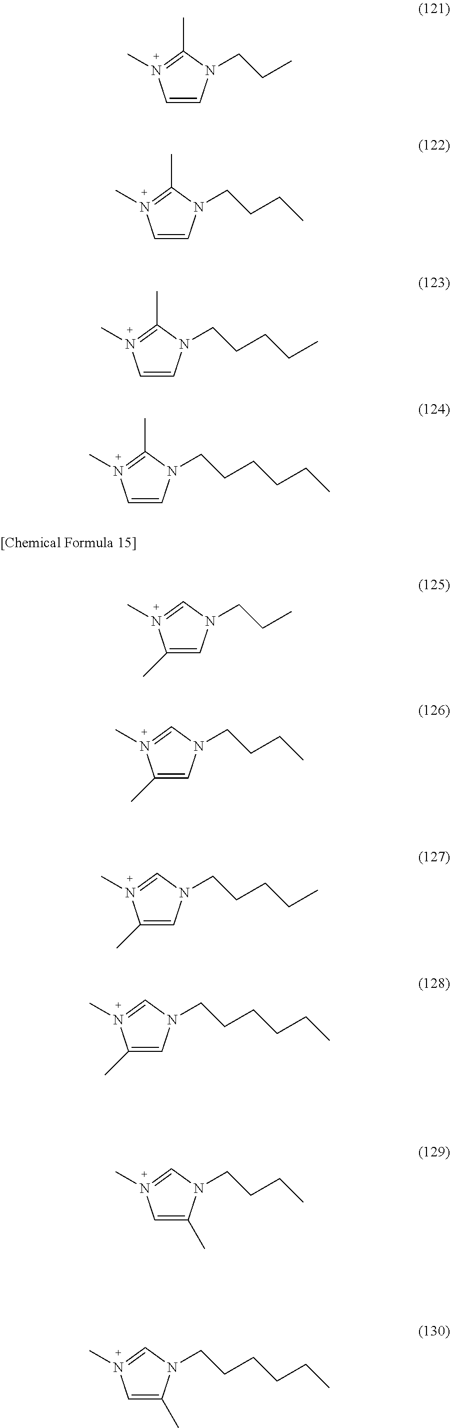

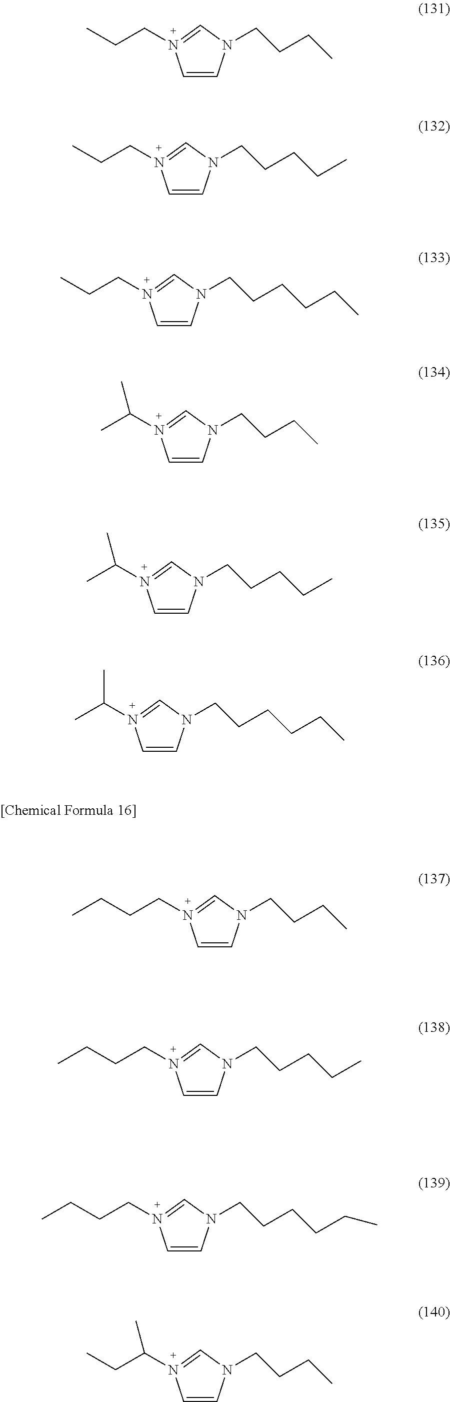

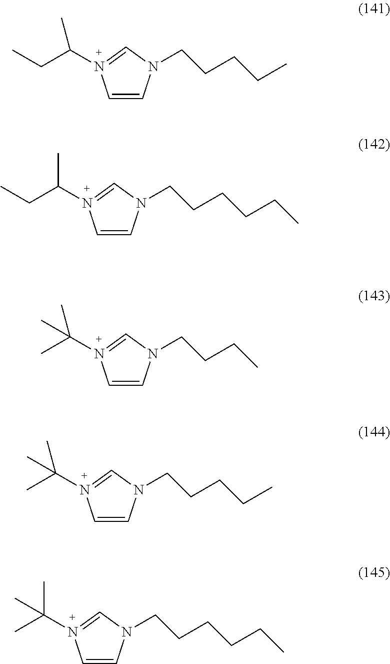

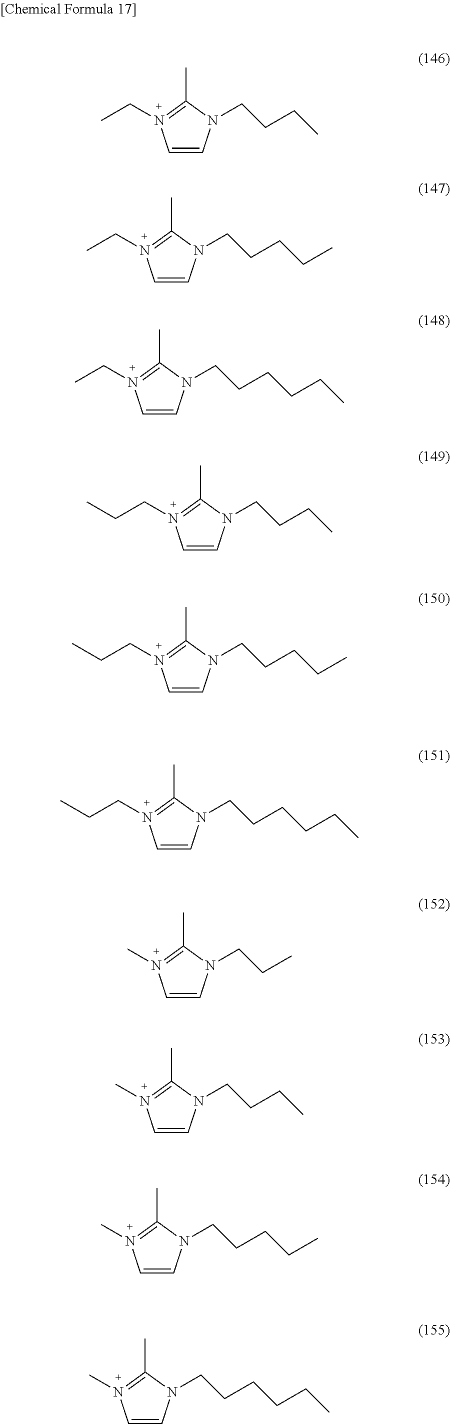

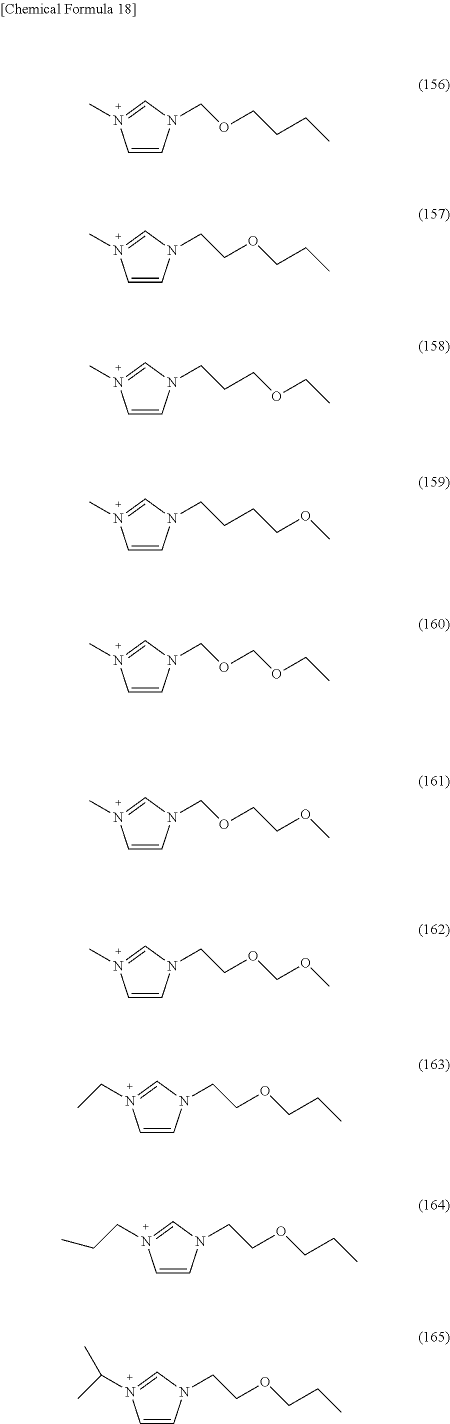

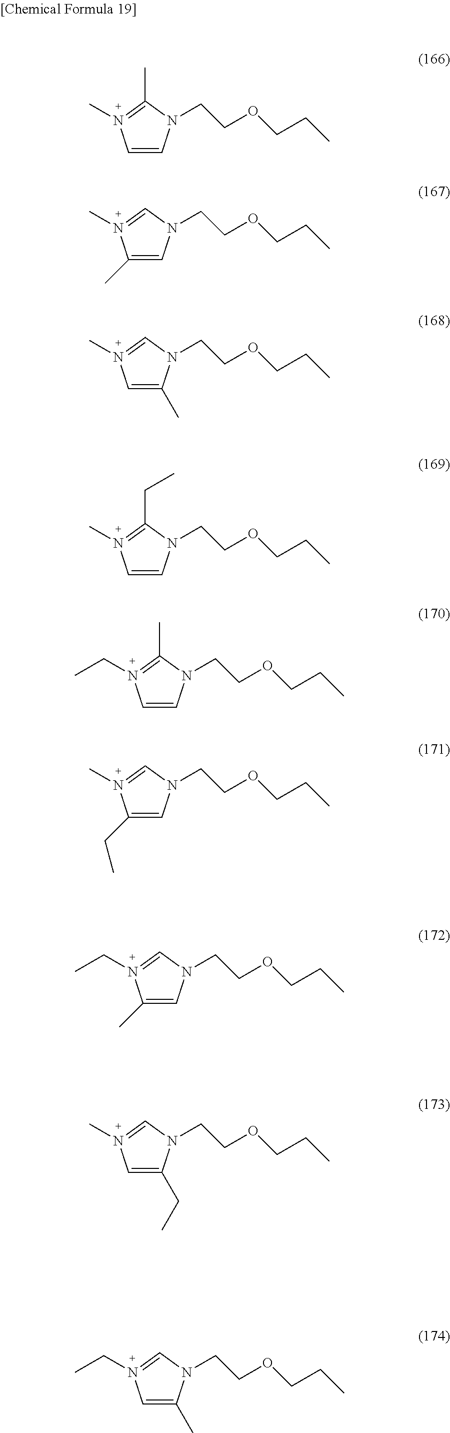

Specific examples of the cation represented by General Formula (G2) above include Structural Formula (701) to Structural Formula (719).

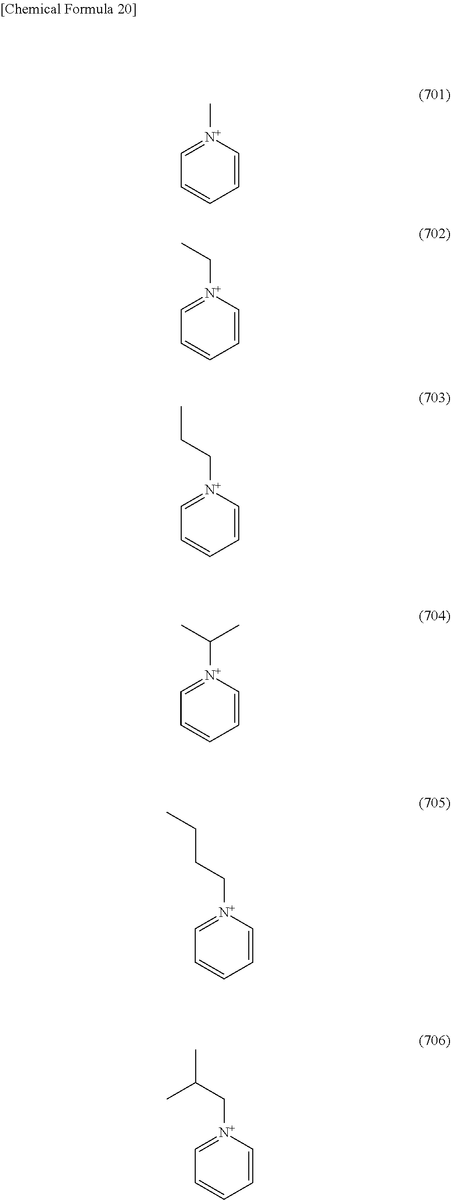

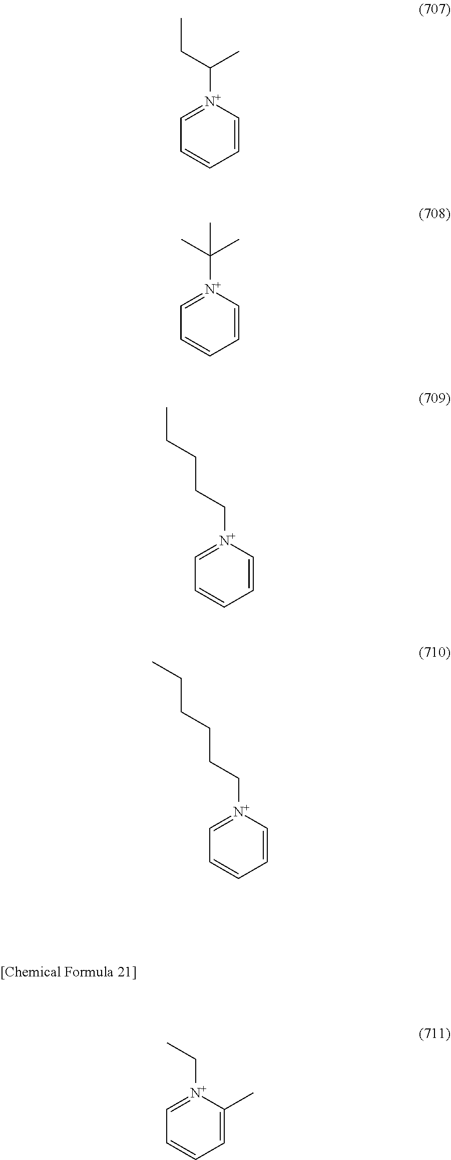

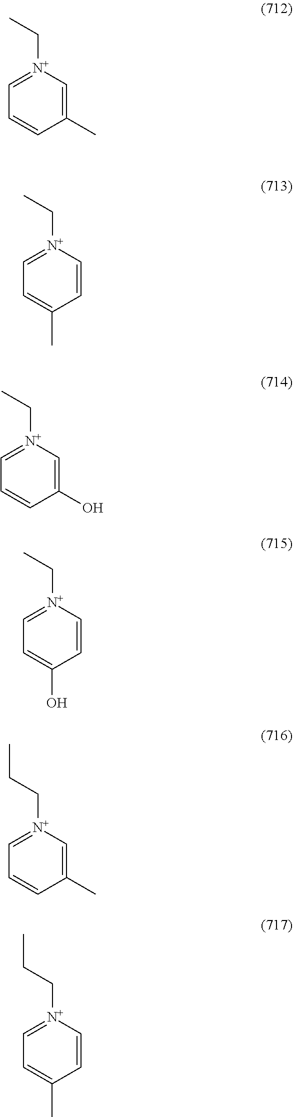

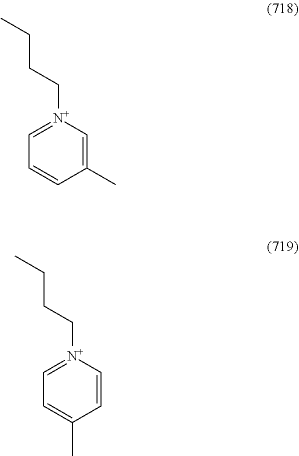

Specific examples of the cation represented by General Formula (G4) above include Structural Formula (501) to Structural Formula (520)

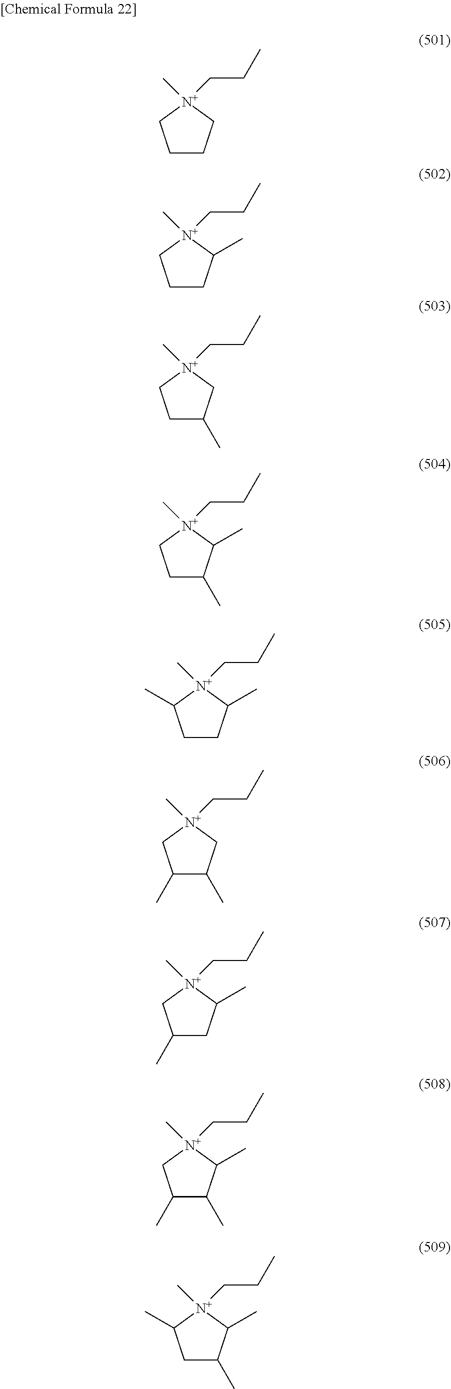

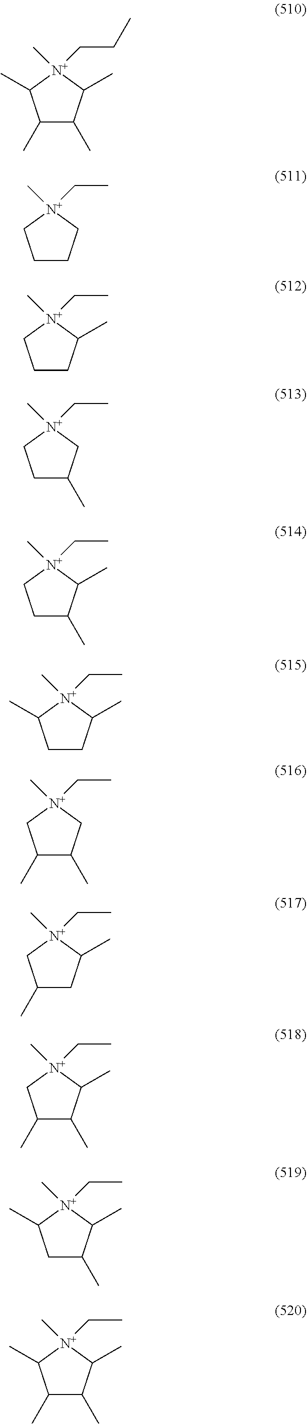

Specific examples of the cation represented by General Formula (G5) above include Structural Formula (601) to Structural Formula (630).

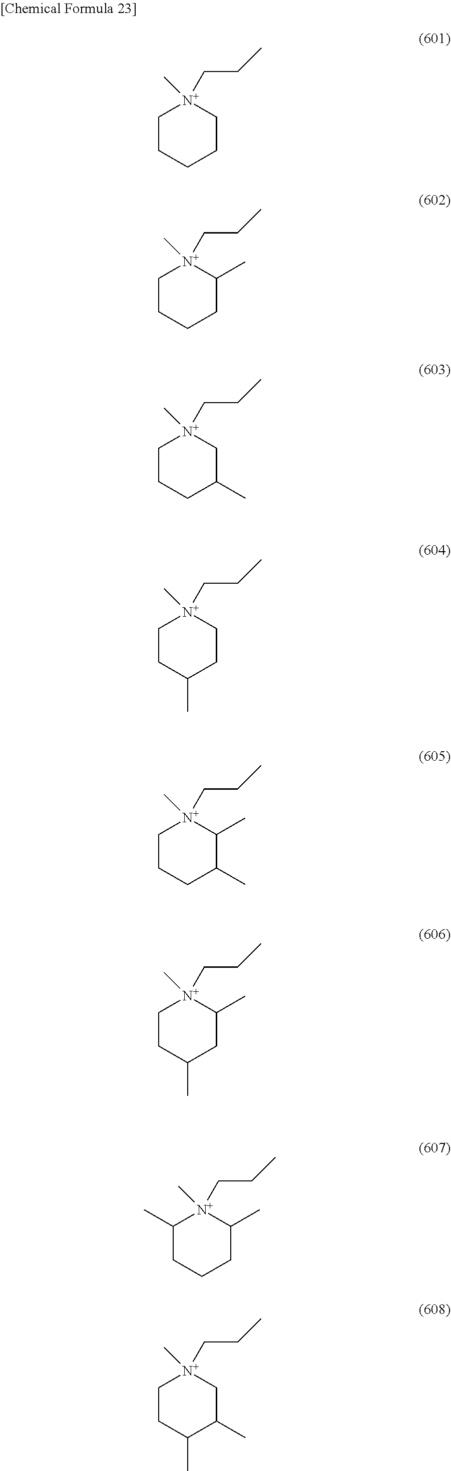

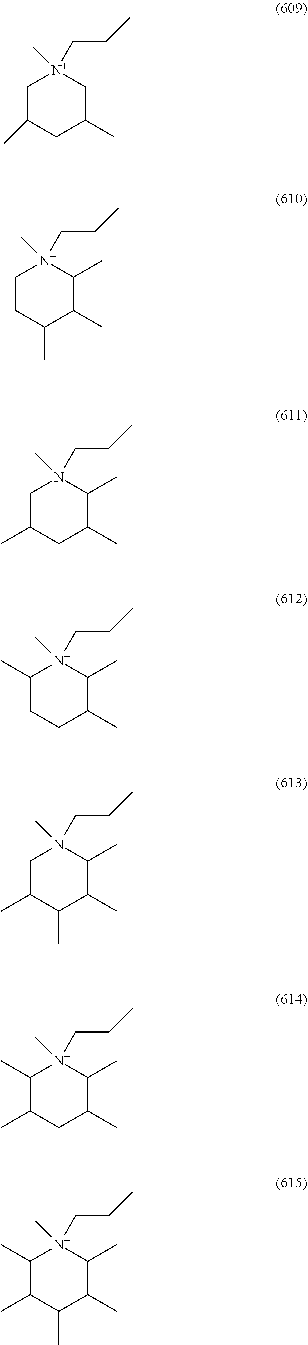

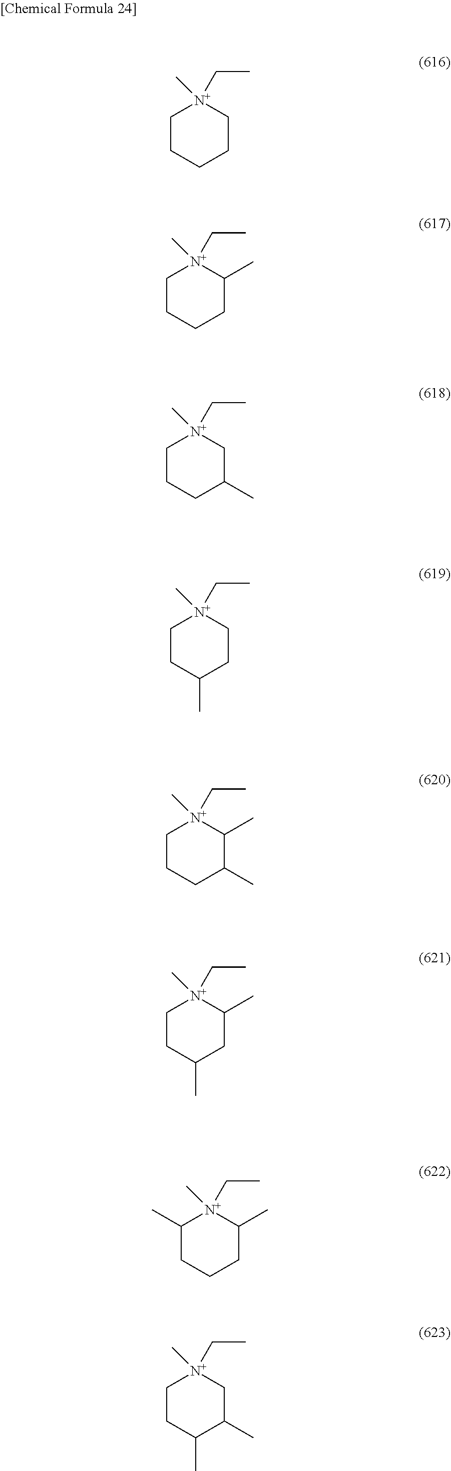

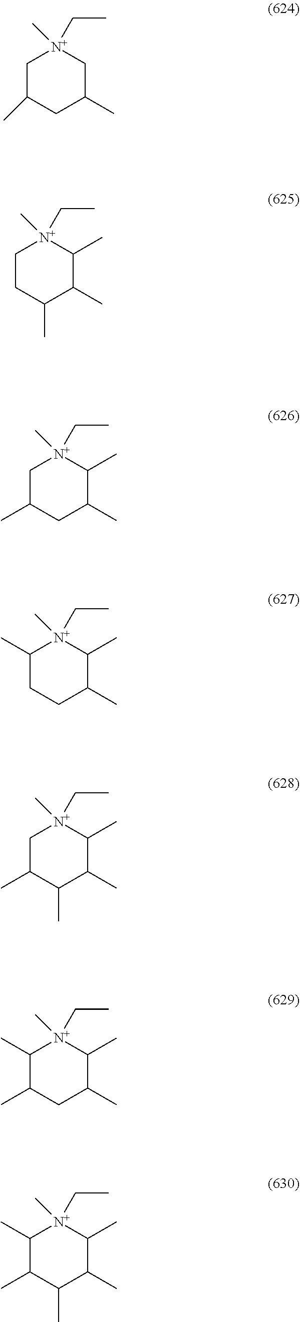

Specific examples of the cation represented by General Formula (G6) above include Structural Formula (301) to Structural Formula (309) and Structural Formula (401) to Structural Formula (419).

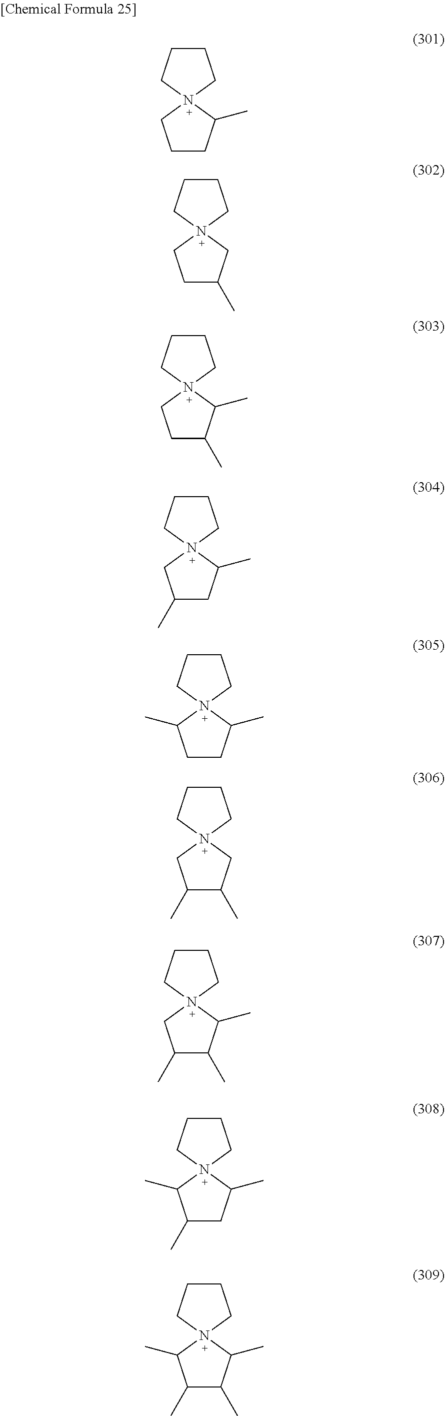

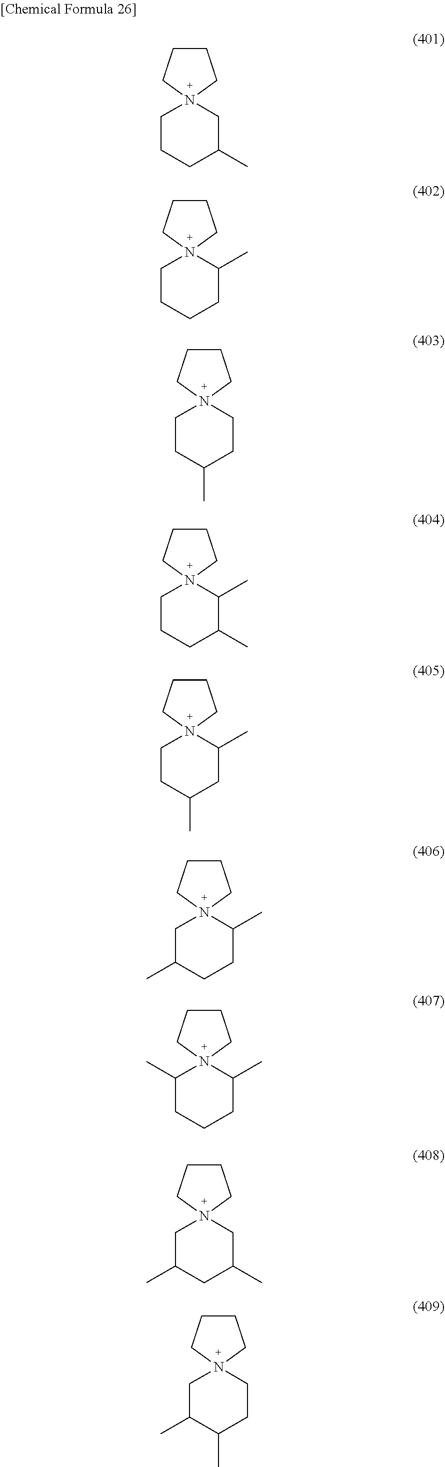

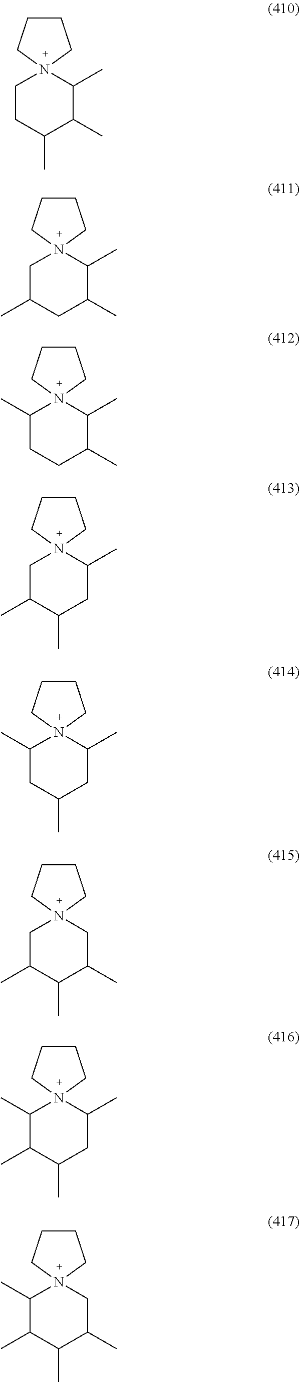

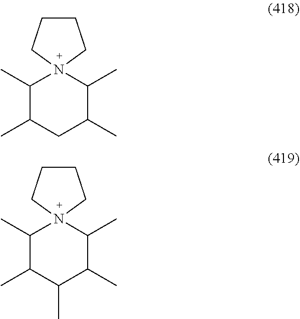

Although Structural Formula (301) to Structural Formula (309) and Structural Formula (401) to Structural Formula (419) each show an example in which m is 1 in General Formula (G6), m may be changed into 2 or 3 in Structural Formula (301) to Structural Formula (309) and Structural Formula (401) to Structural Formula (419).

Specific examples of the cation represented by General Formula (G7) above include Structural Formula (201) to Structural Formula (215).

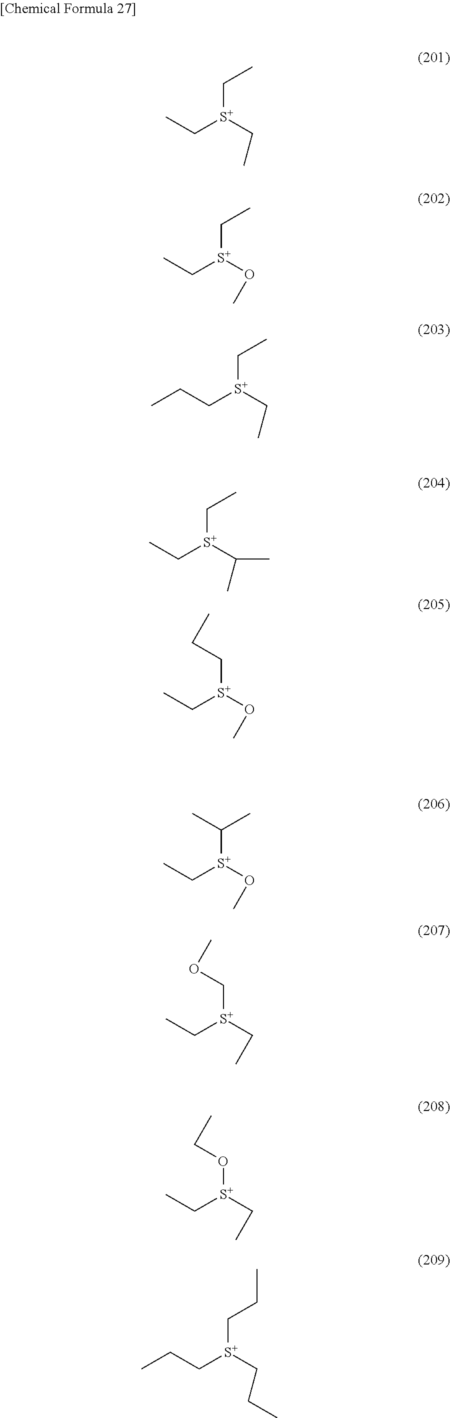

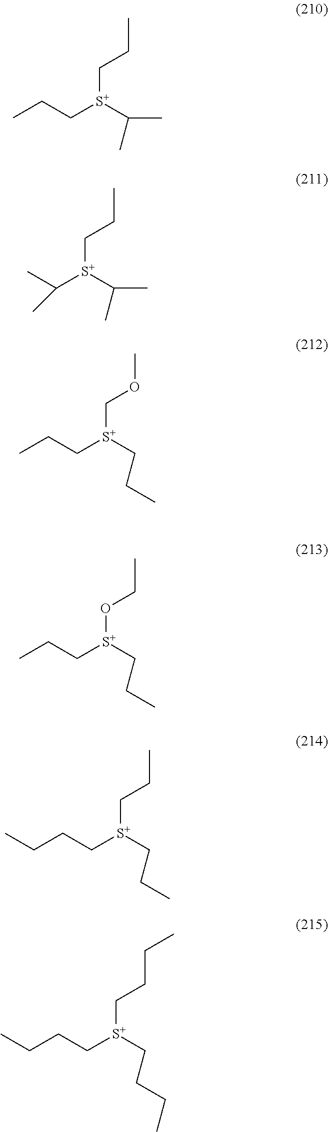

Such an ionic liquid is a liquid consisting only of ions, thereby having strong electrostatic interaction, nonvolatility, thermal stability, and high heat resistance. A secondary battery using the ionic liquid as an electrolyte does not catch fire in its usable temperature range and is highly safe.

### <Organic Electrolyte>

An organic electrolyte that can be used in one embodiment of the present invention will be described. The organic electrolyte contains a cyclic carbonate and a linear carbonate. The cyclic carbonate has a high dielectric constant and thus has a function of promoting dissociation of a lithium salt. The linear carbonate has a function of lowering the viscosity of an electrolyte.

The cyclic carbonate preferably accounts for greater than or equal to 25 volume % and less than or equal to 35 volume %, further preferably approximately 30 volume % in the organic electrolyte. An excessively small amount of cyclic carbonate might result in insufficient dissociation of a lithium salt. On the other hand, an excessively large amount of cyclic carbonate might lead to an overly high viscosity especially at low temperatures.

The organic electrolyte preferably contains only the linear carbonate besides the cyclic carbonate. That is, the linear carbonate preferably accounts for greater than or equal to 65 volume % and less than or equal to 75 volume %, further preferably approximately 70 volume % in the organic electrolyte. An excessively small amount of linear carbonate might lead to an overly high viscosity especially at low temperatures. On the other hand, an excessively large amount of linear carbonate might result in insufficient dissociation of a lithium salt.

As the linear carbonate, for example, methyl ethyl carbonate (ethyl methyl carbonate. EMC), dimethyl carbonate (DMC), diethyl carbonate (DEC), 1,2-dimethoxyethane (DME), a mixture thereof, or the like can be used.

Among them, EMC and DMC are linear carbonates with low viscosities. Meanwhile, DEC is a conventional linear carbonate that has been commonly used, and has high-temperature resistance and high-voltage resistance.

As the cyclic carbonate, for example, ethylene carbonate (EC), propylene carbonate (PC). γ-butyrolactone (GBL), a mixture thereof, or the like can be used.

A fluorinated cyclic carbonate may be used as the cyclic carbonate. A fluorinated cyclic carbonate has a high flash point and can enhance the safety. A secondary battery using the fluorinated cyclic carbonate as an electrolyte does not catch fire in its usable temperature range and is highly safe.

As a fluorinated cyclic carbonate, for example, a fluorinated ethylene carbonate such as monofluoroethylene carbonate (fluoroethylene carbonate, FEC, or FIEC), difluoroethylene carbonate (DFEC or F2EC), trifluoroethylene carbonate (F3EC), or tetrafluoroethylene carbonate (F4EC) can be used. Note that DFEC has isomers such as a cis-4,5 isomer and a trans-4,5 isomer.

A cyclic carbonate having a cyano group can also be used as the cyclic carbonate. A cyano group and a fluoro group of a fluorinated cyclic carbonate are also referred to as electron-withdrawing groups.

In the case where the organic electrolyte contains EC as the cyclic carbonate and EMC and DMC as the linear carbonates, the volume ratio between EC, EMC, and DMC is 30:x:(70−x) where 30≤x≤65 is preferably satisfied. That is, EMC preferably accounts for greater than or equal to 30 volume % and less than or equal to 65 volume % in the organic electrolyte. Since EMC has a low melting point of −54° C., EMC contained in the above range can lower the melting point of the organic electrolyte, thereby further increasing carrier ion conductivity at low temperatures.

In the present invention, unlike an additive agent contained in a small amount, the ionic liquid and the organic electrolyte containing the cyclic carbonate, the linear carbonate, and the like each account for greater than or equal to 5 volume % in the entire electrolyte.

In the nonaqueous solvent of the present invention, at least the ionic liquid and the organic electrolyte are mixed. The proportion of the ionic liquid in the entire nonaqueous solvent is preferably greater than or equal to 20 volume % and less than or equal to 50 volume %. The nonaqueous solvent containing the ionic liquid in this proportion can have high heat resistance. Since the nonaqueous solvent has the high heat resistance and the high carrier ion conductivity at low temperatures, a nonaqueous solvent that can be used in a wide temperature range can be provided.

### <Lithium Salt>

A lithium salt dissolved in the ionic liquid of the present invention is preferably a lithium salt containing a halogen, further preferably a fluorine-containing imide lithium salt. As the fluorine-containing imide lithium salt, Li(CF₃SO₂)₂N (hereinafter, sometimes referred to as “LiTFSI” or “LiTFSA”), Li(C₂F₅SO₂)₂N (hereinafter, sometimes referred to as “LiBETI”), Li(SO₂F)₂N (hereinafter, sometimes referred to as “LiFSI” or “LiFSA”), or the like can be used.

As another lithium salt containing a halogen, lithium hexafluorophosphate (LiPF₆). LiBF₄, LiClO₄, or the like can be used.

As another lithium salt containing no halogen, LiBOB (lithium bis(oxalate)borate) may be used.

These lithium salts may be used alone or mixed to be used.

### <Additive Agent>

An additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte. The concentration of the additive agent in the whole electrolyte is, for example, higher than or equal to 0.1 wt % and lower than or equal to 5 wt %.

In the case where a conventional organic electrolyte and an organic electrolyte with a low viscosity are mixed to be used, for example, a mixture of DEC, EMC, and DMC can be used as the linear carbonate. For example, the volume ratio between EC, EMC, DMC, and DEC can be 12:7:7:14. An electrolyte with such a composition can have a low viscosity at low temperatures, high-temperature resistance, and high-voltage resistance. Low temperatures here refer to temperatures lower than or equal to 0° C., for example. High temperatures refer to temperatures higher than or equal to 45° C. for example.

Even when a secondary battery containing an electrolyte with high-temperature resistance and high-voltage resistance is subjected to a cycle test under high-temperature and high-voltage conditions, the amount of electrolyte decomposed through the cycle test is small. Thus, changes in the proportions of the cyclic carbonate and the linear carbonate in the electrolyte are small. For example, when the amount of change in the proportion of the linear carbonate in the electrolyte between before and after the cycle test is less than or equal to 30 points, preferably less than or equal to 20 points, further preferably less than or equal to 15 points, the decomposition amount of electrolyte can be regarded as being adequately small.

The proportions of the compounds contained in the organic electrolyte can be analyzed by, for example, nuclear magnetic resonance (NMR), gas chromatography (GC/MS), high performance liquid chromatography (HPLC), or the like.

As the cycle test at high temperatures and high voltages to which the secondary battery is subjected, for example, charging and discharging can be alternately repeated 50 times in a 45° C. environment, where the charging is constant current charging to a voltage of 4.6 V at a current value of 100 mA/g and subsequent constant voltage charging to a current value of 10 mA/g and the discharging is constant current discharging to a voltage of 2.5 V at a current value of 100 mA/g.

This embodiment can be used in combination with the other embodiments.

### Embodiment 2

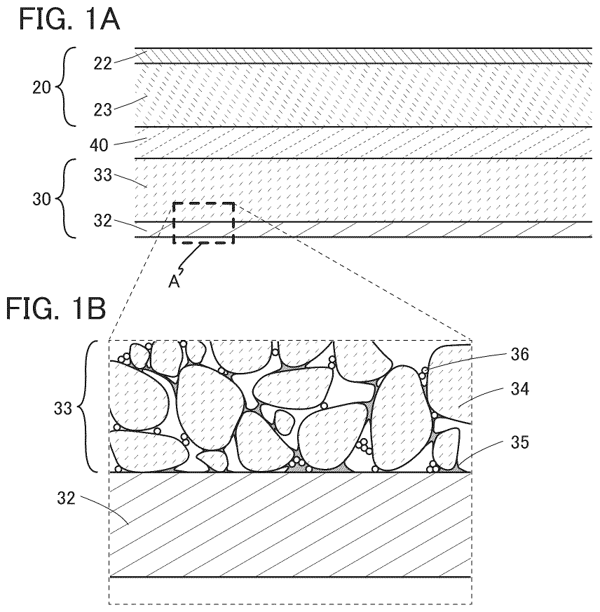

In this embodiment, an example of a secondary battery of the present invention will be described with reference to FIG. 1.

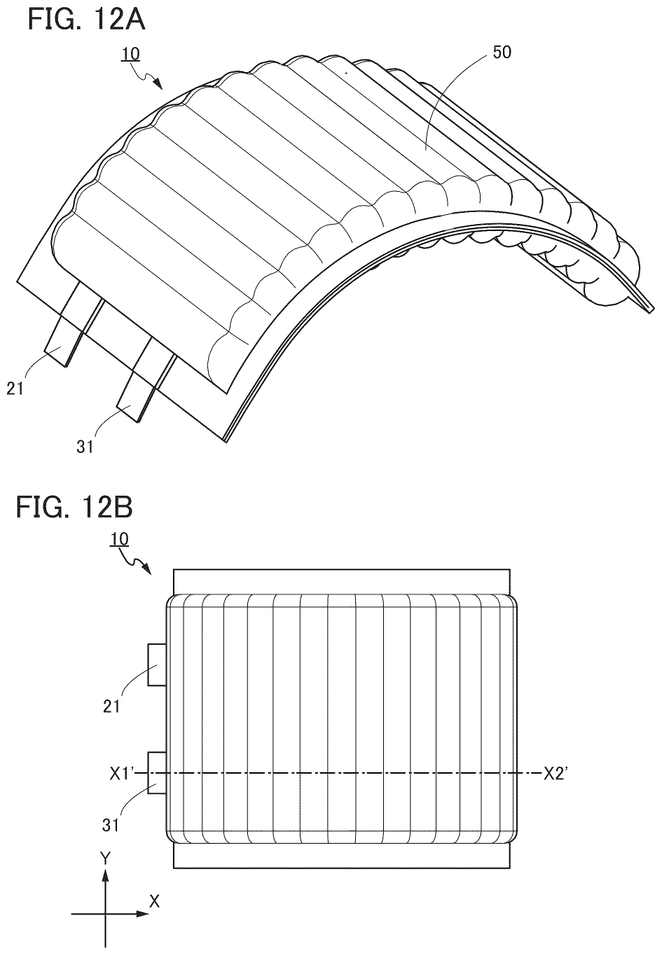

FIG. 1A and FIG. 1B are schematic cross-sectional views illustrating a positive electrode 20, a negative electrode 30, and a separator 40 included in a secondary battery 10 of one embodiment of the present invention illustrated in FIG. 12.

In the schematic cross-sectional view illustrated in FIG. 1A, the positive electrode 20 includes a positive electrode current collector 22 and a positive electrode active material layer 23. The negative electrode 30 includes a negative electrode current collector 32 and a negative electrode active material layer 33. The positive electrode 20 and the negative electrode 30 overlap with each other such that the positive electrode active material layer 23 faces the negative electrode active material layer 33 with the separator 40 therebetween.

In the schematic cross-sectional view illustrated in FIG. 1B in which part of the negative electrode 30 is enlarged, the negative electrode active material layer 33 provided over the negative electrode current collector 32 contains a negative electrode active material 34 and a binder 35. Note that the negative electrode active material layer 33 may contain a conductive material 36 in addition to the negative electrode active material 34 and the binder 35, but does not necessarily contain the conductive material 36 when the conductivity of the negative electrode active material 34 is sufficiently high.

Similarly, the positive electrode active material layer 23 provided over the positive electrode current collector 22 contains a positive electrode active material and a binder. The positive electrode active material layer 23 may contain a conductive material in addition to the positive electrode active material and the binder, but does not necessarily contain the conductive material when the conductivity of the positive electrode active material is sufficiently high.

Although not illustrated, the separator 40, the positive electrode active material layer 23, and the negative electrode active material layer 33 are impregnated with the electrolyte in the above embodiment.

### [Separator]

For the separator 40, a material having stability and an excellent liquid-retaining property with respect to an electrolyte is preferably used. The separator can be formed using, for example, fiber containing cellulose, such as paper, nonwoven fabric, glass fiber, ceramics, or synthetic fiber containing nylon (polyamide), vinylon (polyvinyl alcohol-based fiber), polyester, polyimide, acrylic, polyolefin, or polyurethane.

For the separator, a material having high wettability with respect to the electrolyte is preferably used. As the wettability is higher, the carrier ion conductivity is higher. The wettability can be evaluated by, for example, a sessile drop method in which an electrolyte is dripped on a separator and its contact angle is measured. When the contact angle is less than or equal to 25°, preferably less than 10°, the wettability can be regarded as being adequately high.

It is preferable that the separator have low air permeability resistance, that is, easily transmit a gas. The use of a separator with low air permeability resistance can increase carrier ion conductivity at extremely low temperatures, e.g., at −40° C.

The air permeability resistance measured by the Gurley test is preferably less than or equal to 600 seconds, further preferably less than or equal to 200 seconds. As the air permeability resistance is lower, the carrier ion conductivity can be higher. By contrast, excessively low air permeability resistance might cause a safety problem due to a short circuit. Thus, the air permeability resistance measured by the Gurley test is preferably greater than or equal to 61 seconds, further preferably greater than or equal to 70 seconds.

The separator preferably has a porosity higher than or equal to 30% and lower than or equal to 85%, further preferably higher than or equal to 45% and lower than or equal to 65%. High porosity is preferable because it facilitates impregnation with an electrolyte. The porosity of the separator on the positive electrode side may be different from that on the negative electrode side, and the porosity on the positive electrode side is preferably higher than the porosity on the negative electrode side. Examples of a structure with different porosities include a single material having different porosities and different kinds of materials with different porosities. In the case where different kinds of materials are used, stacking these materials allows the separator to have different porosities.

The thickness of the separator is preferably greater than or equal to 5 μm and less than or equal to 200 μm, further preferably greater than or equal to 5 μm and less than or equal to 100 μm.

The separator preferably has an average pore size greater than or equal to 40 nm and less than or equal to 3 μm, further preferably greater than or equal to 70 nm and less than or equal to 1 μm. A large average pore size is preferable because it facilitates passage of carrier ions. The average pore size of the separator on the positive electrode side may be different from that on the negative electrode side, and the average pore size on the positive electrode side is preferably larger than the average pore size on the negative electrode side. Examples of a structure with different average pore sizes include a single material having different average pore sizes and different kinds of materials with different average pore sizes. In the case where different kinds of materials are used, stacking these materials allows the separator to have different average pore sizes.

The separator preferably has a heat resistance temperature higher than or equal to 200° C.

A separator using polyimide and having a thickness greater than or equal to 10 μm and less than or equal to 50 μm and a porosity higher than or equal to 75% and lower than or equal to 85% is preferably used to increase the output characteristics of the secondary battery.

The separator may be processed into a bag-like shape to enclose or sandwich one of the positive electrode and the negative electrode.

The total thickness of the separator is preferably greater than or equal to 1 μm and less than or equal to 100 μm, and as long as having a thickness in this range, the separator may have either a single-layer structure or a multilayer structure. For the multilayer structure, an organic material film of polypropylene, polyethylene, or the like coated with a ceramics-based material, a fluorine-based material, a polyamide-based material, a mixture thereof, or the like can be used. As the ceramics-based material, for example, aluminum oxide particles, silicon oxide particles, or the like can be used. As the fluorine-based material, for example, PVDF, polytetrafluoroethylene, or the like can be used. As the polyamide-based material, for example, nylon, aramid (meta-based aramid or para-based aramid), or the like can be used.

When the surface of the separator is coated with the ceramics-based material, the oxidation resistance is improved; hence, deterioration of the separator in high-voltage charging and discharging can be suppressed and accordingly, the reliability of the secondary battery can be improved. When the surface of the separator is coated with the fluorine-based material, the separator is easily brought into close contact with an electrode, resulting in high output characteristics. When the surface of the separator is coated with the polyamide-based material, in particular, aramid, heat resistance is improved; hence, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of such a separator with a multilayer structure, which can have the functions of the materials, insulation between the positive electrode and the negative electrode can be ensured and the safety of the secondary battery can be kept even when the total thickness of the separator is small. This is preferable because in that case, the capacity of the secondary battery per volume can be increased.

### [Positive Electrode Active Material]

Although sometimes referred to as a positive electrode active material particle because of its form, the positive electrode active material is in any of a variety of forms other than a particle form. The positive electrode active material may be a primary particle having a plurality of crystallites, or a secondary particle formed of an aggregate of primary particles.

As the positive electrode active material, a material into and from which carrier ions can be inserted and extracted can be used. As the carrier ions, lithium ions, sodium ions, potassium ions, calcium ions, strontium ions, barium ions, beryllium ions, or magnesium ions can be used.

Examples of the material into and from which lithium ions can be inserted and extracted include lithium composite oxides with an olivine crystal structure, a layered rock-salt crystal structure, and a spinel crystal structure. For example, a lithium composite oxide with an olivine crystal structure is represented by LiMPO₄ (here, M includes any of Fe, Mn, Ni, and Co). Owing to excellent thermal stability, Fe and Mn show promise for next-generation positive electrode materials. A lithium composite oxide with a layered rock-salt crystal structure is, for example, represented by LiMO₂ (here, M includes any of Fe, Mn, Ni, and Co). In the case of containing Co, LiMO₂ is denoted as LiCoO₂, which is sometimes referred to as LCO and is sometimes called lithium cobalt oxide. A lithium composite oxide with a layered rock-salt crystal structure may contain two or more of Fe, Mn, Ni, and Co. One containing Ni, Mn, and Co is represented by LiNiCoMnO₂, which is sometimes referred to as NCM. The ratio of Ni:Co:Mn may be any of Ni:Co:Mn=1:1:1 and the neighborhood thereof, 8:1:1 and the neighborhood thereof, and 5:2:3 and the neighborhood thereof. Besides, oxides such as V₂O₅ and Nb₂O₅ are studied as positive electrode materials. Examples of a lithium composite oxide with a spinel crystal structure include a lithium manganese spinel (LiMn₂O₄).

A lithium composite oxide may contain at least one or more elements selected from the group consisting of nickel, chromium, aluminum, iron, magnesium, molybdenum, zinc, zirconium, indium, gallium, copper, titanium, niobium, silicon, fluorine, phosphorus, and the like. A lithium composite oxide containing Ni, Mn, and Co and further containing aluminum is sometimes referred to as NCMA. A lithium composite oxide containing Ni and Co and further containing aluminum is sometimes referred to as NCA.

The average particle diameter of the positive electrode active material is greater than or equal to 1 μm and less than or equal to 50 μm, preferably greater than or equal to 5 μm and less than or equal to 20 μm. In the case of a ternary composite oxide such as NCM, the positive electrode active material can be regarded as a secondary particle, and the average particle diameter of the secondary particle is preferably greater than or equal to 1 μm and less than or equal to 50 μm, further preferably greater than or equal to 5 μm and less than or equal to 20 μm.

The positive electrode active material having a different particle size is further added in some cases to increase the filling density of the active material. “Having a different particle size” means having a different local maximum value of the average particle diameter.

The positive electrode active material sometimes has a grain boundary positioned between crystallites.

The positive electrode active material sometimes contains an added element in the vicinity of its surface. The vicinity of the surface includes a surface portion of the positive electrode active material. In a cross-sectional view, the surface portion extends 50 nm or less, preferably 35 nm or less, further preferably 20 nm or less, most preferably 10 nm or less inward from the surface of the positive electrode active material.

The added element is preferably unevenly distributed in the vicinity of the surface. Uneven distribution refers to a state where the added element exists non-uniformly or unevenly, and in this state, the concentration of the added element is higher in one region than in another region. Uneven distribution may be referred to as segregation or precipitation.

Some kinds of added elements do not contribute to capacity as positive electrode active materials. The state where the added element is unevenly distributed can be checked from the fact that the added element exists at a higher concentration in the vicinity of the surface of the positive electrode active material than inside the positive electrode active material. The added element existing at least in the vicinity of the surface can hinder structural degradation at the time of charging and discharging, which inhibits the positive electrode active material from degrading.

A structure in which a surface portion is provided with respect to the inside of an active material is sometimes referred to as a core-shell structure.

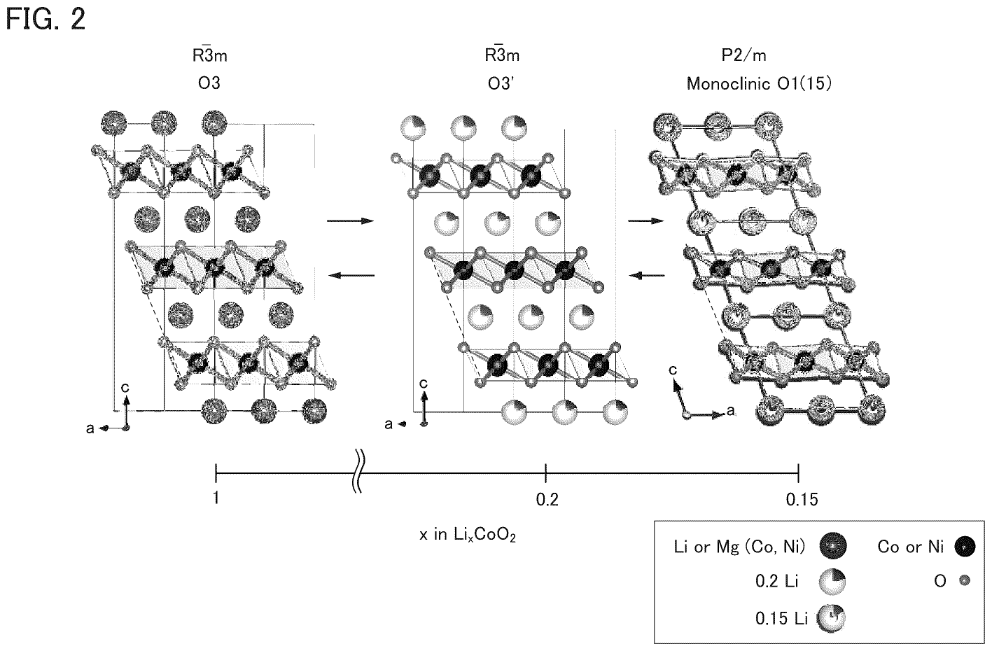

Since having high-voltage resistance, the electrolyte solution of one embodiment of the present invention is preferably combined with a positive electrode active material with high-voltage resistance, in which case a secondary battery capable of high-voltage charging and discharging can be fabricated. Examples of the positive electrode active material with high-voltage resistance include a positive electrode active material having an O3′ type crystal structure and a positive electrode active material having a monoclinic O1(15) type crystal structure at the time of charging, which are described with reference to FIG. 2 to FIG. 6B.

The positive electrode active material with high-voltage resistance contains lithium, cobalt, oxygen, and an added element. Alternatively, the positive electrode active material contains lithium cobalt oxide (LiCoO₂) to which an added element is added. Cobalt is used as a transition metal contained in the positive electrode active material at preferably greater than or equal to 75 atomic %, further preferably greater than or equal to 90 atomic %, still further preferably greater than or equal to 95 atomic %.

The positive electrode active material with high-voltage resistance preferably has a layered rock-salt crystal structure belonging to the space group R-3m in a discharged state, i e, in the case where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that an inner portion, which accounts for the majority of the volume of the positive electrode active material, have a layered rock-salt crystal structure. In FIG. 2, the layered rock-salt crystal structure is denoted by R-3m O3.

The surface portion of the positive electrode active material with high-voltage resistance preferably has a function of reinforcing the layered structure, which is formed of octahedrons of cobalt and oxygen, of the inner portion so that the layered structure does not break even when lithium is extracted from the positive electrode active material by charging. Here, the term “reinforce” means inhibiting a structural change of the surface portion and the inner portion of the positive electrode active material such as release of oxygen and/or a shift in the layered structure formed of octahedrons of cobalt and oxygen, and/or inhibiting oxidative decomposition of an electrolyte on the surface of the positive electrode active material.

Accordingly, the surface portion of the positive electrode active material preferably has a crystal structure different from that of the inner portion. The surface portion preferably has a more stable composition and a more stable crystal structure than those of the inner portion at room temperature (25° C.). For example, at least part of the surface portion of the positive electrode active material of one embodiment of the present invention preferably has a rock-salt crystal structure. Alternatively, the surface portion preferably has both a layered rock-salt crystal structure and a rock-salt crystal structure. Alternatively, the surface portion preferably has features of both a layered rock-salt crystal structure and a rock-salt crystal structure.

The surface portion is a region from which lithium ions are extracted first in charging, and is a region that tends to have a lower lithium concentration than the inner portion. Bonds between atoms are regarded as being partly cut on the surface of the particle of the positive electrode active material included in the surface portion. Thus, the surface portion is regarded as a region which is likely to be unstable and in which degradation of the crystal structure is likely to begin. For example, it is presumable that a shift in the crystal structure of the layered structure formed of octahedrons of cobalt and oxygen in the surface portion has an influence on the inner portion to cause a shift in the crystal structure of the layered structure in the inner portion, leading to degradation of the crystal structure in the whole positive electrode active material. Meanwhile, when the surface portion can be made sufficiently stable, the layered structure, which is formed of octahedrons of cobalt and oxygen, of the inner portion is unlikely to break even with small x in LiₓCoO₂, e.g., with x of 0.24 or less. Furthermore, a shift in layers, which are formed of octahedrons of cobalt and oxygen, of the inner portion can be inhibited.

In order that the surface portion can have a stable composition and a stable crystal structure, the surface portion preferably contains an added element, further preferably contains a plurality of added elements. The surface portion preferably has a higher concentration of one or more selected from the added elements than the inner portion. The one or more selected from the added elements contained in the positive electrode active material preferably have a concentration gradient. In addition, it is further preferable that the added elements contained in the positive electrode active material be differently distributed. For example, it is further preferable that peaks of the detected amounts of the added elements in the surface portion be exhibited at different depths from the surface or the reference point in EDX line analysis described later. The peak of the detected amount here refers to the local maximum value of the detected amount in the surface portion or the detected amount in a region from the surface to a depth of 50 nm or less. The detected amount refers to counts in EDX line analysis, for example.

As the added element, one or more selected from magnesium, fluorine, nickel, aluminum, titanium, zirconium, vanadium, iron, manganese, chromium, niobium, arsenic, zinc, silicon, sulfur, phosphorus, boron, bromine, and beryllium are preferably used.

The crystal structure in a state where x in LiₓCoO₂ is small of the positive electrode active material is different from that of a conventional positive electrode active material because the positive electrode active material has the above-described added element and/or crystal structure in a discharged state. Here. “x is small” means 0.1<x≤0.24.

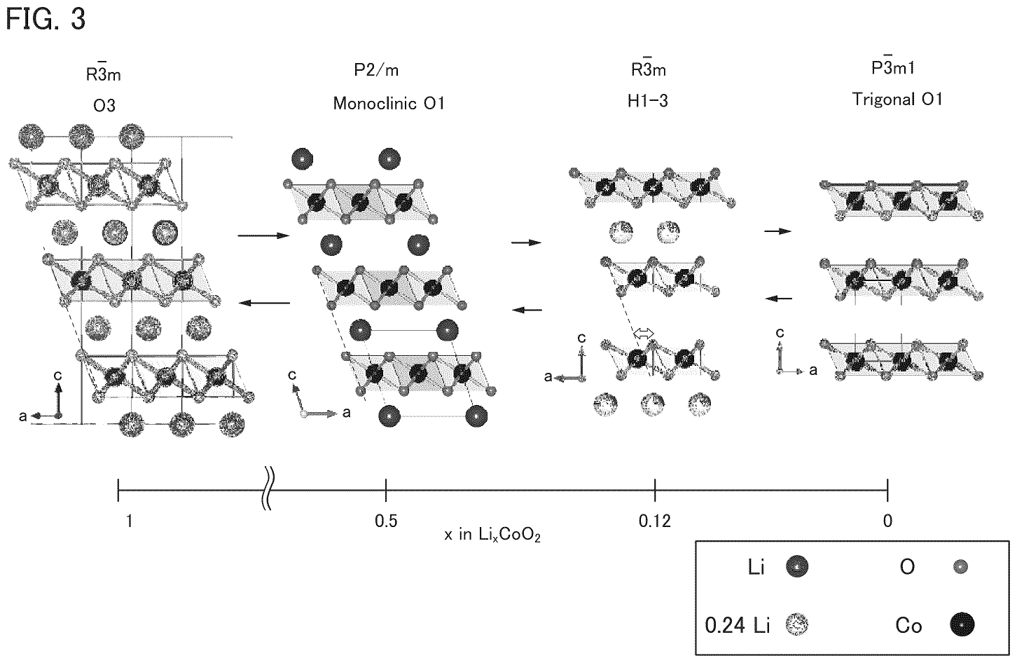

A change in the crystal structure of the conventional positive electrode active material is shown in FIG. 3. The conventional positive electrode active material shown in FIG. 3 is lithium cobalt oxide (LiCoO₂) without an added element in particular.

As shown in FIG. 3, conventional lithium cobalt oxide with x of approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in the positive electrode active material in reality, the lithium concentrations can vary; thus, the H1-3 type crystal structure is started to be observed when x is approximately 0.25 in practice. The number of cobalt atoms per unit cell in the actual H1-3 type crystal structure is twice that in other structures. However, in this specification including FIG. 3, the c-axis of the H1-3 type crystal structure is half that of the unit cell for easy comparison with the other crystal structures.

When charging that makes x in LiₓCoO₂ be 0.24 or less and discharging are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As denoted by the dotted lines and the arrows in FIG. 3, the CoO₂ layer in the H1-3 type crystal structure largely shifts from that in R-3m O3 in a discharged state. Such a dynamic structural change can adversely affect the stability of the crystal structure.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging are repeated, the crystal structure of conventional lithium cobalt oxide is gradually broken. The broken crystal structure triggers deterioration of the cycle performance. This is because the broken crystal structure has a smaller number of sites where lithium can exist stably and makes it difficult to insert and extract lithium.

Meanwhile, in the positive electrode active material with high-voltage resistance shown in FIG. 2, a change in the crystal structure between a discharged state with x in LiₓCoO₂ of 1 and a state with x of 0.24 or less is smaller than that in the conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material can have a crystal structure that is difficult to break even when charging that makes x be 0.24 or less and discharging are repeated, and enables excellent cycle performance. In addition, the positive electrode active material with x in LiₓCoO₂ of 0.24 or less can have a more stable crystal structure than the conventional positive electrode active material. Thus, the positive electrode active material with x in LiₓCoO₂ being kept at 0.24 or less inhibits a short circuit. This is preferable because the safety of the secondary battery is improved.

The positive electrode active material with x of approximately 0.2 has a trigonal crystal structure belonging to the space group R-3m. The symmetry of the CoO₂ layers of this structure is the same as that of 03. Thus, this crystal structure is called an O3′ type crystal structure. In FIG. 2, this crystal structure is denoted by R-3m O3′.

In the unit cell of the O3′ type crystal structure, the coordinates of cobalt and oxygen can be represented as follows: Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811 (Å), typically c=13.781 (Å).

When x is approximately 0.15, the positive electrode active material has a monoclinic crystal structure belonging to the space group P2/m. This structure includes one CoO₂ layer in a unit cell. Here, lithium in the positive electrode active material is approximately 15 atomic % of that in a discharged state. Thus, this crystal structure is referred to as a monoclinic O1(15) type crystal structure. In FIG. 2, this crystal structure is denoted by P2/m monoclinic O1(15).

In the unit cell of the monoclinic O1 (15) type crystal structure, the coordinates of cobalt and oxygen can be represented by Co1 (0.5, 0, 0.5), Co2 (0, 0.5, 0.5), O1 (X_{O1}, 0, Z_{O1}) within the range of 0.23≤X_{O1}≤0.24 and 0.61≤Z_{O1}≤0.65, and O2 (X_{O2}, 0.5, Z_{O2}) within the range of 0.75≤X_{O2}≤0.78 and 0.68≤Z_{O2}≤0.71. The unit cell has lattice constants a=4.880±0.05 Å, b=2.817±0.05 Å, c=4.839±0.05 Å, α=90°, β=109.6±0.1°, and γ=90°.

Note that this crystal structure can have the lattice constants even when belonging to the space group R-3m if a certain error is allowed. The coordinates of cobalt and oxygen in the unit cell in this case can be represented by Co (0, 0, 0.5) and O (0, 0, Z_{O}) within the range of 0.21≤Z_{O}≤0.23. The unit cell has lattice constants a=2.817±0.02 Å and c=13.68±0.1 Å.

As denoted by the dotted lines in FIG. 2, the CoO₂ layers hardly shift between the R-3m O3 type crystal structure in a discharged state, the O3′ type crystal structure, and the monoclinic O1 (15) type crystal structure.

The R-3m O3 type crystal structure in a discharged state and the O3′ type crystal structure which contain the same number of cobalt atoms have a difference in volume of 2.5% or less, specifically 2.2% or less, typically 1.8%.

The R-3m O3 type crystal structure in a discharged state and the monoclinic O1(15) type crystal structure which contain the same number of cobalt atoms have a difference in volume of 3.3% or less, specifically 3.0% or less, typically 2.5%.

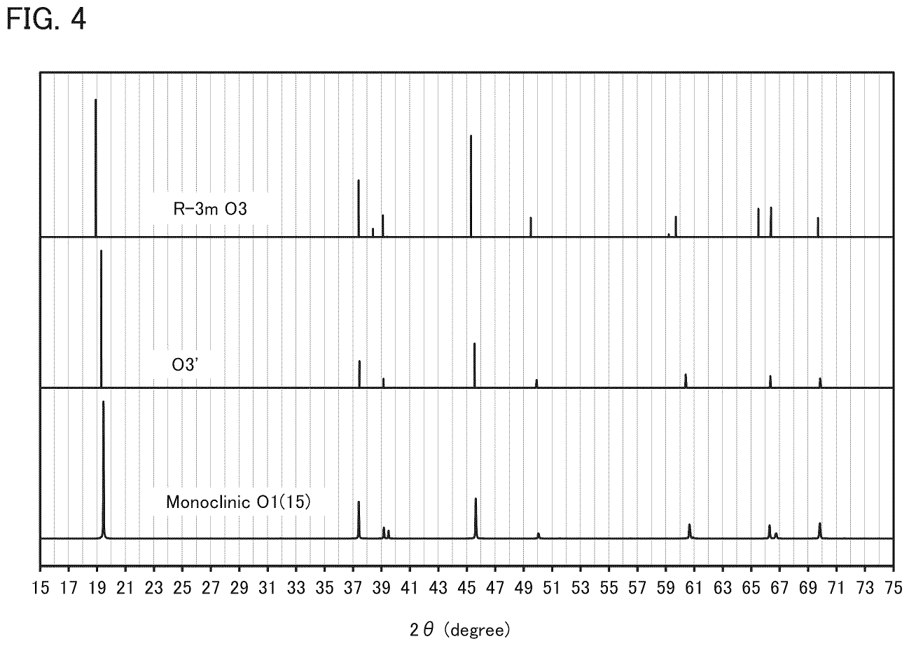

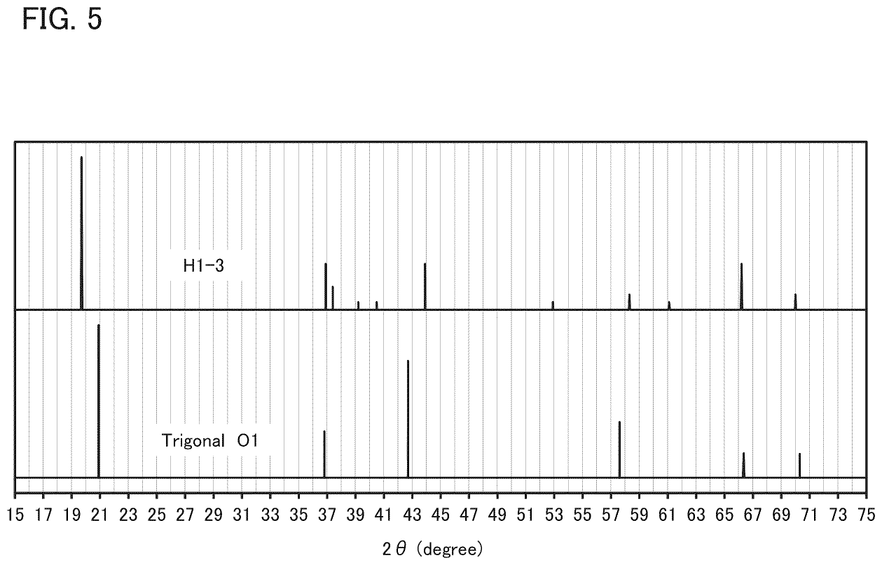

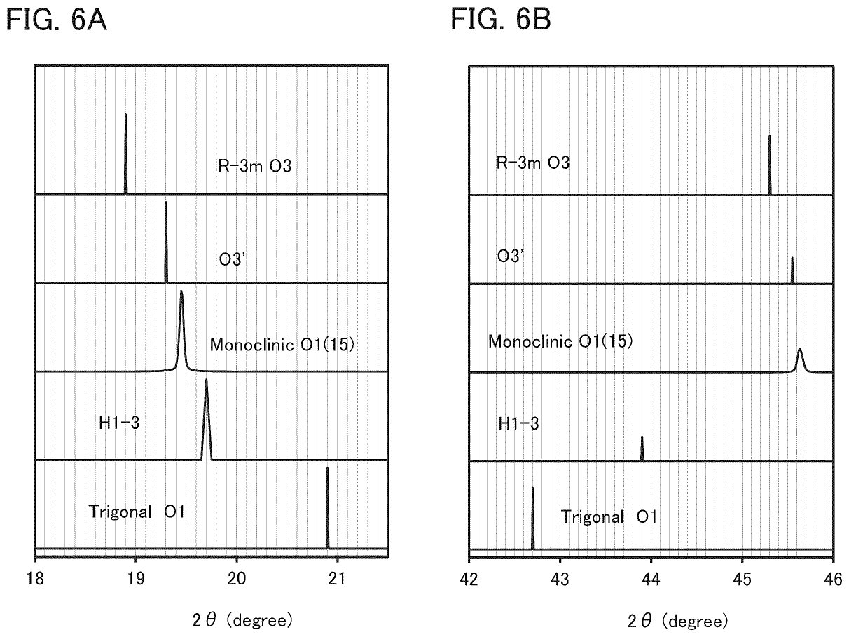

FIG. 4, FIG. 5, FIG. 6A, and FIG. 6B show ideal powder XRD patterns with CuKα₁ radiation that are calculated from models of the O3′ type crystal structure, the monoclinic O1(15) type crystal structure, and the H1-3 type crystal structure. For comparison, ideal XRD patterns calculated from the crystal structure of LiCoO₂ O3 with x in LiₓCoO₂ of 1 and the crystal structure of the trigonal O1 with x of 0 are also shown. FIG. 6A and FIG. 6B each show the XRD patterns of the O3′ type crystal structure, the monoclinic O1(15) type crystal structure, and the H1-3 type crystal structure, and FIG. 6A and FIG. 6B are enlarged diagrams showing, respectively, a range of 2θ greater than or equal to 18° and less than or equal to 21° and a range of 2θ greater than or equal to 42° and less than or equal to 46°.

As shown in FIG. 4, FIG. 6A, and FIG. 6B, the O3′ type crystal structure exhibits diffraction peaks at 2θ of 19.25±0.12° (greater than or equal to 19.13° and less than) 19.37° and 2θ of 45.47±0.10° (greater than or equal to 45.37° and less than 45.57°).

Furthermore, the monoclinic O1 (15) type crystal structure exhibits diffraction peaks at 2θ of 19.47±0.10° (greater than or equal to 19.37° and less than or equal to 19.57°) and 2θ of 45.62±0.05° (greater than or equal to 45.57° and less than or equal to 45.67°).

However, as shown in FIG. 5. FIG. 6A, and FIG. 6B, the H1-3 type crystal structure and the trigonal O1 do not exhibit peaks at these positions. Thus, exhibiting the peak at 2θ of greater than or equal to 19.13° and less than 19.37° and/or the peak at 2θ of greater than or equal to 19.37° and less than or equal to 19.57° and the peak at 2θ of greater than or equal to 45.37° and less than 45.57° and/or the peak at 2θ of greater than or equal to 45.57° and less than or equal to 45.67° in a state with small x in LiₓCoO₂ can be the feature of the positive electrode active material.

It can be said that the positions of the XRD diffraction peaks exhibited by the crystal structure with x of 1 and the crystal structure with x of 0.24 or less are close to each other in the positive electrode active material. More specifically, it can be said that in the 20 range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material has the O3′ type crystal structure and/or the monoclinic O1(15) type crystal structure when x in LiₓCoO₂ is small, not all particles in the positive electrode active material necessarily have the O3′ type crystal structure and/or the monoclinic O1(15) type crystal structure. The positive electrode active material may have another crystal structure or may be partly amorphous. Note that when the XRD patterns are subjected to the Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% can have sufficiently good cycle performance.

### [Binder]

A binder is provided to prevent an active material or a conductive material from slipping off from a current collector in a positive electrode and/or a negative electrode. A binder has a function of fixing an active material and a conductive material to each other. Thus, there are a binder positioned to be in contact with a current collector, a binder positioned between an active material and a conductive material, and a binder positioned to be intertwined with a conductive material.

The binder contains a resin that is a high molecular material. When a lot of binder is contained, the proportion of the positive electrode active material in the active material layer sometimes decreases. Such a decrease in the proportion of the active material leads to lowered discharge capacity of a secondary battery; thus, the mixed quantity of the binder is minimized.

### [Conductive Material]

In order to increase the conductivity of a positive electrode and/or a negative electrode, it is preferable that the positive electrode and/or the negative electrode contain a conductive material. For example, since a positive electrode active material is a composite oxide, it sometimes has high resistance. This makes it difficult to collect current from the positive electrode active material to a positive electrode current collector. In that case, the conductive material has a function of giving aid to a current path between the active material and the current collector, a current path between a plurality of the active materials, a current path between a plurality of the active materials and the current collector, and the like. To have such a function, the conductive material is formed of a material having lower resistance than the active material, and there are a conductive material positioned to be in contact with the current collector and a conductive material positioned in a gap of the active material.

A conductive material is also referred to as a conductivity-imparting agent or a conductive additive because of its function, and a carbon material or a metal material is used. Examples of the carbon material used as the conductive material include carbon black (furnace black, acetylene black, graphite, and the like). Carbon black has a smaller particle diameter than the positive electrode active material. Examples of a fibrous carbon material used as the conductive material include carbon nanotube (CNT) and VGCF (registered trademark). Examples of a carbon material in sheet form used as the conductive material include multilayer graphene.

The conductive material in particle form can enter a gap of the positive electrode active material and easily aggregates. Thus, the conductive material in particle form can give aid to a conductive path between positive electrode active materials provided close to each other (adjacent positive electrode active materials). Although having a bent region, the conductive material in fiber form or sheet form is larger than the positive electrode active material. The conductive material in fiber form or sheet form can thus give aid not only to a conductive path between adjacent positive electrode active materials but also to a conductive path between positive electrode active materials located apart from each other. A particulate conductive material, a fibrous conductive material, and a sheet-shaped conductive material are preferably mixed.

In the case where graphene is used as a sheet-shaped conductive material and carbon black is mixed as a particulate conductive material, the weight of carbon black is preferably greater than or equal to 1.5 times and less than or equal to 20 times, further preferably greater than or equal to twice and less than or equal to 9.5 times that of graphene in slurry.

When the mixing ratio between graphene and carbon black is in the above range, carbon black does not aggregate and is easily dispersed. When the mixing ratio between graphene and carbon black is in the above range, the electrode density can be higher than when only carbon black is used as a conductive material. As the electrode density is higher, the capacity per unit weight can be higher. Specifically, the density of the positive electrode active material layer measured by gravimetry can be higher than 3.5 g/cc.

A positive electrode which contains a mixture of graphene and carbon black and in which the mixing ratio of graphene to carbon black is in the above range enables fast charging as compared with a positive electrode containing only graphene as a conductive material. For example, fast charging of a portable information terminal is possible, thereby improving the convenience. A secondary battery capable of fast charging is preferably included in a vehicle, in which case the effect of charging of the secondary battery with power temporarily generated when the brake of the vehicle is applied, i.e., what is called regenerative charging, is enhanced.

### [Current Collector]

For the positive electrode current collector and the negative electrode current collector, metal foil containing aluminum, titanium, copper, nickel, or the like can be used.

### [Negative Electrode Active Material]

As the negative electrode active material, for example, an alloy-based material and a carbon-based material can be used. The negative electrode active material used for the secondary battery of one embodiment of the present invention particularly preferably contains fluorine as a halogen. Fluorine has high electronegativity, and the negative electrode active material containing fluorine in its surface portion may have an effect of facilitating removal of a solvent that has been solvated at the surface of the negative electrode active material.

For the negative electrode active material, an element that enables charging and discharging reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. For this reason, silicon is preferably used for the negative electrode active material. Alternatively, a compound containing any of these elements may be used. Examples of the compound include SiO (silicon monoxide, which is sometimes denoted as SiO_{X}, where x is preferably greater than or equal to 0.2 and less than or equal to 1.5), Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charging and discharging reactions by an alloying reaction and a dealloying reaction with lithium, a compound containing the element, and the like may be referred to as an alloy-based material.

Silicon nanoparticles can be used as the negative electrode active material containing silicon. The median diameter (D50) of a silicon nanoparticle is greater than or equal to 5 nm and less than 1 μm, preferably greater than or equal to 10 nm and less than or equal to 300 nm, further preferably greater than or equal to 10 nm and less than or equal to 100 nm. The silicon nanoparticles may have crystallinity. The silicon nanoparticles may include a region with crystallinity and an amorphous region.

The negative electrode active material containing silicon may be in the form of a silicon monoxide particle including one or more silicon crystal grains. The silicon monoxide may be amorphous. The silicon monoxide particle may be coated with carbon. This particle can be mixed with graphite to be used as the negative electrode active material.

As the carbon-based material, graphite, graphitizing carbon (soft carbon), non-graphitizing carbon (hard carbon), carbon nanotube, graphene, carbon black, or the like can be used. Such a carbon-based material preferably contains fluorine. A carbon-based material containing fluorine can also be referred to as a particulate or fibrous fluorinated carbon material. In the case where the carbon-based material is subjected to measurement by X-ray photoelectron spectroscopy, the concentration of fluorine is preferably higher than or equal to 1 atomic % with respect to the total concentration of fluorine, oxygen, lithium, and carbon.

Although the volume of the negative electrode active material sometimes changes in charging and discharging, an organic compound containing fluorine, such as fluorinated carbonate ester, placed between negative electrode active materials maintains smoothness and inhibits a crack even when the volume changes in charging and discharging, so that an effect of increasing cycle performance is obtained. It is important that an organic compound containing fluorine exists between a plurality of negative electrode active materials.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V vs. Li/Lit) when lithium ions are inserted into graphite (while a lithium-graphite intercalation compound is formed). For this reason, a lithium-ion secondary battery can have a high operating voltage. In addition, graphite is preferable because of its advantages such as relatively high capacity per unit volume, relatively small volume expansion, low cost, and a level of safety higher than that of lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

As the negative electrode active material. Li₃₋ₓMₓN (M is Co, Ni, or Cu) with a Li₃N structure, which is a composite nitride of lithium and a transition metal, can be used. For example, Li_{2.6}Co_{0.4}N₃ is preferable because of its high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO)), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

### [Fluorine-Modified Conductive Material]

The conductive material contained in the negative electrode is preferably modified with fluorine. For example, as the conductive material, a material obtained by modification of the above-described conductive material with fluorine can be used.

The conductive material can be modified with fluorine through treatment or heat treatment using a fluorine-containing gas or plasma treatment in a fluorine-containing gas atmosphere, for example. As the fluorine-containing gas, for example, a fluorine gas or a lower hydrofluorocarbon gas such as fluoromethane (CF₄) can be used.

Alternatively, the conductive material may be modified with fluorine through immersion in a solution containing hydrofluoric acid, tetrafluoroboric acid, hexafluorophosphoric acid, or the like or a solution containing a fluorine-containing ether compound, for example.

Modification of the conductive material with fluorine is expected to stabilize the structure of the conductive material and suppress a side reaction in charging and discharging processes of a secondary battery. The suppression of the side reaction can improve the charging and discharging efficiency. In addition, a decrease in capacity caused by repetitive charging and discharging can be suppressed. Thus, when the negative electrode of one embodiment of the present invention contains a conductive material that is modified with fluorine, an excellent secondary battery can be obtained.

In some cases, the stabilization of the structure of the conductive material stabilizes conduction characteristics, leading to high output characteristics.

This embodiment can be used in combination with the other embodiments.

### Embodiment 3

This embodiment will describe examples of shapes of several types of secondary batteries containing the materials and the like described in the foregoing embodiment.

### [Coin-Type Secondary Battery]

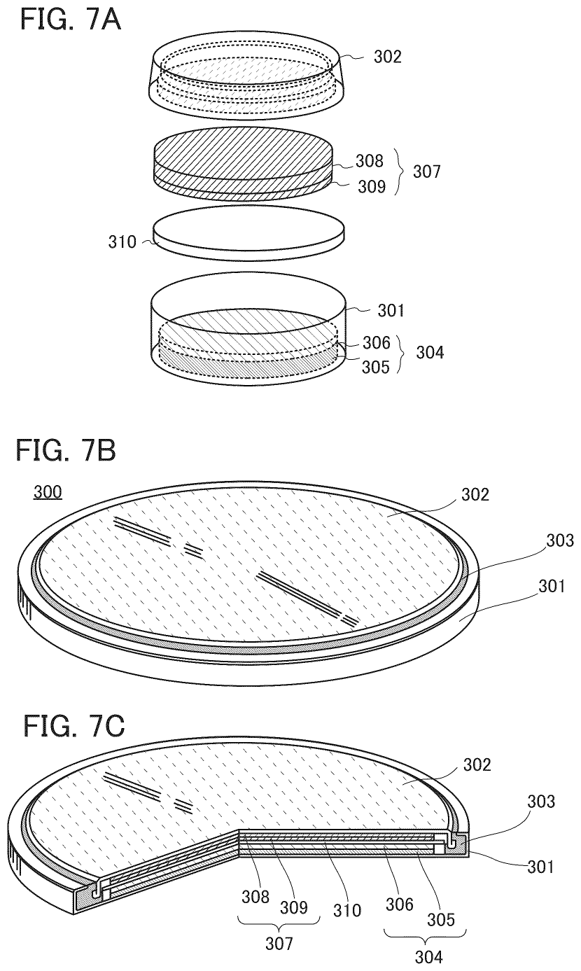

An example of a coin-type secondary battery will be described. FIG. 7B is an external view of a coin-type (single-layer flat type) secondary battery, FIG. 7A is a diagram illustrating the structure thereof, and FIG. 7C is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and a separator 310 are immersed in an electrolyte; as illustrated in FIG. 7A, the positive electrode 304, the separator 310, the negative electrode 307, and the negative electrode can 302 are stacked in this order with the positive electrode can 301 positioned at the bottom; and then, the positive electrode can 301 and the negative electrode can 302 are subjected to pressure bonding with the gasket 303 therebetween. When the electrolyte described in the above embodiment is used as the electrolyte of the secondary battery, it is possible to provide a secondary battery that can be used in a wide temperature range.

### [Secondary Battery Including Wound Body]

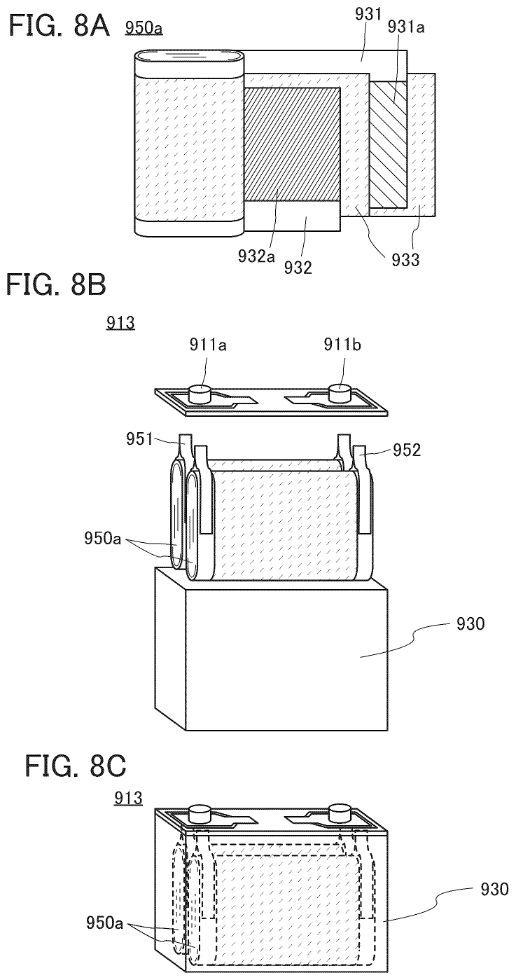

A secondary battery including a wound body will be described with reference to FIG. 8. A wound body 950a illustrated in FIG. 8A includes a negative electrode 931, a positive electrode 932, and separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 8A and FIG. 8B, the negative electrode 931 is electrically connected to a terminal 951. The terminal 951 is electrically connected to a terminal 911a. The positive electrode 932 is electrically connected to a terminal 952. The terminal 952 is electrically connected to a terminal 911b. The wound body 950a is immersed in an electrolyte inside a housing 930.

As illustrated in FIG. 8C, the wound body 950a and an electrolyte are covered with the housing 930, whereby a secondary battery 913 is completed. The housing 930 is preferably provided with a safety valve, an overcurrent protection element, and the like. A safety valve is a valve to be released, in order to prevent the battery from exploding, when the pressure inside the housing 930 reaches a predetermined pressure. For the housing 930, a metal material (e.g., aluminum or the like) and a resin material can be used.

As illustrated in FIG. 8B, the secondary battery 913 may include a plurality of the wound bodies 950a. The use of the plurality of wound bodies 950a enables the secondary battery 913 to have higher charge and discharge capacity.

When the electrolyte described in the above embodiment is used as the electrolyte of the secondary battery, it is possible to provide a secondary battery that can be used in a wide temperature range.

### [Cylindrical Secondary Battery]

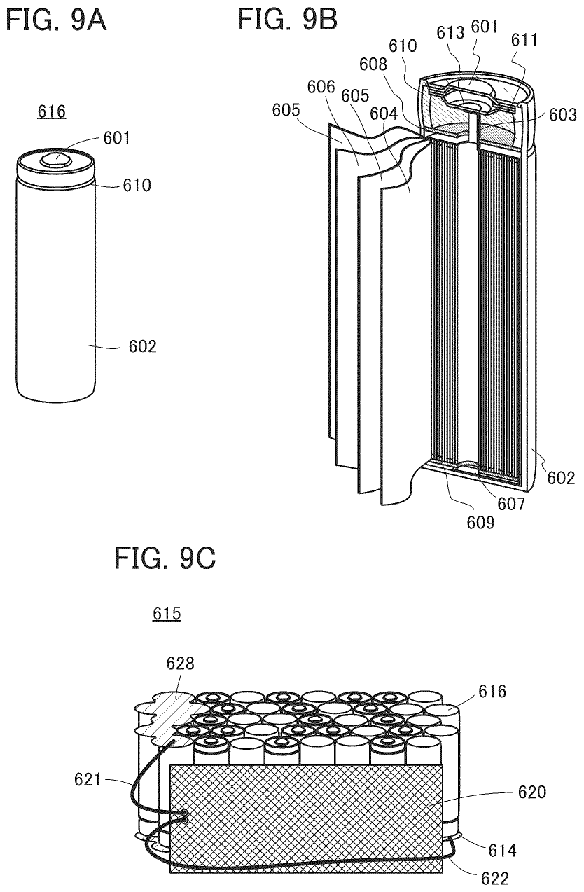

An example of a cylindrical secondary battery will be described with reference to FIG. 9A and FIG. 9B. As illustrated in FIG. 9A, a cylindrical secondary battery 616 includes a positive electrode cap (battery cap) 601 on the top surface and a battery can (outer can) 602 on the side surface and bottom surface. The battery can (outer can) 602 is formed using a metal material and has both an excellent water permeation barrier property and an excellent gas barrier property. The positive electrode cap 601 and the battery can (outer can) 602 are insulated from each other by a gasket (insulating gasket) 610.

As illustrated in FIG. 9B, inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is closed and the other end thereof is open. For the battery can 602, a metal having corrosion resistance to an electrolyte, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte (not illustrated). As the electrolyte, an electrolyte similar to that for the coin-type secondary battery can be used.

Since the positive electrode and the negative electrode that are used for the cylindrical secondary battery are wound, active materials are preferably formed on both surfaces of the current collectors.

When the electrolyte described in the above embodiment is used as the electrolyte of the secondary battery, it is possible to provide a secondary battery that can be used in a wide temperature range.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 9C illustrates an example of a battery pack 615. The battery pack 615 includes a plurality of the secondary batteries 616. The secondary batteries are electrically connected to a conductive plate 628 and a conductive plate 614. For clarity of the structure, part of the conductive plate 628 is selectively illustrated.

The plurality of secondary batteries 616 may be connected in parallel, connected in series, or connected in series after being connected in parallel, through the conductive plates and wirings. With the battery pack 615 including the plurality of secondary batteries 616, large electric power can be extracted.

The conductive plate 628 and the conductive plate 614 are electrically connected to a control circuit 620 respectively through a wiring 621 and a wiring 622. As the control circuit 620, a charging and discharging control circuit for performing charging, discharging, and the like and a protection circuit for preventing overcharging or overdischarging can be used.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the battery pack 615 is less likely to be influenced by the outside temperature.

### [Battery Pack Including Plurality of Kinds of Secondary Batteries]

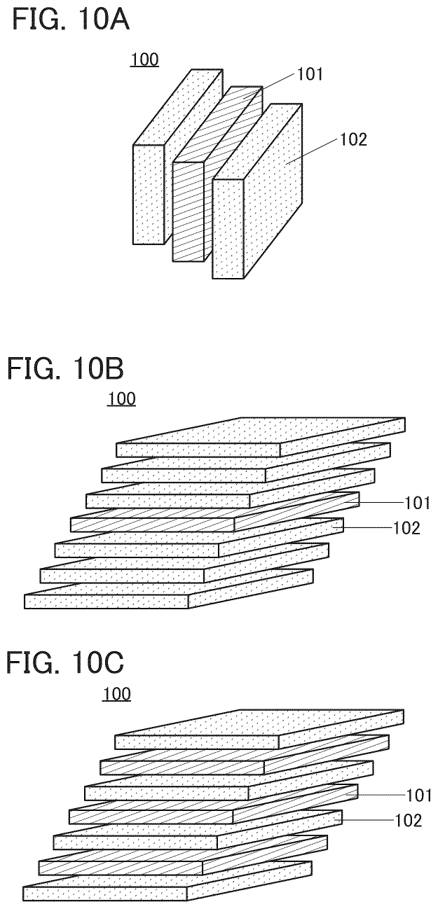

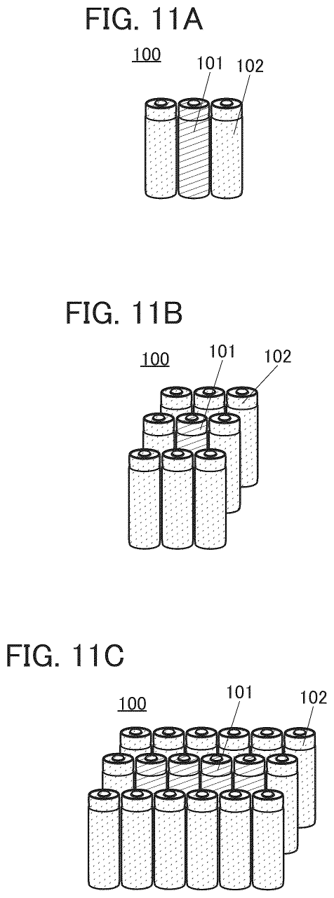

A battery pack in which secondary batteries containing different electrolytes are arranged will be described with reference to FIG. 10 and FIG. 11.

A battery pack 100 illustrated in FIG. 10A includes a secondary battery 101 and a secondary battery 102 adjacent to each other. The secondary battery 101 contains the electrolyte having excellent carrier ion conductivity even at low temperatures described in the above embodiment. The secondary battery 102 has high charge and discharge characteristics and high cycle performance in a middle temperature range. The middle temperature range refers to a temperature higher than or equal to 0° C. and lower than or equal to 45° C., for example. To have high charge and discharge characteristics in the middle temperature range, the secondary battery 102 preferably contains an organic solvent as an electrolyte. The use of an organic solvent as the electrolyte enables lower-cost manufacturing.

With such a structure, the secondary battery 102 can be heated using heat generated by charging and discharging of the secondary battery 101 as an internal heat source in a low temperature environment. When the secondary battery 102 is heated to reach or be close to the middle temperature range, high charge and discharge characteristics of the secondary battery 102 can be utilized.

In this specification and the like, the expression “A and B are adjacent to each other” means that A and B are not necessarily in contact with each other but are at a distance close enough to allow thermal conduction. For example, when A and B are in the same container, box, or bundle. A and B can be regarded as being adjacent to each other.

FIG. 10A illustrates an example in which the secondary battery 101 and the secondary battery 102 included in the battery pack 100 are rectangular solids and placed such that their largest surfaces face each other. Such a placement can increase the efficiency of thermal conduction.

The term “rectangular solid” refers to a hexahedron whose surfaces are all rectangular. In this specification and the like, these rectangular surfaces are not necessarily strictly rectangular nor completely flat. For example, a certain surface may be provided with a positive electrode terminal and/or a negative electrode terminal, or may have unevenness for higher strength. Such a shape may be referred to as a substantially rectangular solid.

In the battery pack 100, the secondary batteries 102 are preferably placed such that the secondary battery 101 that operates in a low temperature environment is surrounded by or interposed between the secondary batteries 102. In other words, the secondary battery 101 is preferably placed on the inner side.

FIG. 10B illustrates an example of the battery pack 100 in which one secondary battery 101 is interposed between six secondary batteries 102. FIG. 10C illustrates an example of the battery pack 100 in which three secondary batteries 101 and four secondary batteries 102 are placed alternately.

With any of these structures, heat generated by the secondary battery 101 can be efficiently conducted to the secondary batteries 102. In addition, a storage battery that can be used in a wide temperature range can be obtained even with a small number of secondary batteries 101, which are factors of cost increase.

FIG. 11A illustrates an example in which the secondary battery 101 and the secondary batteries 102 included in the battery pack 100 each have a cylindrical shape.

In this specification and the like, the cylindrical shape refers to a solid whose bottom and top surfaces are circular. These circular surfaces are not necessarily strictly circular nor completely flat. For example, the surface may be provided with a positive electrode terminal and/or a negative electrode terminal, or may have unevenness for higher strength. Such a shape may be referred to as a substantially cylindrical shape.

As in the case of the rectangular solid, FIG. 11B illustrates an example of the battery pack 100 in which one secondary battery 101 is surrounded by eight secondary batteries 102. FIG. 11C illustrates an example of the battery pack 100 in which four secondary batteries 101 are surrounded by fourteen secondary batteries 102.

It is preferable that the battery pack 100 further include a temperature sensor and a control circuit. The temperature sensor has a function of detecting at least the temperatures of the secondary batteries 102. The control circuit preferably has a function of making the secondary battery 101 generate heat so that the secondary batteries 102 are heated to the operating temperature range, when the temperatures of the secondary batteries 102 are lower than the operating temperature range.

For example, in the case of the battery pack 100 including the secondary battery 101 with an operating temperature range from −20° C. to 0° C., the secondary batteries 102 with an operating temperature range from 0° C. to 45° C.′, the temperature sensor, and the control circuit, the control circuit preferably has a function of making the secondary battery 101 generate heat so that the secondary batteries 102 are heated to the range from 0° C. to 45° C., when the temperatures of the secondary batteries 102 detected by the temperature sensor are lower than 0° C.

When the temperatures of the secondary batteries 102 are within the operating temperature range, the secondary battery 101 may be operated, i.e., charged or discharged, or is not necessarily operated. For example, the control circuit may have a function of making the secondary battery 101 operate when the temperatures of the secondary batteries 102 are lower than 25° C. and not making the secondary battery 101 operate when the temperatures of the secondary batteries 102 are higher than or equal to 25° C.

There is no particular limitation on the method for making the secondary battery 101 generate heat. The secondary battery 101 generates heat also when normal charging and discharging are performed.

The control circuit further preferably has a function of sensing at least one of overcharging, overdischarging, and overcurrent to protect the secondary battery 101 and the secondary batteries 102, in addition to the temperature controlling function.

### [Flexible Battery]

A flexible battery will be described with reference to FIG. 12 to FIG. 16.

FIG. 12B is a top view of the secondary battery 10 illustrated in FIG. 12A. The secondary battery 10 illustrated in FIG. 12A and FIG. 12B includes an exterior body 50 and a positive electrode lead 21 and a negative electrode lead 31 that extend from the inside of a space included in the exterior body 50 to the outside.

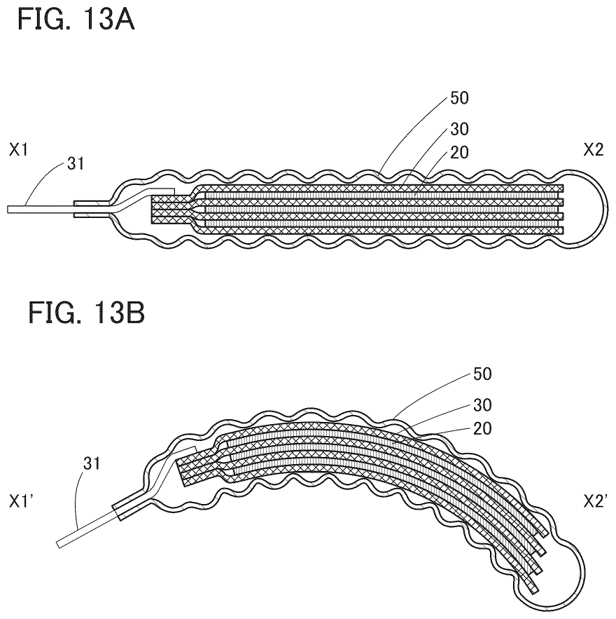

FIG. 13A and FIG. 13B are schematic cross-sectional views taken along the dashed-dotted line X1′-X2′ in FIG. 12B; FIG. 13A illustrates a state where the secondary battery 10 is not curved (an unbent state) and FIG. 13B illustrates a state where the secondary battery 10 is curved (a bent state). Note that a separator is not illustrated in FIG. 13A and FIG. 13B to avoid complexity of the drawings.

The secondary battery 10 can be repeatedly changed in shape between at least two shapes such as an uncurved shape and a curved shape as illustrated in FIG. 12A. FIG. 12B, and the like. Shapes that the secondary battery 10 of one embodiment of the present invention can have are not limited to the shapes illustrated in FIG. 12A, FIG. 12B, and the like. The secondary battery 10 can have two shapes of a shape in which it is curved with a first curvature radius and a shape in which it is curved with a second curvature radius different from the first curvature radius. Furthermore, the secondary battery 10 can be changed in shape between a plurality of different shapes; for example, the secondary battery 10 may also have a shape in which it is curved with a third curvature radius different from the first curvature radius and the second curvature radius.

The secondary battery 10 illustrated in FIG. 12A, FIG. 12B, and the like has a shape in which the entire secondary battery 10 is uniformly curved; however, the secondary battery 10 may include a first region where it is curved with the first curvature radius and a second region where it is curved with the second curvature radius different from the first curvature radius. Moreover, the secondary battery 10 may include a region where it is curved with two or more different curvature radii.

### [Example of Electrode Stack]

A structure example of a stack in which a plurality of electrodes are stacked and which can be used for a flexible battery will be described below.

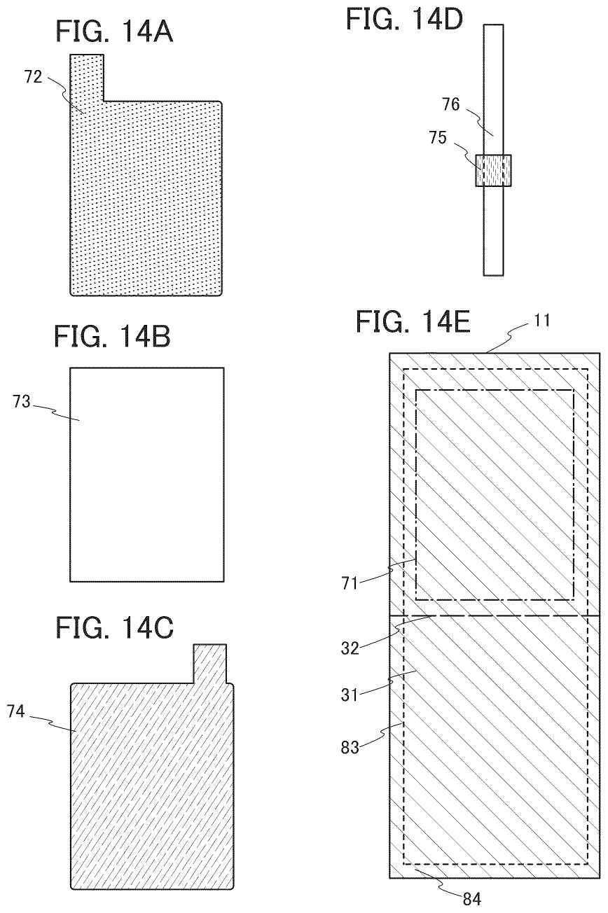

FIG. 14A shows a top view of a positive electrode current collector 72, FIG. 14B shows a top view of a separator 73, FIG. 14C shows a top view of a negative electrode current collector 74, FIG. 14D shows a top view of a sealing layer 75 and a lead electrode 76, and FIG. 14E shows a top view of a film-like exterior body 11.

The dimensions in the drawings of FIG. 14 are substantially the same, and a region 71 surrounded by a dashed-dotted line in FIG. 14E has substantially the same dimensions as the separator 73 in FIG. 14B. A dashed line and a region between the dashed line and the edge in FIG. 14E are respectively a bonding portion 83 and a bonding portion 84.

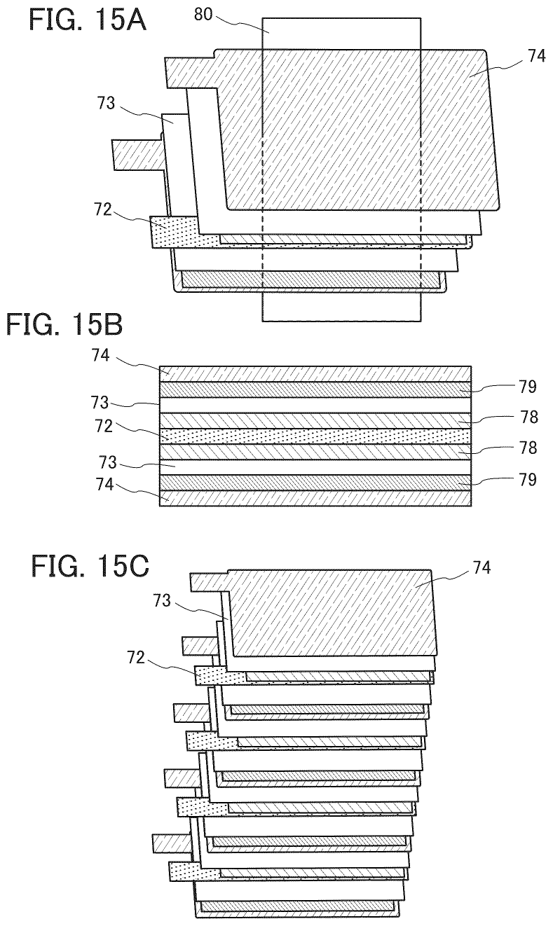

FIG. 15A is an example in which a positive electrode active material layer 78 is provided on both surfaces of the positive electrode current collector 72. Specifically, the negative electrode current collector 74, a negative electrode active material layer 79, the separator 73, the positive electrode active material layer 78, the positive electrode current collector 72, the positive electrode active material layer 78, the separator 73, the negative electrode active material layer 79, and the negative electrode current collector 74 are stacked in this order. FIG. 15B shows a cross-sectional view of the stacked-layer structure taken along a plane 80.

Although FIG. 15A illustrates an example in which two separators are used, a structure may be employed in which one separator is folded and both ends are sealed to form a bag-like shape, and the positive electrode current collector 72 is held therein. The positive electrode active material layer 78 is formed on both surfaces of the positive electrode current collector 72 held in the separator having a bag-like shape.

The negative electrode active material layer 79 can be provided on both surfaces of the negative electrode current collector 74. FIG. 15C illustrates an example of a secondary battery in which three negative electrode current collectors 74 each provided with the negative electrode active material layers 79 on both surfaces, four positive electrode current collectors 72 each provided with the positive electrode active material layers 78 on both surfaces, and eight separators 73 are sandwiched between two negative electrode current collectors 74 each provided with the negative electrode active material layer 79 on one surface. In this case, four separators each having a bag-like shape may be used instead of eight separators.

The capacity of the secondary battery can be increased by increasing the number of stacks. In addition, when the positive electrode active material layers 78 are provided on both surfaces of the positive electrode current collector 72 and the negative electrode active material layers 79 are provided on both surfaces of the negative electrode current collector 74, the thickness of the secondary battery can be made small.

In the case of thus stacking layers, ultrasonic welding is performed to fix and electrically connect all the positive electrode current collectors 72 at a time. Furthermore, when ultrasonic welding is performed with the positive electrode current collectors 72 overlapping with a lead electrode, they can be electrically connected to each other efficiently.

Ultrasonic welding can be performed in the following manner: ultrasonic waves are applied to the tab portion placed to overlap with a tab portion of another positive electrode current collector while pressure is applied thereto.

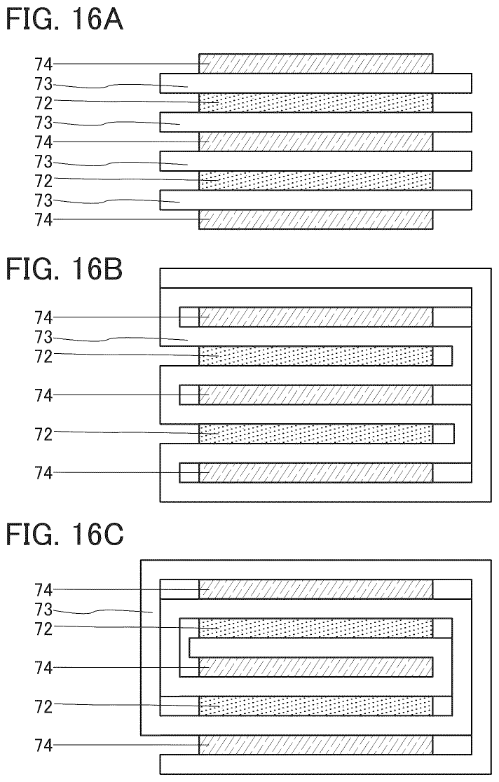

The separators 73 preferably have a shape that helps prevent an electrical short circuit between the positive electrode current collector 72 and the negative electrode current collector 74. For example, the width of each of the separators 73 is preferably larger than those of the positive electrode current collector 72 and the negative electrode current collector 74 as illustrated in FIG. 16A, in which case the positive electrode current collector 72 and the negative electrode current collector 74 are less likely to come in contact with each other even when the relative positions thereof are shifted because of a change in shape such as bending. As illustrated in FIG. 16B, one separator 73 is preferably folded into an accordion-like shape, or as illustrated in FIG. 16C, one separator 73 is preferably wrapped around the positive electrode current collectors 72 and the negative electrode current collectors 74 alternately, in which case the positive electrode current collector 72 and the negative electrode current collector 74 do not come in contact with each other even when the relative positions thereof are shifted. FIG. 16B and FIG. 16C each illustrate an example in which the separator 73 is provided to partly cover the side surface of a stacked-layer structure of the positive electrode current collectors 72 and the negative electrode current collectors 74.

Although the drawings of FIG. 16 do not illustrate the positive electrode active material layer 78 and the negative electrode active material layer 79, the above description can be referred to for formation methods thereof. Although an example in which the positive electrode current collectors 72 and the negative electrode current collectors 74 are alternately arranged is described here, two positive electrode current collectors 72 or two negative electrode current collectors 74 may be adjacent to each other as described above.

In this embodiment, one rectangle film is folded in half and two end portions are made to overlap with each other for sealing; however, the shape of the film is not limited to a rectangle. A polygon such as a triangle, a square, or a pentagon or any symmetric shape other than a rectangle, such as a circle or a star, may be employed.

This embodiment can be used in combination with the other embodiments.

### Embodiment 4

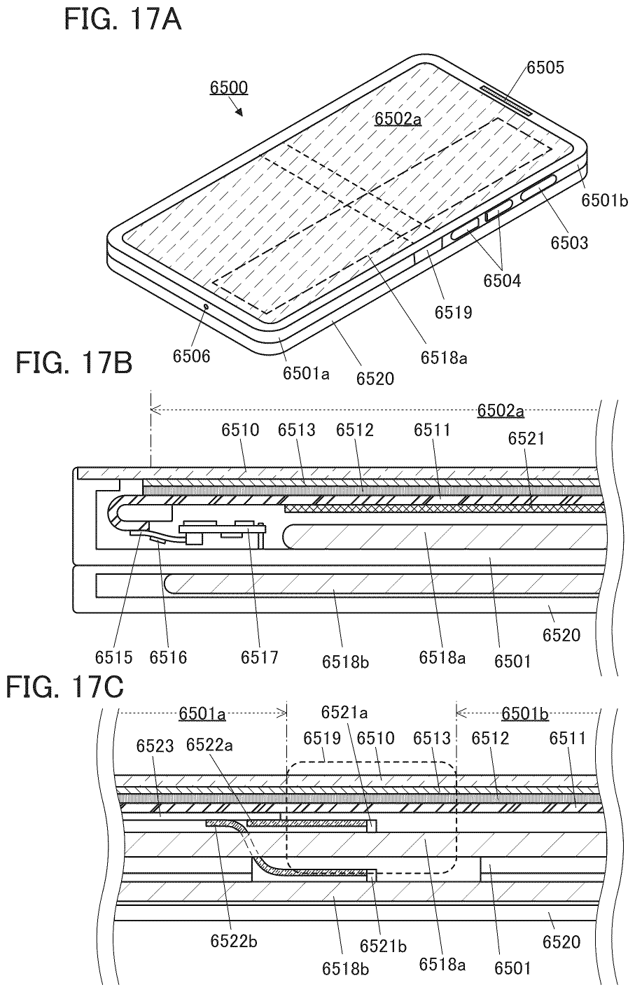

In this embodiment, examples of electronic devices each including the secondary battery of one embodiment of the present invention will be described with reference to FIG. 17 to FIG. 26. Examples of the electronic devices each including the secondary battery include an electric vehicle (EV), an electric bicycle, an electric motorcycle, a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

An electronic device 6500 illustrated in FIG. 17A is a portable information terminal that can be used as a smartphone.

The electronic device 6500 includes at least a first housing 6501a, a second housing 6501b, a hinge portion 6519, a display portion 6502a, a power button 6503, buttons 6504, a speaker 6505, and a microphone 6506. The display portion 6502a has a touch panel function. The first housing 6501a and the second housing 6501b are connected to each other through the hinge portion 6519.

The electronic device 6500 can be folded at the hinge portion 6519.

FIG. 17B is a schematic cross-sectional view including an end portion of a housing 6501 (6501a and 6501b) on the microphone 6506 side.

A protection member 6510 having a light-transmitting property is provided on the display surface side of the housing 6501 (6501a and 6501b), and a display panel 6511, an optical member 6512, a touch sensor panel 6513, a printed circuit board 6517, and a first battery 6518a are provided in a space surrounded by the housing 6501 (6501a and 6501b) and the protection member 6510.

The display panel 6511, the optical member 6512, and the touch sensor panel 6513 are fixed to the protection member 6510 with an adhesive layer (not illustrated).

Part of the display panel 6511 is folded back in a region outside the display portion 6502a, and an FPC 6515 is connected to the part that is folded back. An IC 6516 is mounted on the FPC 6515. The FPC 6515 is connected to a terminal provided on the printed circuit board 6517.

A flexible display can be used as the display panel 6511. The flexible display includes a plurality of flexible films and employs a plurality of light-emitting elements arranged in a matrix. As the light-emitting elements, EL elements (also referred to as EL devices) such as OLEDs or QLEDs are preferably used. Examples of a light-emitting substance contained in the EL element include a substance that emits fluorescent light (a fluorescent material), a substance that emits phosphorescent light (a phosphorescent material), an inorganic compound (a quantum dot material or the like), and a substance exhibiting thermally activated delayed fluorescence (a thermally activated delayed fluorescent (TADF) material). An LED such as a micro LED can also be used as the light-emitting element.

The use of the flexible display allows the display panel 6511 to be provided at a position overlapping with the first housing 6501a, the second housing 6501b, and the hinge portion 6519, and to be folded at the hinge portion 6519.

The use of the flexible display allows an internal space of the housing 6501 (6501a and 6501b) to be effectively utilized and an extremely lightweight electronic device to be achieved. Since the display panel 6511 is extremely thin, the first battery 6518a with high capacity can be mounted while the thickness of the electronic device is reduced.

Furthermore, in the electronic device 6500 using the high capacity battery, a second battery 6518b is provided inside a cover portion 6520 and is electrically connected to the first battery 6518a although the connection portion therebetween is not illustrated. The flexible battery of one embodiment of the present invention can be used as the first battery 6518a and the second battery 6518b.

The use of the flexible battery allows the battery to be provided at a position overlapping with the first housing 6501a, the second housing 6501b, and the hinge portion 6519, and to be folded at the hinge portion 6519.

FIG. 17C is a schematic cross-sectional view including the hinge portion 6519.

The first battery 6518a and the second battery 6518b each preferably include a battery connection portion 6521 (6521a and 6521b) provided with a positive electrode lead and a negative electrode lead in a region overlapping with the hinge portion 6519 or in the vicinity of the region overlapping with the hinge portion 6519. The battery connection portion 6521 can be electrically connected to a printed circuit board 6523 through an FPC 6522 (6522a and 6522b). The battery connection portion 6521 can include a protection circuit such as an overcharging protection circuit, an overdischarging protection circuit, an overcurrent protection circuit, or an overtemperature protection circuit.

A battery 6518 extends from one side to the other side of the hinge portion 6519 and includes the battery connection portion 6521, and the battery connection portion 6521 is provided in the region overlapping with the hinge portion 6519 or in the vicinity of the region overlapping with the hinge portion 6519 as described above. Thus, as described in Embodiment 1, the battery 6518 can be curved with reduced stress applied to a positive electrode lead connection portion or a negative electrode lead connection portion included in the battery 6518. That is, degradation of the battery 6518 due to curving can be inhibited.

The first battery 6518a and the second battery 6518b each preferably include a portion fixed to the housing 6501 (6501a and 6501b) and a portion fixed to the cover portion 6520 in the region overlapping with the hinge portion 6519 or in the vicinity of the region overlapping with the hinge portion 6519. The first battery 6518a and the second battery 6518b can slide in the housing 6501 (6501a and 6501b) and the cover portion 6520 other than in the fixed portions, which facilitates curving of the battery 6518 inside the electronic device 6500.

Part of the display panel 6511 is folded back such that a connection portion with the FPC 6515 is provided on the rear side of a pixel portion, whereby an electronic device with a narrow bezel can be achieved.

When the flexible battery of one embodiment of the present invention is used as one or both of the first battery 6518a and the second battery 6518b, the electronic device 6500 can be partly folded to be downsized, so that the electronic device 6500 with high portability can be achieved.

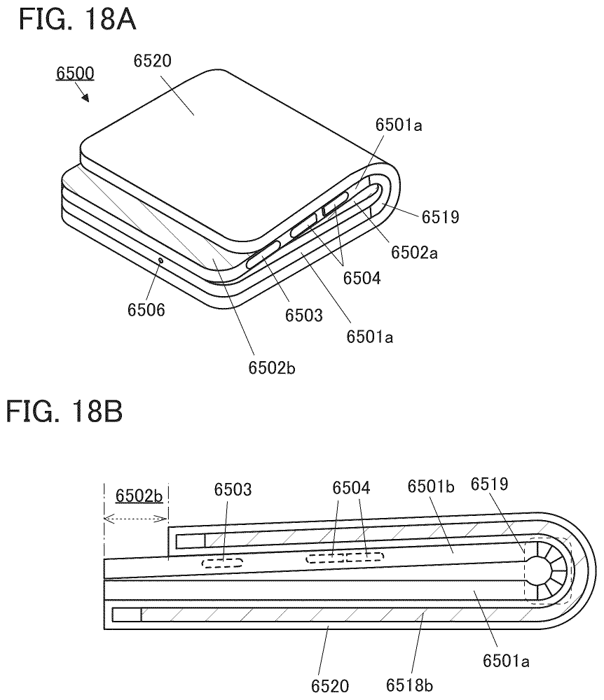

FIG. 18A is a perspective view illustrating a folded state along the dotted line portion in FIG. 17A. The electronic device 6500 can be folded in half; the display portion 6502a and the second battery 6518b can be folded repeatedly.

FIG. 18A has a structure in which a second display portion 6502b is provided in a portion exposed when the cover portion 6520 slides by folding. Even when the electronic device 6500 is folded in half, a user can check simple time display or e-mail reception notification display by seeing the second display portion 6502b.

FIG. 18B schematically illustrates a cross-sectional state of the cover portion in a state where the electronic device 6500 is folded. In FIG. 18B, the inside of the housing 6501 (6501a and 6501b) is not illustrated for simplicity.

In FIG. 18B, the hinge portion 6519 can be referred to as a connection portion and can have various modes as well as a structure example in which a plurality of columnar bodies are connected. It is particularly preferable that the hinge portion 6519 have a mechanism capable of curving the display portion 6502a and the second battery 6518b without stretching.

Although the second battery 6518b is illustrated inside the cover portion 6520, a plurality of second batteries may be included. In addition, a charging control circuit or a wireless charging circuit of the second battery 6518b may be provided inside the cover portion 6520.

In the example, the cover portion 6520 is partly fixed to the housing 6501 (6501a and 6501b) and is not fixed to a portion overlapping with the hinge portion 6519 and a portion overlapping with the second display portion 6502b that is exposed when the cover portion 6520 slides by folding.

The cover portion 6520 is not necessarily fixed to the housing 6501 (6501a and 6501b) and may be detachable. In the case where high capacity is not needed, the electronic device 6500 can be used while the cover portion 6520 is detached and only the first battery 6518a is used. Charging of the detached second battery 6518b allows supplementary charging of the first battery 6518a when the second battery 6518b is reconnected to the first battery 6518a. Thus, the cover portion 6520 can also be used as a mobile battery.

FIG. 18A and FIG. 18B illustrate an example in which the display portion 6502a is folded in half such that the display surface faces inside; however, there is no particular limitation and the hinge portion 6519 may have a structure allowing the display portion 6502a to be folded in half such that the display surface faces outside.

The flexible battery of one embodiment of the present invention has high reliability with respect to repetitive deformation, and thus can be suitably used for the device that can be folded (also referred to as a foldable device).

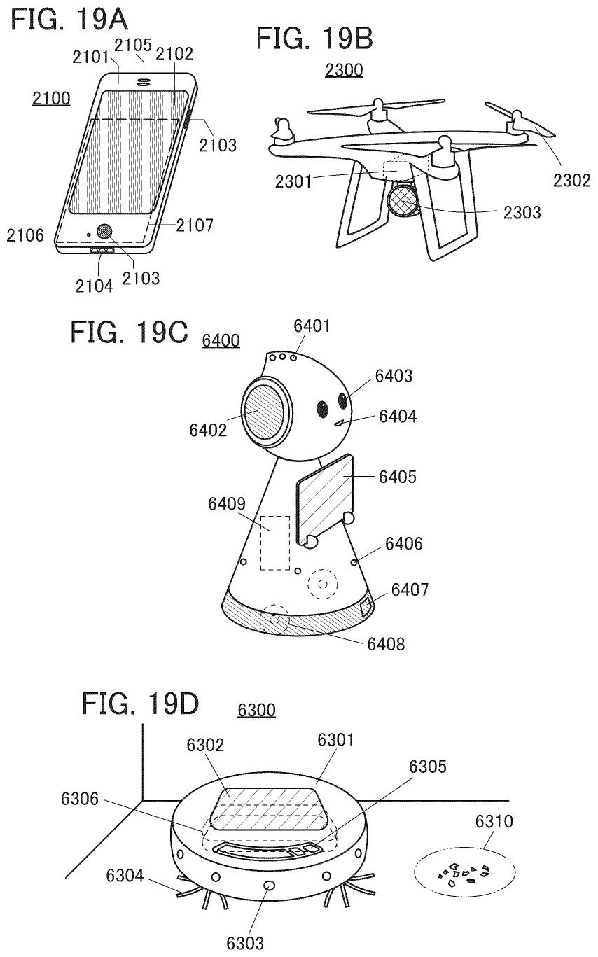

FIG. 19A illustrates an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. With the secondary battery 2107 containing the electrolyte described in Embodiment 1, it is possible to provide the mobile phone 2100 that can be used in a wide temperature range.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and can perform direct data transmission and reception with another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 19B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery containing the electrolyte described in Embodiment 1 can be used in a wide temperature range and is thus suitable as the secondary battery included in the unmanned aircraft 2300.

FIG. 19C illustrates an example of a robot. A robot 6400 illustrated in FIG. 19C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. The secondary battery containing the electrolyte described in Embodiment 1 can be used in a wide temperature range and is thus suitable as the secondary battery 6409 included in the robot 6400.

FIG. 19D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. The secondary battery containing the electrolyte described in Embodiment 1 can be used in a wide temperature range and is thus suitable as the secondary battery 6306 included in the cleaning robot 6300.

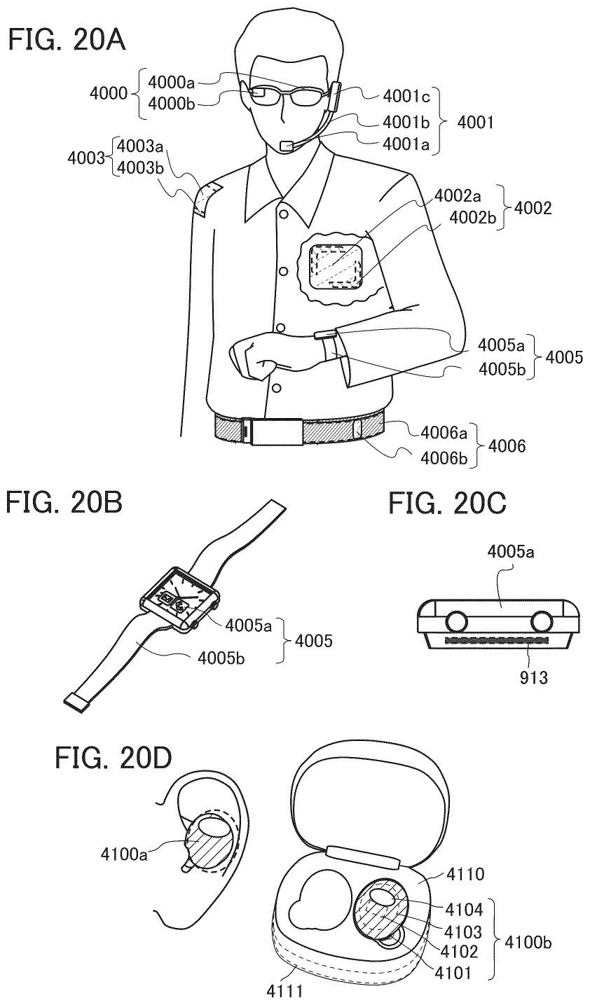

FIG. 20A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 20A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. The secondary battery containing the electrolyte described in Embodiment 1 can be used in a wide temperature range and is thus suitable as the secondary battery included in the glasses-type device 4000.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. The secondary battery containing the electrolyte described in Embodiment 1 can be used in a wide temperature range and is thus suitable as the secondary battery included in the headset-type device 4001.

The secondary battery of one embodiment of the present invention can be provided in a device 4002 that can be attached directly to a body. A secondary battery 4002b can be provided in a thin housing 4002a of the device 4002. The secondary battery containing the electrolyte described in Embodiment 1 can be used in a wide temperature range and is thus suitable as the secondary battery included in the device 4002.

The secondary battery of one embodiment of the present invention can be provided in a device 4003 that can be attached to clothes. A secondary battery 4003b can be provided in a thin housing 4003a of the device 4003. The secondary battery containing the electrolyte described in Embodiment 1 can be used in a wide temperature range and is thus suitable as the secondary battery included in the device 4003.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. The secondary battery containing the electrolyte described in Embodiment 1 can be used in a wide temperature range and is thus suitable as the secondary battery included in the belt-type device 4006.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. The secondary battery containing the electrolyte described in Embodiment 1 can be used in a wide temperature range and is thus suitable as the secondary battery included in the watch-type device 4005.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be mounted therein. Data on the exercise quantity and health of the user can be stored to be used for health maintenance.

FIG. 20B is a perspective view of the watch-type device 4005 that is detached from an arm.

FIG. 20C is a side view. FIG. 20C illustrates a state where the secondary battery 913 is incorporated in the inner region. The secondary battery 913 is the secondary battery described in the above embodiment. The secondary battery 913 is provided at a position overlapping with the display portion 4005a, can have high density and high capacity, and is small and lightweight.

FIG. 20D illustrates an example of wireless earphones. The wireless earphones illustrated here include, but are not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charging control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. The secondary battery containing the electrolyte described in Embodiment 1 can be used in a wide temperature range and is thus suitable as the secondary battery included in the wireless earphones.

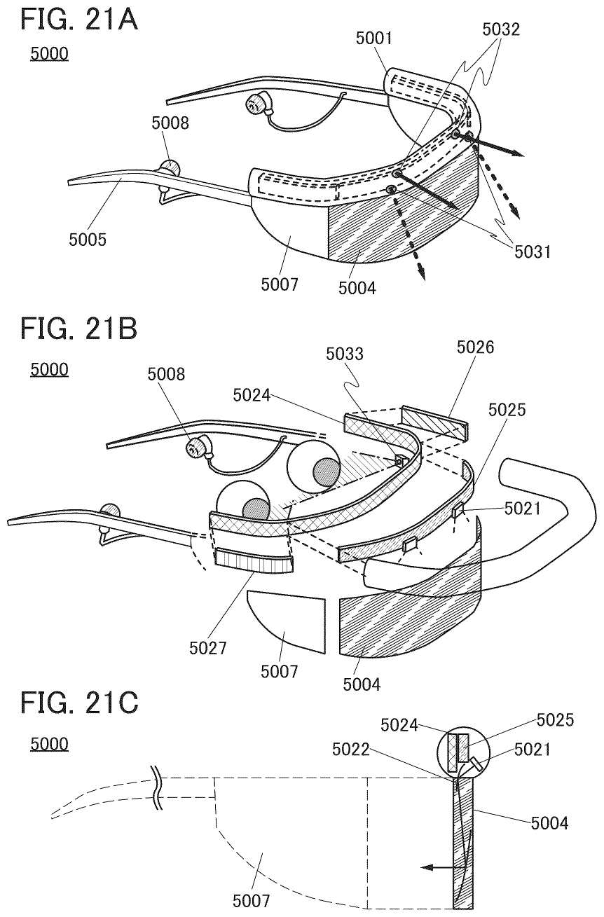

FIG. 21A to FIG. 21C illustrate another example of the glasses-type device. FIG. 21A is a perspective view of a glasses-type device 5000.

The glasses-type device 5000 has a function of what is called a portable information terminal and can execute a variety of programs and reproduce a variety of content when connected to the Internet, for example. The glasses-type device 5000 has a function of displaying AR (Augmented Reality) content in the AR mode, for example. The glasses-type device 5000 may have a function of displaying VR (Virtual Reality) content in the VR mode. Note that the glasses-type device 5000 may also have a function of displaying substitutional reality (SR) content or mixed reality (MR) content, in addition to AR and VR content.

The glasses-type device 5000 includes a housing 5001, an optical member 5004, a wearing tool 5005, a light-blocking unit 5007, earphones 5008, and the like. The housing 5001 preferably has a cylindrical shape. The glasses-type device 5000 is preferably wearable on the user's head. Further preferably, the glasses-type device 5000 is worn such that the housing 5001 is positioned above the circumference of the user's head passing through eyebrows and ears. When the housing 5001 has a cylindrical shape that is curved along the user's head, the glasses-type device 5000 can fit more snugly. The housing 5001 is fixed to the optical member 5004. The optical member 5004 is fixed to the wearing tool 5005 with the light-blocking unit 5007 or the housing 5001 therebetween. The glasses-type device 5000 includes two types of imaging devices (a camera 5031 and a camera 5032) for capturing images of the outside of the glasses-type device. The camera 5031 has a function of capturing an image of the front side of the housing 5001, and includes a wide-angle lens for capturing an image within a range of about one meter from the glasses-type device 5000, for example. The camera 5031 is an imaging device mainly used for capturing an image of user's hands movement for gesture operation. The camera 5032 is an imaging device mainly used for capturing the scenery and has a lens that is more telephoto than that of the camera 5031. That is, the camera 5032 has a longer focal length and a narrower angle of view than the camera 5031. The camera 5031 and the camera 5032 may each include a zooming mechanism for changing the focal length. In that case, the camera 5032 is selected such that the maximum focal length of the camera 5032 is greater than the maximum focal length of the camera 5031. The glasses-type device 5000 includes a pair of imaging devices (cameras 5033) for capturing an image of the inner side of the glasses-type device 5000. The pair of cameras 5033 are cameras for capturing images of the right eye and the left eye. The cameras 5033 preferably have sensitivity to infrared light. Since the cameras 5033 can capture images of the user's right and left eyes independently, the images can be used for iris authentication, health care, eye tracking, or the like. Although not illustrated, a light source that emits infrared light used for lighting is preferably included. Note that the glasses-type device 5000 may have a structure including one camera 5033 that captures an image of both eyes. Alternatively, the glasses-type device 5000 may have a structure including one camera 5033 that captures an image of one eye.

The glasses-type device 5000 includes a display device 5021, a reflective plate 5022, a flexible battery 5024, and a system unit. Each of the display device 5021, the reflective plate 5022, the flexible battery 5024, and the system unit is preferably provided inside the housing 5001. The system unit can be provided with a control unit, a memory unit, and a communication unit included in the glasses-type device 5000, a sensor, and the like. The system unit is preferably provided with a charging circuit, a power supply circuit, and the like. The flexible battery 5024 can be bent and mounted in a curved portion.

FIG. 21B illustrates components included in the glasses-type device 5000 in FIG. 21A. FIG. 21B is a schematic view illustrating the details of the components included in the glasses-type device 5000 illustrated in FIG. 21A. FIG. 21C is a schematic side view illustrating the glasses-type device 5000.

In the glasses-type device 5000 illustrated in FIG. 21B, the flexible battery 5024, a system unit 5026, and a system unit 5027 are provided along the cylindrical housing 5001. A system unit 5025 is provided along the flexible battery 5024 and the like.

The housing 5001 preferably has a curved cylindrical shape. When the flexible battery 5024 is provided along the curved cylinder, the flexible battery 5024 can be provided efficiently in the housing 5001 and the space in the housing 5001 can be used efficiently; as a result, the volume of the flexible battery 5024 can be increased in some cases.

The housing 5001 has a cylindrical shape and the axis of the cylinder is along a part of a substantially elliptical shape, for example. A cross section of the cylinder is preferably substantially elliptical, for example. Alternatively, a part of a cross section of the cylinder preferably has a part of an elliptical shape, for example. In particular, in the case where the glasses-type device 5000 is worn on a head, the part of the cross section having a part of an elliptical shape is preferably positioned on a side facing the head. Note that one embodiment of the present invention is not limited thereto. For example, a part of a cross section of the cylinder may have a polygonal (e.g., triangular, quadrangular, or pentagonal) part.

The housing 5001 is formed so as to be curved along the user's forehead, for example. Alternatively, the housing 5001 is positioned along the user's forehead, for example.

The housing 5001 may be formed using two or more cases in combination. For example, the housing 5001 can be formed using an upper case and a lower case in combination. Alternatively, the housing 5001 can be formed using a case on an inner side (a side in contact with the user) and a case on an outer side in combination, for example. The housing 5001 may be formed using three or more cases in combination

An electrode can be provided in a portion of the housing 5001 in contact with the user's forehead to measure brain waves using the electrode. Alternatively, an electrode may be provided in a portion in contact with the user's forehead to acquire information such as user's sweat using the electrode.

A plurality of the flexible batteries 5024 described in the above embodiment may be provided inside the housing 5001.

The flexible battery 5024 can be provided along the curved cylinder, which is preferable. The flexible battery has flexibility, and thus can be positioned inside the housing more freely. The flexible battery 5024, a system unit, and the like are provided inside the cylindrical housing. The system unit is provided over a plurality of circuit boards, for example. The plurality of circuit boards and the flexible battery are connected using a connecter, a wiring, and the like. The flexible battery has flexibility, and thus can be positioned so as not to overlap with a connector, a wiring, and the like.

Note that the flexible battery 5024 may be provided, for example, inside the wearing tool 5005 as well as inside the housing 5001.

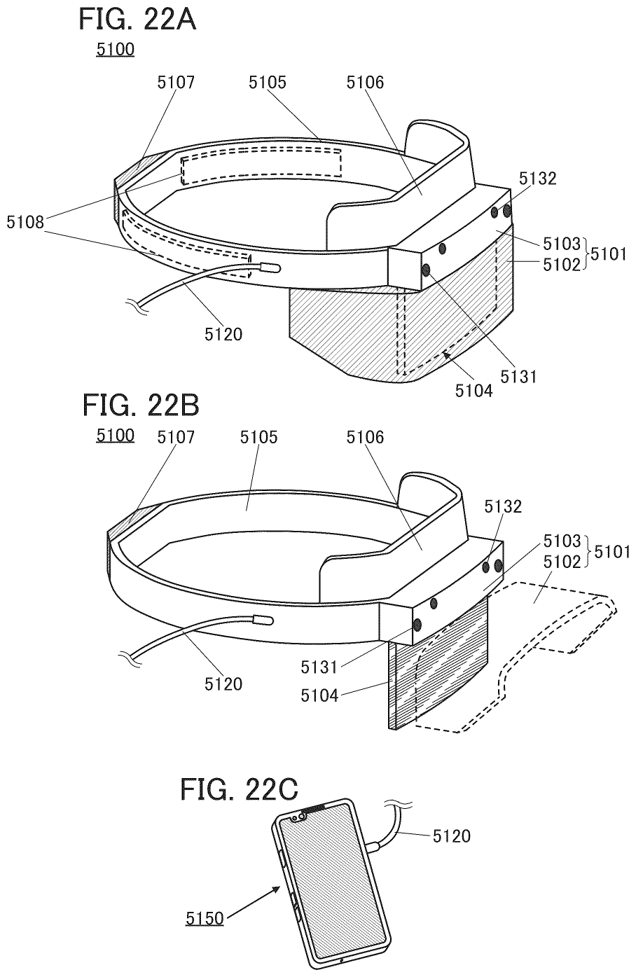

FIG. 22A to FIG. 22C illustrate an example of a head-mounted device. FIG. 22A and FIG. 22B illustrate a head-mounted device 5100 including a wearing tool 5105 with a band-like shape. The head-mounted device 5100 is connected to a terminal 5150 illustrated in FIG. 22C through a cable 5120.

FIG. 22A illustrates a state where a first portion 5102 attached to part 5103 of the housing is closed, and FIG. 22B illustrates a state where the first portion 5102 is opened. The first portion 5102 has a shape that covers not only the front but also the side of the face in the closed state. Accordingly, the user's view can be blocked from external light, so that realistic sensation and the sense of immersion can be increased. For example, it is also possible to increase the user's sense of fear depending on content to be displayed.

In the electronic device illustrated in FIG. 22A and FIG. 22B, the wearing tool 5105 has a band-like shape. Accordingly, the electronic device is less likely to slip as compared with the structure illustrated in FIG. 21A and the like and thus is preferable in enjoying content with relatively large momentum, such as an attraction.

A flexible battery 5107 or the like may be incorporated on the rear head side of the wearing tool 5105. Keeping a balance between the weight of the housing 5101 on the front head side and the weight of the flexible battery 5107 on the rear head side can adjust the center of gravity of the head-mounted device 5100, whereby the device can be worn more comfortably.

A flexible battery 5108 having flexibility may be provided inside the wearing tool 5105 with a band-like shape. FIG. 22A illustrates an example in which two flexible batteries 5108 are provided inside the wearing tool 5105. The flexible battery having flexibility is preferably used, in which case the flexible battery can have a curved band shape.

The wearing tool 5105 includes a camera 5131, a camera 5132, and an optical member 5104. For these components, refer to the description of the camera 5031, the camera 5032, and the optical member 5004 illustrated in FIG. 21A to FIG. 21C. The wearing tool 5105 includes a portion 5106 covering the user's forehead or front head. Owing to the portion 5106, the wearing tool 5105 is less likely to slip. An electrode can be provided in the portion 5106 or a portion of the housing 5101 that is in contact with the user's forehead to measure brain waves using the electrode.

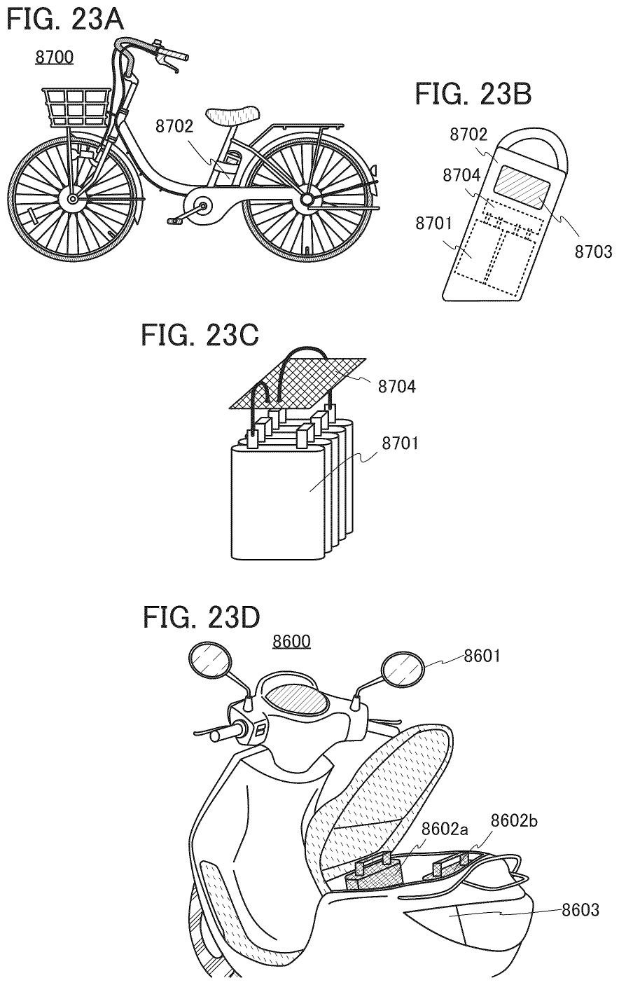

FIG. 23A illustrates an example of an electric bicycle using the secondary battery of one embodiment of the present invention. The battery pack of one embodiment of the present invention can be used for an electric bicycle 8700 illustrated in FIG. 23A. The battery pack of one embodiment of the present invention includes a plurality of secondary batteries and a protection circuit, for example.

The electric bicycle 8700 includes a power storage device 8702. The power storage device 8702 can supply electricity to a motor that assists a rider. The power storage device 8702 is portable, and FIG. 23B illustrates the state where the power storage device 8702 is detached from the bicycle. As illustrated in FIG. 23C, the power storage device 8702 includes a plurality of secondary batteries 8701 of one embodiment of the present invention and a control circuit 8704. The control circuit 8704 is electrically connected to positive electrodes and negative electrodes of the secondary batteries 8701 and is capable of charging control or anomaly detection of the secondary batteries. The power storage device 8702 can display the remaining battery capacity or the like on a display portion 8703. With the use of the secondary battery containing the electrolyte described in Embodiment 1 as each secondary battery 8701, it is possible to provide the electric bicycle that can be used in a wide temperature range.

FIG. 23D illustrates an example of a motorcycle using the power storage device of one embodiment of the present invention. A motor scooter 8600 illustrated in FIG. 23D includes a power storage device 8602a, a power storage device 8602b, side mirrors 8601, and indicator lights 8603. The power storage device 8602a and the power storage device 8602b can supply electricity to a motor and the indicator lights 8603. With the use of the secondary battery containing the electrolyte described in Embodiment 1 as each of the power storage device 8602a and the power storage device 8602b, it is possible to provide the motor scooter 8600 that can be used in a wide temperature range.

In the motor scooter 8600 illustrated in FIG. 23D, the power storage device 8602a and the power storage device 8602b can be stored in an under-seat storage unit. Although the motor scooter 8600 includes the power storage device 8602a and the power storage device 8602b in this embodiment, one embodiment of the present invention is not limited thereto. The number of power storage devices may be one, or three or more.

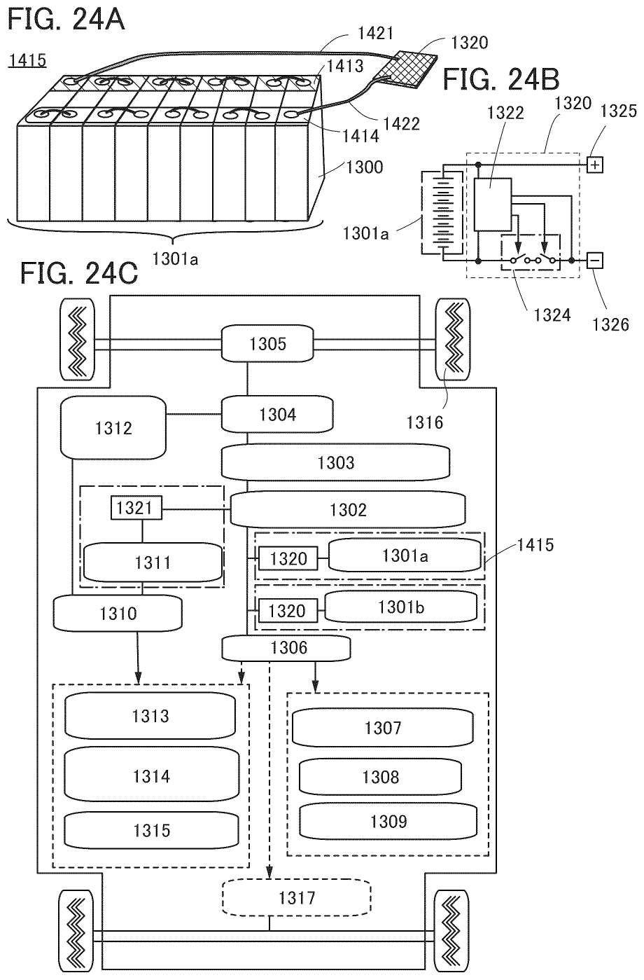

FIG. 24C illustrates an example in which the secondary battery of the present invention is used in an electric vehicle (EV).

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (a starter battery). The second battery 1311 only needs high output and high capacity is not so much needed; the capacity of the second battery 1311 is lower than that of the first batteries 1301a and 1301b.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a will be described with reference to FIG. 24A.

FIG. 24A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing) Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charging control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (an element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, and magnesium) or the like is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion Note that distortion refers to a portion where the orientation of a lattice in some cases, arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state where one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic proportions of In, Ga, and Zn in the metal elements contained in the CAC-OS in an In—Ga—Zn oxide are denoted by [In]. [Ga], and [Zn], respectively. For example, the first region in the CAC-OS in the In—Ga—Zn oxide is a region having [In] higher than [In] in the composition of the CAC-OS film. Moreover, the second region is a region having [Ga] higher than [Ga] in the composition of the CAC-OS film. Alternatively, for example, the first region is a region having [In] higher than [In] in the second region and [Ga] lower than [Ga] in the second region. Moreover, the second region is a region having [Ga] higher than [Ga] in the first region and [In] lower than [In] in the first region.

Specifically, the first region is a region containing an indium oxide, an indium zinc oxide, or the like as its main component. The second region is a region containing a gallium oxide, a gallium zinc oxide, or the like as its main component. That is, the first region can be rephrased as a region containing In as its main component. The second region can be rephrased as a region containing Ga as its main component.

Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Jon), high field-effect mobility (u), and excellent switching operation can be achieved.

An oxide semiconductor has various structures with different properties. Two or more kinds among an amorphous oxide semiconductor, a polycrystalline oxide semiconductor, an a-like OS, a CAC-OS, an ne-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety.

The control circuit portion 1320 that includes a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: charging and discharging performed a plurality of times cause uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharging, an output transistor of a charging circuit and an interruption switch can be turned off substantially at the same time.

FIG. 24B illustrates an example of a block diagram of the first battery 1301a and the control circuit portion 1320 of the battery pack 1415 illustrated in FIG. 24A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, and the like. The range from the lower limit voltage to the upper limit voltage of the secondary battery falls within the recommended voltage range; when voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaO, (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system).

In this embodiment, an example in which the secondary battery described in the above embodiment is used as both the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit) in some cases. The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, and a three-phase 200 V outlet with 50 KW, for example. Furthermore, charging can be performed with electric power supplied from external charging equipment by a contactless power feeding method or the like.

For fast charging, secondary batteries that can withstand high-voltage charging have been desired to perform charging in a short time.

Moreover, the above-described secondary battery of this embodiment can achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

The secondary battery of this embodiment can be used in a wide temperature range and thus can be suitably used in a vehicle.

Next, examples in which the secondary battery of one embodiment of the present invention is mounted on a vehicle, typically a transport vehicle, will be described.

Mounting the secondary battery or the power storage device described in the above embodiment on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be used in a wide temperature range and thus can be suitably used in transport vehicles.

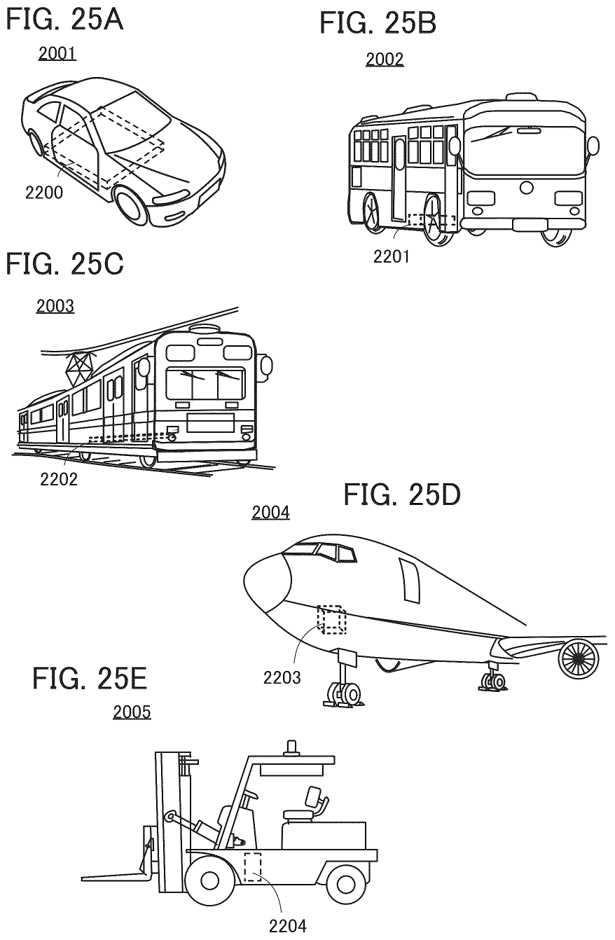

FIG. 25A to FIG. 25E illustrate examples of transport vehicles using one embodiment of the present invention. An automobile 2001 illustrated in FIG. 25A is an electric vehicle that runs using an electric motor as a driving power source. Alternatively, the automobile 2001 is a hybrid vehicle that can appropriately select an electric motor or an engine as a driving power source. In the case where the secondary battery is mounted on the vehicle, an example of the secondary battery described in Embodiment 4 is provided at one position or several positions. The automobile 2001 illustrated in FIG. 25A includes a battery pack 2200, and the battery pack includes a secondary battery module in which a plurality of secondary batteries are connected to each other. Moreover, the battery pack preferably includes a charging control device that is electrically connected to the secondary battery module.

The automobile 2001 can be charged when the secondary battery included in the automobile 2001 is supplied with electric power from external charging equipment by a plug-in system, a contactless power feeding system, or the like. In charging, a given method such as CHAdeMO (registered trademark) or Combined Charging System may be employed as a charging method, the standard of a connector, and the like as appropriate. Charging equipment may be a charging station provided in a commerce facility or a household power supply. For example, with the use of the plug-in system, the power storage device mounted on the automobile 2001 can be charged by being supplied with electric power from the outside. The charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 25B illustrates a large transporter 2002 having a motor controlled by electricity as an example of a transport vehicle. A secondary battery module of the transporter 2002 has a cell unit of four secondary batteries with a nominal voltage of 3.0 V or higher and 5.0 V or lower, and 48 cells are connected in series to have 170 V as the maximum voltage, for example. A battery pack 2201 has the same function as the battery pack in FIG. 25A except, for example, the number of secondary batteries configuring the secondary battery module; thus, the description is omitted.

FIG. 25C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. With the secondary battery containing the electrolyte described in Embodiment 1, it is possible to provide the transport vehicle 2003 that can be used in a wide temperature range. A battery pack 2202 has the same function as the battery pack in FIG. 25A except, for example, the number of secondary batteries configuring the secondary battery module; thus, the description is omitted.

FIG. 25D illustrates an aircraft 2004 having a combustion engine as an example. The aircraft 2004 illustrated in FIG. 25D is regarded as a kind of transport vehicles because it has wheels for takeoff and landing, and includes a battery pack 2203 that includes a charging control device and a secondary battery module configured by connecting a plurality of secondary batteries.

The secondary battery module of the aircraft 2004 has eight 4 V secondary batteries connected in series, which has a maximum voltage of 32 V, for example. The battery pack 2203 has the same function as the battery pack in FIG. 25A except, for example, the number of secondary batteries configuring the secondary battery module; thus, the description is omitted.

FIG. 25E illustrates a transport vehicle 2005 that transports a load as an example. The transport vehicle 2005 includes a motor controlled by electricity and executes various operations with the use of electric power supplied from secondary batteries configuring a secondary battery module of a battery pack 2204. The transport vehicle 2005 is not limited to operation by a human who rides thereon as a driver, and an unmanned operation is also possible by CAN communication or the like. Although FIG. 25E illustrates a fork lift, there is no particular limitation and a battery pack including the secondary battery of one embodiment of the present invention can be mounted on industrial machines capable of being operated by CAN communication or the like. e.g., automatic transporters, working robots, and small construction equipment.

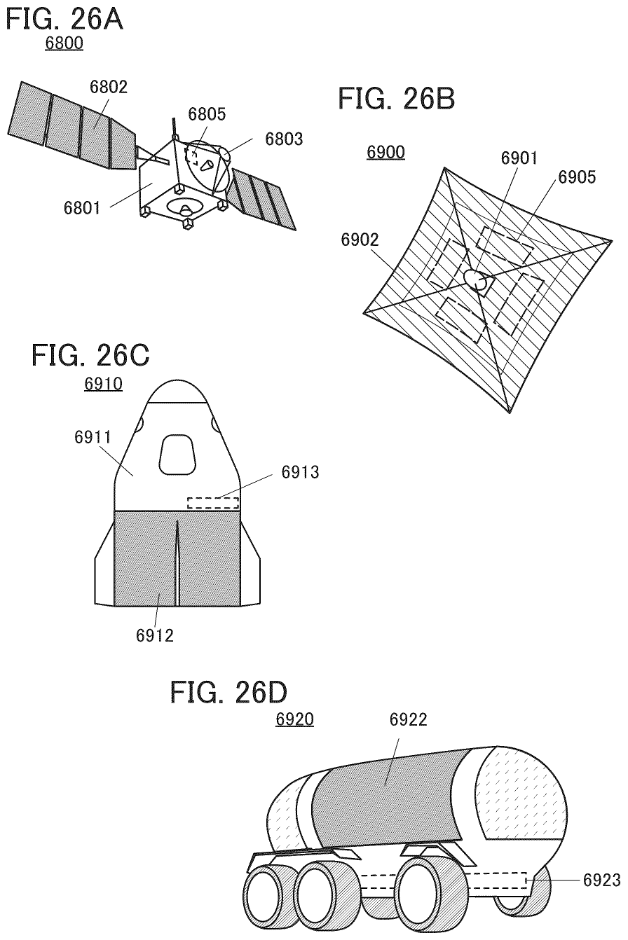

FIG. 26A illustrates an artificial satellite 6800 as an example of space equipment. The artificial satellite 6800 includes a body 6801, a solar panel 6802, an antenna 6803, and a secondary battery 6805. A solar panel is referred to as a solar cell module in some cases.

When the solar panel 6802 is irradiated with sunlight, electric power required for the operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for the operation of the artificial satellite 6800 might not be generated. In order to operate the artificial satellite 6800 even with a small amount of generated electric power, the artificial satellite 6800 is preferably provided with the secondary battery 6805.

The artificial satellite 6800 can generate a signal. The signal is transmitted through the antenna 6803, and the signal can be received by a ground-based receiver or another artificial satellite, for example. When the signal transmitted from the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can have a function of an earth observing satellite, for example.

FIG. 26B illustrates a probe 6900 including a solar sail as an example of space equipment. The probe 6900 includes a body 6901, a solar sail 6902, and a secondary battery 6905. When photons from the sun are incident on the surface of the solar sail 6902, the momentum is transmitted to the solar sail 6902. Thus, it is preferable that the surface of the solar sail 6902 have a thin film with high reflectance and face the sun.

The solar sail 6902 is furled in a small size until it goes beyond the earth's atmosphere, and is unfurled to have a large sheet-like shape as illustrated in FIG. 26B in the expanse beyond the earth's atmosphere (outer space). Thus, it is preferable to use the bendable secondary battery of one embodiment of the present invention as the secondary battery 6905 included in the solar sail 6902.

FIG. 26C illustrates a spacecraft 6910 as an example of space equipment. The spacecraft 6910 includes a body 6911, a solar panel 6912, and a secondary battery 6913. The secondary battery of one embodiment of the present invention can be used as the secondary battery 6913. The body 6911 can have a pressurized cabin and a non-pressurized cabin, for example. The pressurized cabin may be made to allow a crew to enter. The secondary battery 6913 can be charged with power generated when the solar panel 6912 is irradiated with sunlight. Note that the solar panel 6912 and the secondary battery 6913 may each have flexibility. The solar panel 6912 having flexibility is preferably used, in which case the solar panel 6912 having a curved shape can be provided on the external surface portion of the body 6911. In addition, the secondary battery 6913 having flexibility is preferably used, in which case the secondary battery 6913 having a curved shape can be provided on the inner side of the solar panel 6912 (on the inner side of the body 6911).

FIG. 26D illustrates a rover 6920 as an example of space equipment. The rover 6920 includes a body and a secondary battery 6923. The rover 6920 may include a solar panel 6922. The secondary battery of one embodiment of the present invention can be used as the secondary battery 6923. The rover 6920 may be made to allow a crew to get therein. The secondary battery 6923 may be charged with power generated when the solar panel 6922 is irradiated with sunlight, or the secondary battery 6923 may be charged with power generated by another power source such as a fuel battery or a radioisotope thermoelectric generator. Note that the solar panel 6922 and the secondary battery 6923 may each have flexibility. The solar panel 6922 having flexibility is preferably used, in which case the solar panel 6922 having a curved shape can be provided on the external surface portion of the body. In addition, the secondary battery 6923 having flexibility is preferably used, in which case the secondary battery 6923 having a curved shape can be provided on the inner side of the solar panel 6922 (on the inner side of the body).

The contents of this embodiment can be combined with the contents of the other embodiments as appropriate.

### Example 1

In this example, an ionic liquid and an organic electrolyte for low-temperature use were mixed, and the characteristics of the resulting mixture were evaluated.

In this example, EMI-FSI in which 2.15M LiFSI was dissolved was used as the ionic liquid. As the organic electrolyte for low-temperature use, a mixed solution of EC, EMC, and DMC in which 1M LiPF₆ was dissolved was used. The mixing ratio between EC, EMC, and DMC was 30:35:35 (volume ratio).

A mixture of the ionic liquid and the organic electrolyte for low-temperature use in a volume ratio of 1:1 was used as Sample 1.

As a comparative example, 2.15M LiFSI EMI-FSI was used as Sample 10. Similarly, 1M LiPF₆ EC:EMC:DMC=30:35:35 was used as Sample 11.

Table 1 shows the formation conditions.

TABLE 1

| | | Formation condition |
|---|---|---|
| Sample 1 | Mixture of ionic liquid and | 2.15M LiFSI EMI-FSI + |
| | organic electrolyte for low- | 1M LiPF₆ EC:EMC:DMC = |
| | temperature use | 30:35:35 |
| Sample 10 | Ionic liquid | 2.15M LiFSI EMI-FSI |
| Sample 11 | Organic electrolyte for low- | 1M LiPF₆ EC:EMC:DMC = |
| | temperature use | 30:35:35 |

### <Viscosity>

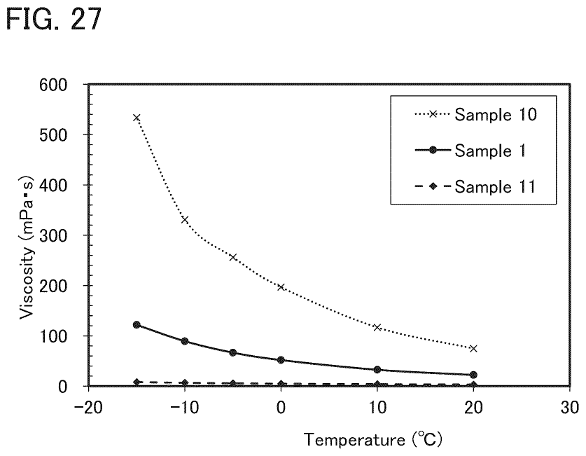

The viscosities of Sample 1, Sample 10, and Sample 11 were measured. The measurement temperatures were −15° C., −10° C., −5° C., 0° C., 10° C., and 20° C. The viscosities were measured using a rotational viscometer (TVE-35L produced by Toki Sangyo Co., Ltd.). FIG. 27 shows the results.

As shown in FIG. 27, Sample 11 containing the organic electrolyte for low-temperature use maintains a low viscosity lower than 10 mPa·s at the above-listed measurement temperatures. Sample 1 containing the mixture of the ionic liquid and the organic electrolyte for low-temperature use has a lower viscosity than Sample 10 containing only the ionic liquid. The viscosity difference therebetween becomes larger as the temperature becomes lower. For example, the viscosity of Sample 1 at −15° C. is higher than or equal to 60 mPa·s and lower than or equal to 200 mPa-s, specifically 121.8 mPa·s. The viscosity of Sample 1 at 0° C. is higher than or equal to 30 mPa·s and lower than or equal to 100 mPa·s, specifically 51.9 mPa·s. The viscosity of Sample 1 at 20° C. is higher than or equal to 10 mPa·s and lower than or equal to 50 mPa·s, specifically 22.2 mPa·s.

### <Wettability>

The wettability of Sample 1. Sample 10, and Sample 11 on separators was measured. As the separators, polyimide (PI) and polypropylene (PP) were used. Each sample was dripped on the separators, and the contact angles were measured.

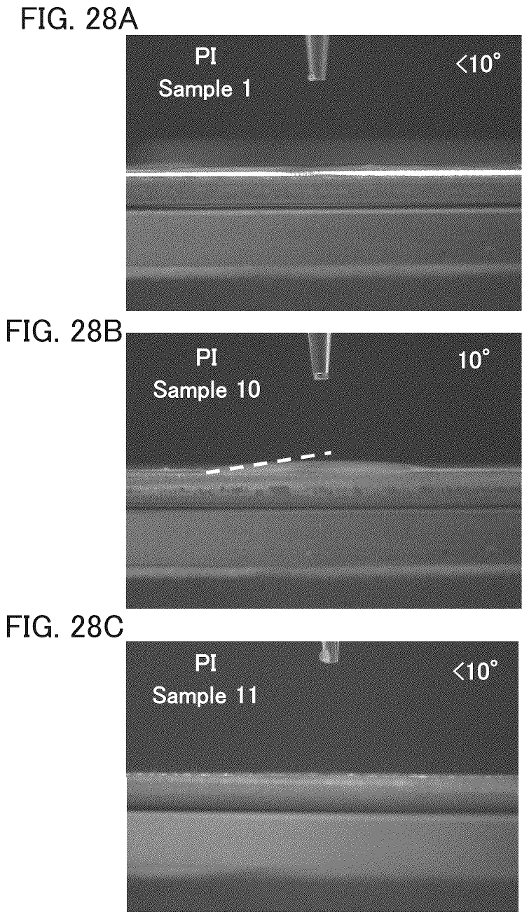

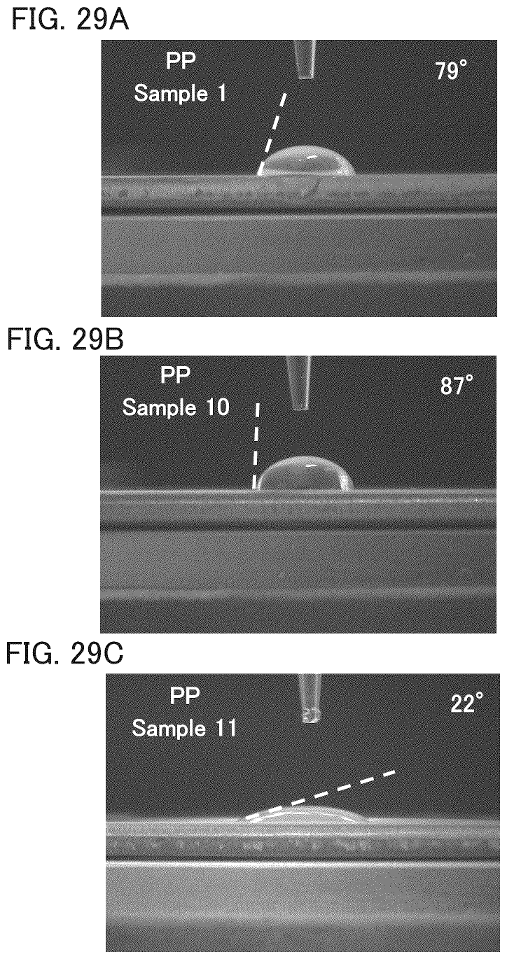

FIG. 28A to FIG. 29C show the photographs and contact angles of the samples dripped on the separators. Note that PI was used as the separators in FIG. 28A to FIG. 28C, and PP was used as the separators in FIG. 29A to FIG. 29C. FIG. 28A and FIG. 29A show the results of dripping Sample 1. FIG. 28B and FIG. 29B show the results of dripping Sample 10, and FIG. 28C and FIG. 29C show the results of dripping Sample 11.

All the samples have higher wettability on PI than on PP. In particular, as shown in FIG. 28A and FIG. 28B, the contact angle of Sample 10 dripped on PI is 10°, and the contact angle of Sample 1 dripped on PI is less than 10°, which is too small to measure. As shown in FIG. 29A and FIG. 29B, the contact angle of Sample 10 dripped on PP is 87°, and the contact angle of Sample 1 dripped on PP is greater than or equal to 60° and less than or equal to 83°, specifically 79°.

The above results demonstrate that the mixture of the ionic liquid and the organic electrolyte for low-temperature use has higher wettability than the ionic liquid alone. Since higher wettability facilitates passage of lithium ions, using the electrolyte of the present invention in which the ionic liquid and the organic electrolyte for low-temperature use are mixed enables a lithium-ion secondary battery to have excellent charge and discharge characteristics.

### Example 2

In this example, a secondary battery was fabricated using an electrolyte in which a conventional electrolyte and an organic electrolyte for low-temperature use were mixed, and its characteristics were evaluated.

As the electrolyte in which the conventional electrolyte and the organic electrolyte for low-temperature use were mixed, a mixture of EC, EMC, DMC, and DEC at EC:EMC:DMC:DEC=12:7:7:14 (volume ratio)=30:17.5:17.5:35 (volume %) to which VC was added at 1% (weight ratio) was used. This was used as Sample 21.

As the conventional electrolyte, a mixture of EC and DEC at EC:DEC=3:7 (volume ratio) to which VC was added at 2% (weight ratio) was used. This was used as Sample 22.

As the organic electrolyte for low-temperature use, a mixture of EC, EMC, and DMC at EC:EMC:DMC=6:7:7 (volume ratio) was used. This was used as Sample 23.

In each of the samples, 1M lithium hexafluorophosphate was used as a lithium salt. Table 2 shows the formation conditions of Sample 21 to Sample 23.

TABLE 2

| | | Organic solvent |
|---|---|---|
| Sample 21 | Mixed electrolyte | EC:EMC:DMC:DEC = 12:7:7:14 + |
| | | VC 1 wt % |
| Sample 22 | Conventional | EC:DEC = 3:7 + VC 2 wt % |
| | electrolyte | |
| Sample 23 | Electrolyte for low- | EC:EMC:DMC = 6:7:7 |
| | temperature use | |

Coin-type half cells were fabricated using the above electrolytes.

As a positive electrode active material, lithium nickel-cobalt-manganese oxide with Ni:Co:Mn=8:1:1 (atomic ratio) was used. Acetylene black (AB) was used as a conductive material, and polyvinylidene fluoride (PVDF) was used as a binder. A slurry was formed by mixing the positive electrode active material, AB, and PVDF at a weight ratio of 95:3:2, and the slurry was applied to a current collector of aluminum. As a solvent of the slurry, NMP was used. After the slurry was applied to the current collector, the solvent was volatilized. Through the above process, a positive electrode was obtained. In the positive electrode, the loading amount of the active material was approximately 7 mg/cm². The density was approximately 3 g/cc.

As a separator, one film of porous polypropylene was used.

A lithium metal was used for a negative electrode.

### <Charge and Discharge Cycle Test>

Charge and discharge cycle tests were performed on the coin-type half cells fabricated above. Fifty cycles of CC/CV charging (100 mA/g, 4.6 V or 4.5 V, 10 mA/g cut) and CC discharging (100 mA/g, 2.5 V cut) were performed. A 10-minute break was provided between the charging and the discharging. The measurement temperature was 25° C., 45° C., or 65° C. Before the cycle tests, two cycles of charging and discharging were performed as aging treatment. Specifically, as the aging treatment, CC/CV charging (20 mA/g, 4.6 V or 4.5 V, 10 mA/g cut) and CC discharging (20 mA/g, 2.5 V cut) were performed and then CC/CV charging (100 mA/g, 4.6 V or 4.5 V, 10 mA/g cut) and CC discharging (100 mA/g, 2.5 V cut) were performed.

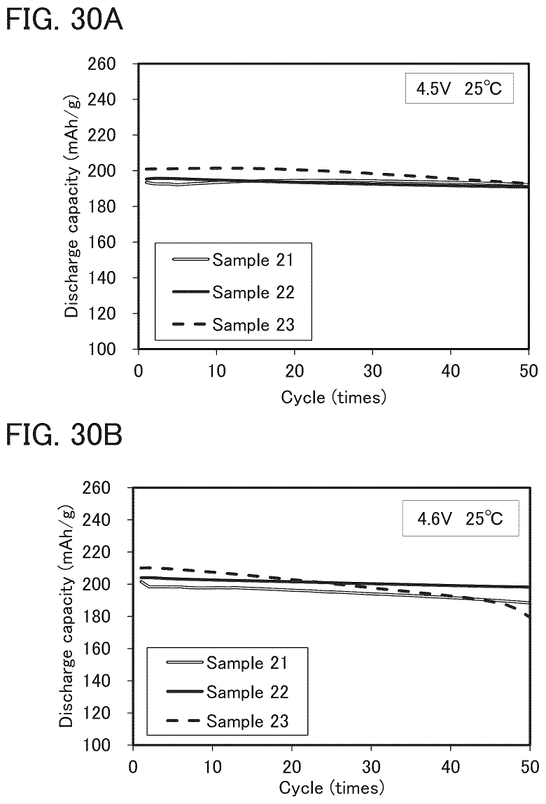

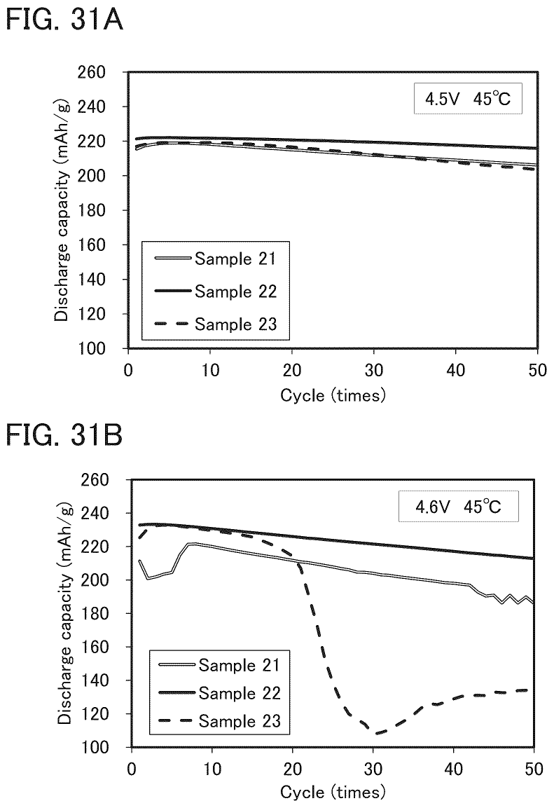

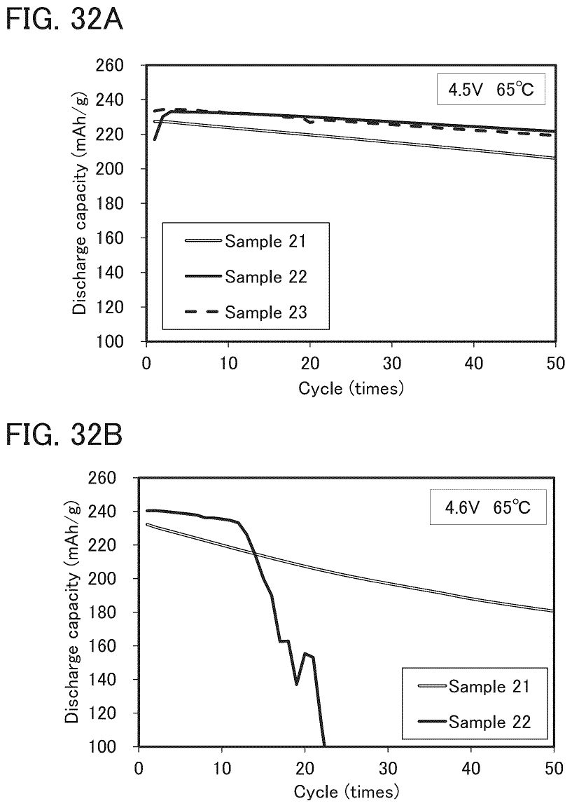

FIG. 30A to FIG. 32B show the results of the charge and discharge cycle tests on the secondary batteries containing Sample 21 to Sample 23. FIG. 30A shows the discharge capacity measured at a charge voltage of 4.5 V and a measurement temperature of 25° C., FIG. 30B shows the discharge capacity measured at a charge voltage of 4.6 V and a measurement temperature of 25° C., FIG. 31A shows the discharge capacity measured at a charge voltage of 4.5 V and a measurement temperature of 45° C., FIG. 31B shows the discharge capacity measured at a charge voltage of 4.6 V and a measurement temperature of 45° C., FIG. 32A shows the discharge capacity measured at a charge voltage of 4.5 V and a measurement temperature of 65° C., and FIG. 32B shows the discharge capacity measured at a charge voltage of 4.6 V and a measurement temperature of 65° C.

As shown in FIG. 30A to FIG. 32B. Sample 23 containing the organic electrolyte for low-temperature use is significantly degraded in the charge and discharge cycle tests performed at a high voltage of 4.6 V or higher and a high temperature of 45° C. or higher. By contrast, a decrease in the discharge capacity of Sample 21 containing the mixed electrolyte of one embodiment of the present invention is comparatively inhibited.

### <Nuclear Magnetic Resonance Spectroscopy, NMR Spectroscopy>

In order to examine the cause of the discharge capacity decrease, analysis was performed by nuclear magnetic resonance spectroscopy (1H NMR) on the compositions of the compounds contained in the electrolytes before the charge and discharge cycle tests and those after the 50-time charge and discharge cycle tests at 4.6 V and 45° C. shown in FIG. 31B. An AVANCEIII400 400 MHz nuclear magnetic resonance spectrometer produced by Bruker Japan K.K. was used, and acetonitrile-d3 (CD3CN) was used as a solvent.

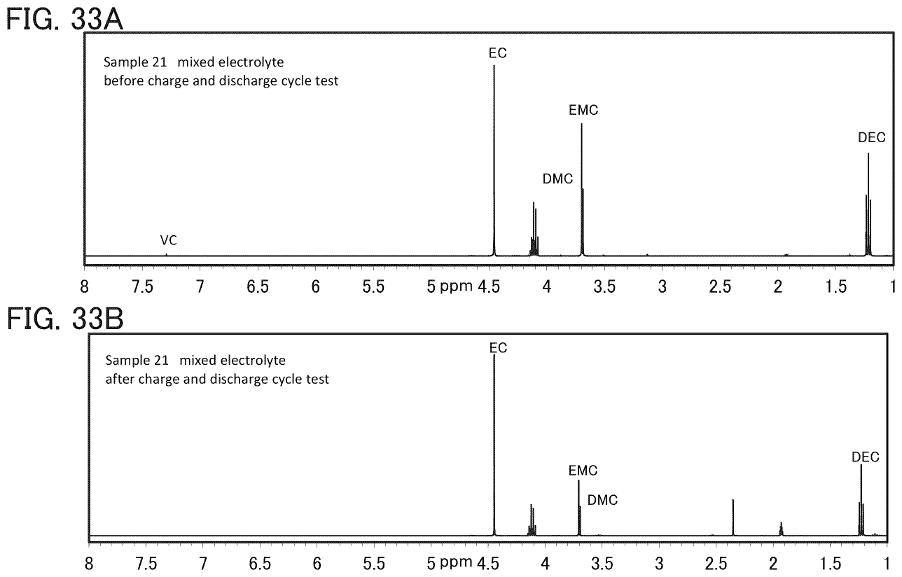

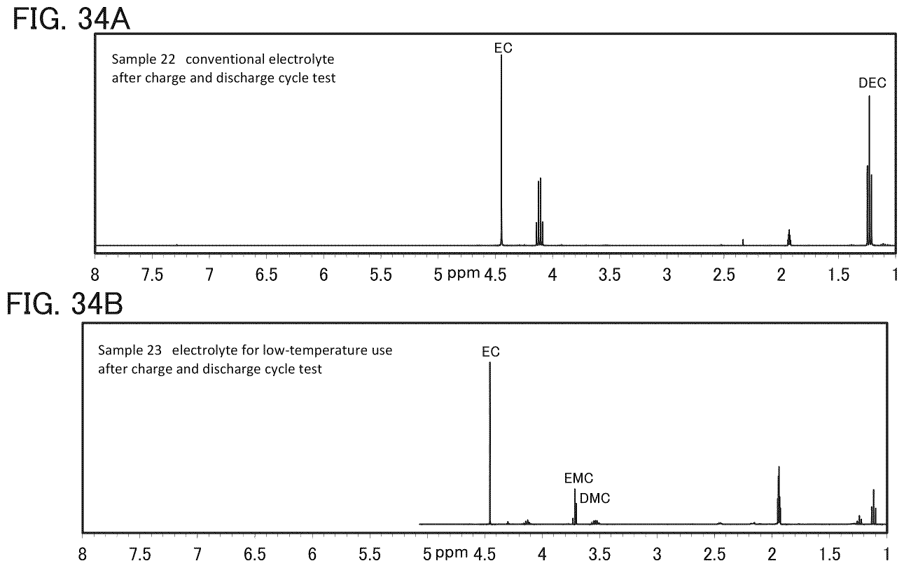

FIG. 33A shows a ¹H-NMR spectrum of Sample 21 before the charge and discharge cycle tests. FIG. 33B shows a ¹H-NMR spectrum of Sample 21 after the charge and discharge cycle tests. FIG. 34A shows a ¹H-NMR spectrum of Sample 22 after the charge and discharge cycle tests. FIG. 34B shows a ¹H-NMR spectrum of Sample 23 after the charge and discharge cycle tests.

The attribution of the compounds contained in the electrolytes and the peak positions used for calculating the compositions were as follows. EC: 4.45 ppm (4H, singlet), EMC: 3.69 ppm (3H, singlet), DMC: 3.71 ppm (6H, singlet), DEC: 1.23 ppm (6H, triplet), VC: 7.29 ppm (2H, singlet).

Note that a proton (3H) of a methyl group of EMC that almost overlapped with the peak of DEC was detected at around 1.23 ppm. Thus, the composition of DEC was estimated on the assumption that the difference between the integral value of the triplet peak at around 1.23 ppm and a value obtained by multiplying the amount (ratio) of EMC estimated from the integral value at around 3.69 ppm by 3 was an integral value derived from the 6-proton of DEC.

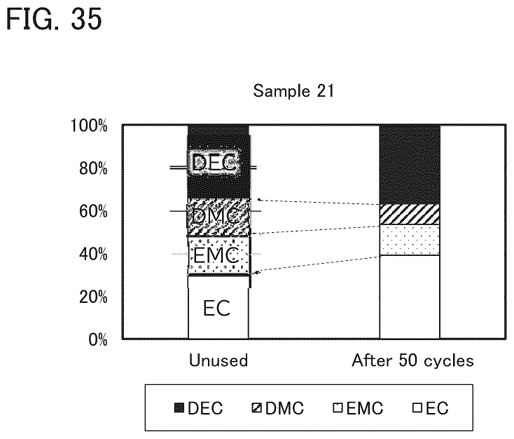

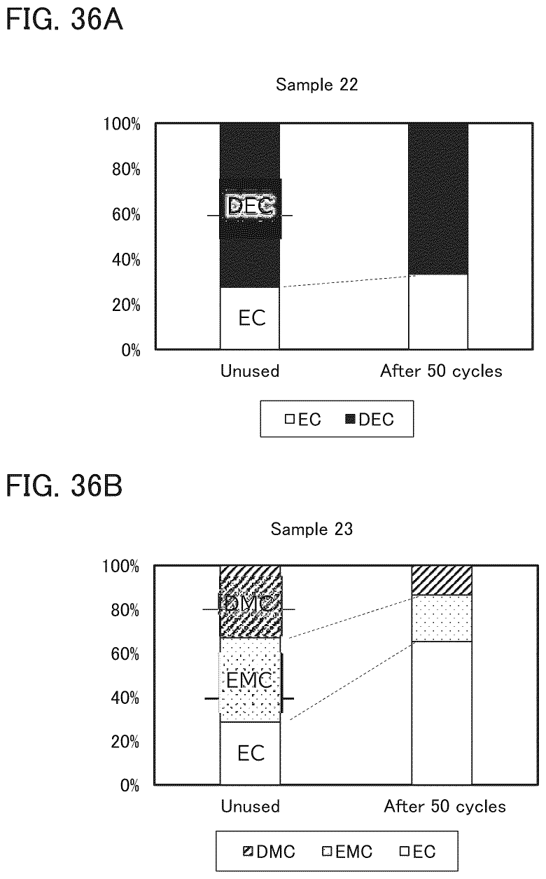

FIG. 35 to FIG. 36B show the compositions of the compounds contained in the electrolytes, which are calculated from the NMR analysis results in FIG. 33A to FIG. 34B, before and after the charge and discharge cycle tests. FIG. 35 is a graph showing the composition of Sample 21 before the charge and discharge cycle tests (unused) and that after the charge and discharge cycle tests (after 50 cycles). Similarly, FIG. 36A and FIG. 36B are graphs showing the compositions of Sample 22 and Sample 23, respectively.

FIG. 35 and FIG. 36A reveal that the difference in composition between before and after the charge and discharge cycle tests is small in each of Sample 21 containing the mixed electrolyte and Sample 22 containing the conventional electrolyte. Meanwhile, as shown in FIG. 36B, the difference in composition between before and after the charge and discharge cycle tests is large in Sample 23 significantly degraded; the proportions of DMC and EMC are greatly reduced. This is probably because of the decomposition of DMC and EMC.

The secondary battery containing Sample 21 of one embodiment of the present invention has comparatively good charge and discharge cycle performance even at a high voltage of 4.6 V and a high temperature of 45° C. presumably because the decomposition of the mixed electrolyte is comparatively inhibited.

### REFERENCE NUMERALS

10 secondary battery
20: positive electrode, 21: positive electrode lead, 22: positive electrode current collector, 23: positive electrode active material layer, 30: negative electrode, 31: negative electrode lead, 32: negative electrode current collector, 33: negative electrode active material layer, 34: negative electrode active material, 35: binder, 36: conductive material, 40: separator, 50: exterior body, 71: region, 72: positive electrode current collector, 73: separator, 74: negative electrode current collector, 75: sealing layer, 76: lead electrode, 78: positive electrode active material layer, 79: negative electrode active material layer, 80: plane, 83: bonding portion, 84: bonding portion, 100: battery pack, 101: secondary battery, 102: secondary battery

1. A battery comprising an electrolyte,
wherein the electrolyte comprises an ionic liquid and an organic electrolyte,
wherein the organic electrolyte comprises a cyclic carbonate, methyl ethyl carbonate, and dimethyl carbonate, and
wherein the methyl ethyl carbonate accounts for greater than or equal to 30 volume % and less than or equal to 65 volume % in the organic electrolyte.

2. The battery according to claim 1, wherein the ionic liquid accounts for greater than or equal to 20 volume % and less than or equal to 80 volume % in the electrolyte.

3. The battery according to claim 1, wherein the ionic liquid has Structural Formula (111) below and Structural Formula (H11) below:

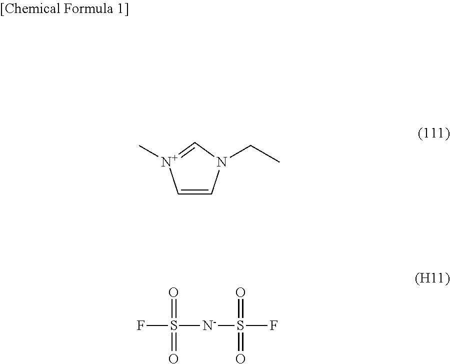

4. The battery according to claim 1,
wherein the cyclic carbonate comprises ethylene carbonate, and
wherein the ethylene carbonate accounts for greater than or equal to 25 volume % and less than or equal to 35 volume % in the organic electrolyte.

5. A battery comprising an organic electrolyte,
wherein the organic electrolyte comprises a cyclic carbonate and three or more kinds of linear carbonates,
wherein, when nuclear magnetic resonance analysis is performed on a first organic electrolyte in the battery before a cycle test and a second organic electrolyte in the battery after the cycle test, a difference between a proportion of the three or more kinds of linear carbonates in the first organic electrolyte and a proportion of the three or more kinds of linear carbonates in the second organic electrolyte is less than or equal to 20 points, and
wherein, as the cycle test, charging and discharging are alternately repeated 50 times in a 45° C. environment, where the charging is constant current charging at a current value of 100 mA/g to a voltage of 4.6 V and subsequent constant voltage charging to a current value of 10 mA/g and the discharging is constant current discharging at a current value of 100 mA/g to a voltage of 2.5 V.

6. The battery according to claim 1, wherein the electrolyte comprises lithium hexafluorophosphate.

7. The battery according to claim 1, wherein the battery is a flexible battery.

8. An electronic device comprising the battery according to claim 1.

9. A vehicle comprising the battery according to claim 1.

10. The battery according to claim 2, wherein the ionic liquid has Structural Formula (111) below and Structural Formula (H11) below:

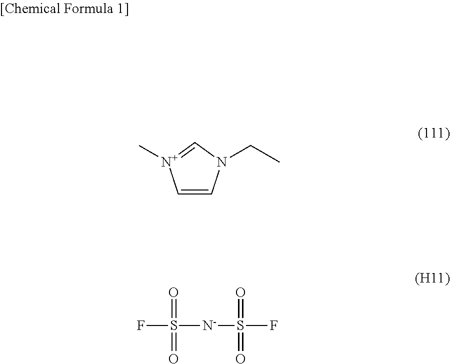

11. The battery according to claim 2,
wherein the cyclic carbonate comprises ethylene carbonate, and
wherein the ethylene carbonate accounts for greater than or equal to 25 volume % and less than or equal to 35 volume % in the organic electrolyte.

12. The battery according to claim 5, wherein the electrolyte comprises lithium hexafluorophosphate.

13. The battery according to claim 5, wherein the battery is a flexible battery.
